(19) United States
(12) Patent Application Publication
(10) Pub. No.: US 2014/0326660 A1
(43) Pub. Date: Nov. 6, 2014

(54) MEMBRANE NANOFILTERS

(71) Applicant: The Research Foundation of Stale University of New York, Binghamton, NY (US)

(72) Inventors: Omowunmi Sadik, Vestal, NY (US); Nian Du, Vestal, NY (US)

(73) Assignee: The Research Foundation of Stale University of New York, Binghamton, NY (US)

(21) Appl. No.: 14/200,332

(22) Filed: Mar. 7, 2014

Related U.S. Application Data
(60) Provisional application No. 61/851,596, filed on Mar. 8, 2013.

(51) Int. Cl. B01D 71/64; B01D 71/02; B01D 69/14

(52) U.S. Cl. CPC B01D 71/64; B01D 69/148; B01D 71/022
USPC 210/500.25; 210/500.39

(57) ABSTRACT

Embodiments of a filter device utilize a membrane comprising poly(amic) acid. The membrane has a porous structure with pores configured to filter nano-sized particles, e.g., less than 100 nm. In one embodiment, the filter device can comprises a substrate (e.g., filter paper) and the membrane disposed on the substrate. This configuration is useful to capture, isolate, and detect nano-particles.

### CROSS-REFERENCE TO RELATED APPLICATIONS

This application claims the benefit of priority to U.S. Provisional Application No. 61/851,596, filed on Mar. 8, 2013 and entitled “MEMBRANE NANOFILTERS.” The content of this application is incorporated by references herein in its entirety.

### BACKGROUND

The present disclosure describes subject matter that relates to nanotechnology and, in particular, to filtration and detection of nano-materials.

Materials that arise from developments in nanotechnology (also “nano-materials” and/or “nano-particles”) are likely key to future technology in various applications and industries, e.g., energy, drug delivery, medicine, and environmental. However, the rapid advancement of nanotechnology and the increasing use of nano-materials or nano-materials-based products and processes present both opportunities and challenges. For example, some of the special properties that make nano-materials useful may also cause them to pose hazards to humans and the environment. Nano-particles are believed to be toxic when inhaled because they present a large surface area to the lung, and are able to bypass the blood-brain barrier through the olfactory bul. Other nano-particles such as ultra fine metal nano-particles have been reported to affect the inflammatory processes of the central nervous system. Moreover, a clear understanding of the potential impact of nano-materials on the environment has been limited by insufficient understanding of the risks associated with development, manipulation, and wide-ranging applications of nano-materials. The identification and characterization of these materials are important first-steps in assessing the potential risks of nano-materials and nano-particles.

Conventional membrane filters often have large pore sizes that cannot be used to filter submicron particles, nano-particles (NPs), or biological particles having sizes of 100 nm or below. One solution to address these pore size issue is to use micro-porous polypropylene filters with surface charge modification. These types of filters can filter NPs with sizes between 60 nm and 200 nm. However, during operation, the filters capture NPs by adsorption based on their surface charge. Another solution may utilize carbonaceous nano-fiber membranes made of carbon nano-fibers with little interaction with the filtered NPs. These types of filters have been shown to filter NPs with a wide range (5 nm 150 nm). In other examples, nano-porous membranes are used of increasing thicknesses (e.g., up to 45 μm) could separate smaller particles (CdTe quantum dots of 2-4 nm in size) and act as size-selective chromatography.

Other techniques may employ membranes more commonly associated with ultra-filtration (UF) for the filtration of NPs. These membranes may be polymeric and naturally hydrophobic. Examples include polysulfone, polyethersulfone, polypropylene, or polyvinylidenefluoride. Still other membranes comprised of inorganic aluminum oxide membrane, having a precise, nondeformable honeycomb pore structure with uniform pore size and extraordinarily high pore density can be used in micrometer and nanometer filtration. However, although these commercial or laboratory filters and membranes have been used for the isolation and separation of NPs, these convention membranes often suffer from inconsistent range in pore size that leads to inadequate in filtration efficiency. For example, some extremely small NPs could still penetrate the pores. Moreover, many conventional filters cannot be used for both detection and separation.

### BRIEF DESCRIPTION OF THE INVENTION

The present disclosure describes embodiments of devices and systems (and methods) that can capture, isolate, and detect nano-materials (e.g., engineered nano-materials) and, further, distinguish these nano-materials from naturally-occurring particular matter. These embodiments may enable size-selective and on-site detection of engineered nano-materials in the environment. These features facilitate new approaches that create materials to take advantage of enhanced catalytic, optical, and electrical properties of nano-materials.

As set forth herein, embodiments can comprise polymeric membranes that were tested using them as nano-filters to isolate and remove silver nano-particles, quantum dots, and titanium dioxide particles in food supplements and environmental samples. These embodiments exhibit filtration efficiencies over 99%. Because the porosity of the membranes can be controlled, discrimination of the NPs from bacteria, enzymes, and even soot and other hydrocarbons was possible. The sensor capabilities were tested on nano-materials in soil, sediment, and water matrices. These tests showed the potential for continuous and in-situ sensing.

Examples of the polymer have excellent physical and chemical properties: transparency, flexibility, electrical conductivity, and accessibility to forming large-area devices. The polymers can be modified for chemical and electrocatalytic applications. For example, the polymer can reduce chromium VI to chromium III, which implies the potential for use in remediation. Somewhat surprisingly, it was also found that the linked flavoinoids, which reduce chrome VI, inhibit enzymes that can lead to alleviation of pain in cancer patients. This is possible because examples of water soluable compounds developed in connection with embodiments set forth herein can degrade in the human body, unlike existing non-water soluable compounds that cannot biodegrade and, therefore, cannot be used in the human body.

This disclosure describes, in one embodiment, a filter device that comprises a substrate and a first layer disposed on the substrate, the first layer having a composition comprising a first component of poly(amic) acid, the first layer having a first porous structure with pores of a first pore size, wherein the first pore size is less than 100 nm.

This disclosure also describes, in one embodiment, an apparatus for filtering nano-particles from a solution, the apparatus comprising a filter media and a membrane disposed on the filter media. The membrane comprises a composition of poly(amic) acid and one or more additive components bonded with the poly(amic) acid, wherein the membrane is configured with at least one functional group that is configured to bond with biomolecules.

This disclosure further describes, in one embodiment, a membrane that comprises a porous structure with pores less than 100 nm, the porous structure comprising poly(amic) acid, a first additive cross-linked with the poly(amic) acid, and a second additive comprising nano-particles bonded to the porous structure.

The discussion that follows below provides information that quantifies and qualifies these and other exemplary embodiments of the membranes, devices, apparatus, and systems contemplated herein. This information is, for example, useful to illustrate the effectiveness of a membrane having a composition with a first component (e.g., of poly(amic) acid) and one or more second components, or additive components, that bond with the first component. This structure enhances the operative characteristics of the membranes, thus lending the embodiments to perform well to capture, isolate, and detect nano-particles and like particulates and contaminants. In some embodiments, the porous structure is configured to capture particulates on the nano-scale (e.g., less than 100 nm), which lends these embodiments to a wide range of applications that are available for membranes having the general structure discussed herein.

Where applicable, one or more of the following terms may be used throughout the discussion:

ODA—4,4′-oxydianiline; PMDA—pyromelitic dianhydride; DMAc—N,N-dimethylacetimide; PAA—poly(amic) acid; PS—PAA-silicone; PG—PAA-gold; PSG—PAA-gold-silicone composite; PI—Polyimide; PET—polyethylene terephthalate; NP—Nano-particle; SEM—Scanning electron microscopy; EDS—energy dispersive spectroscopy; TEM—Transmission electron microscopy; XRD—x-ray diffraction; SE—secondary electrons; CV—cyclic voltammetry; DPV—differential pulse voltammetry; ROS—reactive oxygen species; MF—microfiltration; UF—ultrafiltration; NF—nano-filtration; RO—reverse osmosis; SD—standard deviation.

### BRIEF DESCRIPTION OF THE DRAWINGS

Reference is now made briefly to the accompanying figures in which:

FIG. 1 depicts a schematic diagram of an exemplary embodiment of a filter device that can filter nano-particles, e.g., out of a flow F;

FIG. 2 depicts a schematic diagram of an exemplary embodiment of a filter device as part of a sensor device that operates as part of a measurement system;

FIG. 3 depicts an exemplary embodiment of a method to synthesize PSG copolymer solution;

FIGS. 4-9 depict SEM images recorded at a magnification of 200000 of an example of PSG membranes prepared at temperatures of 75° C. (FIG. 4); 100° C. (FIG. 5); 150° C. (FIG. 6); 200° C. (FIG. 7); 250° C. (FIG. 8); 300° C. (FIG. 9), wherein the inserts are optical images of the exemplary PSG membranes;

FIG. 10 depicts a plot of data for FTIR spectra of PAA and PSG;

FIGS. 11-16 depict a plot of data for NMR spectra of an example of PAA co-polymers including H NMR spectra of exemplary PAA, PG and PSG membranes in FIGS. 11, 12, and 13 and ¹³C NMR spectra of exemplary PAA, PG and PSG membranes in FIGS. 14, 15, and 16;

FIG. 17 depicts a plot of data for XRD spectra of examples of thermally-cured PAA series membranes;

FIGS. 18 and 19 depict a schematic representation of exemplary reactions of PAA, which include the amide group in PAA reduced by AuCl₃ in FIG. 18; and carboxylic acid group reacted with amino group of APTMOS and APTMOS, TMOS and TMOSPA cross-linked into silicone polymer which is an Si—O—Si framework in FIG. 19;

FIG. 20 depicts an image of an example of an example of a PSG membrane and a plot of data for a UV-Vis spectra of two examples of PSG membranes with different thickness (85 μm and 0.5 mm);

FIGS. 21 and 22 depict images of an example of a PAA series membranes before and after bending tests including in FIG. 21 PSG membrane coated on colorless PET substrate, and in FIG. 22 PAA, PG, and PSG membranes before and after 2000 times and 3000 times bending tests;

FIGS. 23-29 depict plots of data for TGA and DSC analysis for an example of a PAA series membranes including TGA results of PAA, PG, PS and PSG membranes in FIGS. 23, 24, 25, and 26 and DSC results of PAA, PG and PSG membranes in FIGS. 26, 27, and 29;

FIGS. 30-32 depict a plot of data for CV and DPV characterizations of several exemplary membranes including a PSG membrane on GCE (experimental conditions: 0.1M PBS at pH 6.0, various scan rate from 50 mV/s to 200 mV/s) in FIG. 30, a PG and a PSG membrane on GCE (experimental conditions: 0.1M PBS at pH 6.0, 150 mV/s) in FIG. 31, and a PSG membrane on GCE (experimental conditions: 0.1M PBS at pH 6.0, sample width: 17 ms, pulse width 50 ms, pulse period: 200 ms, sensitivity; 100 μA/V) in FIG. 32;

FIG. 33 depicts a plot of data for DPV characterization of exemplary PG membranes on GCE in which the concentration of gold in these membranes increased from PG3 to PG1 (experimental conditions: 0.1M PBS at pH 6.0, sample width: 17 ms, pulse width 50 ms, pulse period: 200 ms, sensitivity: 100 μA/V);

FIGS. 34-37 depict SEM images of an example of PG and PSG membranes including SEM image of PG membrane surface at a magnification of 50000× in FIG. 34; SEM images of PSG membrane surface at a magnification of: 50000× in FIG. 35; SEM image of PG membrane cross section side at a magnification of 500000× in FIG. 36; SEM image of PSG membrane cross section side at a magnification of 500000× in FIG. 37;

FIG. 38 depicts a plot of data for EDS analysis of an example of an PSG membrane at a magnification of 20000×, working distance of 10 min and activating potential of 10 kV;

FIGS. 39-40 depict EDS mapping images of gold NPs on an example of a PG membrane including in FIG. 39 a first row with an SEM image of a round NP and an elemental mapping for gold and a second row with elemental mappings for carbon, oxygen, and chlorine, respectively (experimental condition: at a magnification of 200000×, working distance of 10 mm and activating potential of 10 kV); and in FIG. 40 a first row with an SEM image of a triangle NP and elemental mapping for gold and a second row with an elemental mapping for carbon, oxygen, and chlorine, respectively (experimental condition: at a magnification of 200000×, working distance of 10 mm and activating potential of 10 kV);

FIGS. 41-43 depict several SEM images of an example of a PG membrane with various gold concentrations at a magnification of 200000×, wherein the weight ratio of gold/PAA in PG1, PG2 and PG3 were 3/70, 2/70 and 1/70 respectively;

FIGS. 44-50 depict several SEM images of an example of a PG membrane with various gold concentrations at a magnification of 20000×;

FIGS. 51-57 depict various images including an image of an example of PG membrane coated on glass cover slides and heated at various temperatures in FIG. 51 and several SEM images of an example of a PG membrane surfaces, wherein images in FIG. 52 and FIG. 53 have a magnification of 100000× and images in FIGS. 54-57 have a magnification of 30000×;

FIG. 58 depicts a TEM image of 8.4 mg/ml of PSG polymer at a magnification of 40000×;

FIGS. 59 and 60 depict images of an example of a phase-inverted PAA membrane (in FIG. 59) and an example of a PSG phase-inverted membrane (in FIG. 60);

FIGS. 61-66 depict various SEM images of an example of PAA membranes made from different amounts of casting solution, wherein the PAA membranes from casting solutions of 5 μl and 10 μl have a magnification of 100000× and the PAA membranes from casting solutions of 30 μl have a magnification of 50000×;

FIGS. 67 and 68 depict SEM images of examples of a PAA stand-alone membrane and a PAA coated filter paper from the same PAA casting solution at a magnification of 100000×, wherein the PAA stand-alone membrane (in FIG. 67) has an average pore size of 22 nm and pore size range of 8-58 nm and the PAA coating layer on filter paper (in FIG. 68) has an average pore size of 18 nm and pore size range of 7-30 nm;

FIGS. 69 and 70 depict plots of data that identify absorption and emission spectra of an example of a PAA membrane in FIG. 69 and fluorescence emission of stand-alone PAA series membranes excited at 450 nm, using empty cuvette as blank in FIG. 70;

FIGS. 71-75 depict plots of data that identify in FIGS. 71-74 emission of examples of PAA membranes at different excitation wavelengths (350 nm, 400 nm, 450 nm, 500 nm, 550 nm and 600 nm) and in FIG. 75 emission of an example of a PSG membrane when the incident light is in a wavelength range from 420 nm to 540 nm;

FIGS. 76 and 77 depict plots of data that compare emissions from an example of a PAA, PI and PET membranes when they were excited at 570 nm in FIG. 76 and provide emission spectra of PAA dissolved in DMAc at various excitation wavelengths in FIG. 77;

FIG. 78 depicts a plot of data for a Raman spectrum of an example of phase-inverted PAA membrane (blank subtracted), wherein the PAA membrane was placed on solid sample holder, the laser power was 5 mW, and the wavelength of the laser was 632.8 nm,

FIG. 79 depicts a plot of data that identifies output wavelength distribution of a xenon lamp;

FIGS. 80 and 81 depict images of an example of a PAA series phase-inverted membrane before and after bending tests in which the example comprises a PSG membrane coated on colorless PET substrate in FIG. 80 and the images show PAA, PG, and PSG membranes before and after 2000 times and 5000 times bending tests in FIG. 81;

FIGS. 82-87 depict plots of data for TGA and DSC analysis for an example of a PAA series phase-inverted membrane in which. FIGS. 82, 83, and 84 are TGA results and FIGS. 85, 86, and 87 are DSC results;

FIGS. 88-91 depict SEM images of an example of a 0.25M PAA membrane with a top side of the PAA membrane at a magnification of 50000× in FIG. 88, a back side of the PAA membrane at a magnification of 50000× in FIG. 89, a cross-section of the PAA membrane at a magnification of 1000× in FIG. 90, and a cross-section focus on top side at a magnification of 50000× in FIG. 91;

FIGS. 92-95 depict SEM images of surface morphology and inner structure of an example of a filter device comprising filter paper and PAA membrane coated filter paper in which the image in FIG. 92 shows a surface of filter paper at a magnification of 500×; the image in FIG. 93 shows a surface of 0.32M PAA coated filter paper at a magnification of 100000×; and the images FIGS. 94 and 95 show cross sections of filter paper and 0.32M PAA coated filter paper at a magnification of 500×;

FIGS. 96-97 depict SEM images of PSG membrane in which the image in FIG. 96 shows the enlarged micrographs at a magnification of 20000× that shows NPs inside and the inserted image is the fractured side of PSG membrane at a magnification of 3000× and the image in FIG. 97 shows the enlarged image of solid circled part at a magnification of 150000× and the inserted image is the surface of PSG membrane at a magnification of 20000× which shows well-dispersed gold is (circled with short dash line) and silicone nano-clusters (circled with long dash line);

FIGS. 98-111 depict SEM images of examples of PAA membranes and PAA coated filter papers derived from several concentrations at a magnification of 100000×,

FIGS. 112-115 depict SEM images of examples of 0.44M and 0.47M FAA membranes and FAA coated filter papers at a magnification of 200000×;

FIGS. 116 and 117 depict plots of data for single component exponential decay fitting for an example of PAA stand alone membranes in FIG. 116 and PAA coated filter paper in FIG. 117;

FIG. 118 depicts a schematic diagram of an exemplary filter apparatus comprising a 13 mm Swinny filter holder equipped with an example of a FAA membrane disposed therein, wherein in one example the PAA membrane was placed between O-rings and a stainless steel screen was placed under the membrane for support;

FIG. 119 depicts a schematic diagram of one implementation of separation of NPs mixture using three PAA membranes with various pore sizes;

FIGS. 120-122 depict, in FIGS. 120 and 121, SEM images of PAA membrane before and after filtration in which the image in FIG. 120 shows a surface of PAA membrane before filtration at a magnification of 200000× and the image in FIG. 121 shows a surface of FAA membrane after filtration at a magnification of 150000×, and the plot of data in FIG. 122 is for EDS analysis for confirmation of CdSe(core)/ZnS(shell) QDs trapped on PAA membrane, wherein the acceleration voltage was 10 kV at a magnification of 5000 and working distance about 10 mm;

FIGS. 123 and 124 depict plots of data that illustrates fluorescence measurements for QSH620 using low (FIG. 123) and high sensitivities and their calibration plots (FIG. 124);

FIG. 125 depicts a plot of data that illustrates fluorescence emission from 200 nmol ODs on an example of PAA membrane;

FIGS. 126-131 depict SEM image of several silver NPs captured on an example of PAA membranes in which FIG. 126 shows 40 nm silver NPs at a magnification of 2000×, FIG. 127 shows 40 nm silver NPs islands in red rectangle of image in (a) at a magnification of 100000×. FIGS. 128 and 129 show MesoSilver and Colloidal silver NPs being captured by PAA membranes at a magnification of 100000×, and FIGS. 130 and 131 show Sovereign silver NPs being trapped on PAA membranes at magnifications of 50000× and 100000×, respectively;

FIGS. 132 and 133 depict a plot of data for an EDS spectrum of silver NPs on an example of a PAA membrane with a working distance of 10 mm in FIG. 132, and FIG. 133 depicts (b) an SE image of an example of a PAA membrane with silver NPs at a magnification of 3000×, and (c), (d), (e), and (f) several EDS mapping images of silver, carbon, nitrogen, and oxygen, respectively, wherein the membrane surface was coated with carbon and the accelerating voltage for EDX was 10 kV;

FIG. 134 depicts a plot of a UV-Vis Spectra of MesoSilver samples at different concentrations and the accompanied calibration plot, wherein the solid lines are for diluted MesoSilver samples while the dotted lines are recorded for the filtrates through commercial filter papers (FL), nylon (NL) membrane, and an example of a FAA membrane;

FIGS. 135-137 depict SEM images of TiO₂ NPs trapped on 0.2M (FIG. 135), 0.26M (FIG. 136) and 0.32M (FIG. 137) FAA coated filter paper at a magnification of 100000×;

FIGS. 138 and 139 depict a plot of data for an EDS spectrum of an example of a PAA membrane with captured TiO₂ NPs at 10 mm working distance in FIG. 138, and FIG. 139 depicts (b) an SEM image of an example of a PAA membrane with captured TiO₂ NPs at a magnification of 3000×, and (c), (d), (e), and (f) an elements mapping image of titanium, carbon, oxygen, and nitrogen respectively, wherein the membrane surface was coated with carbon and the accelerating voltage for EDX was 10 kW;

FIGS. 140-142 depicts several SEM images of 200 nm (FIG. 140), 50 nm (FIG. 141), and 20 nm (FIG. 142) gold NPs on an example of 0.36M PAA membranes, wherein the big images have a magnification of 10000× and the insert image for FIG. 141 has a magnification of 50000× and for FIGS. 1.41 and 142 have a magnification of 200000×;

FIGS. 143-145 depicts several SEM images of gold NPs being captured on an example of PAA membranes after each separation steps, wherein the images are after first, second, and third filtration, respectively, and wherein the image in FIG. 143 has a magnification of 50000× and in FIGS. 144 and 145 have a magnification of 100000×;

FIGS. 146-148 depict SEM images of TiO₂ NPs (FIG. 146), 60 nm silver NPs (FIG. 147), and 10 nm gold NPs (FIG. 148) at a magnification of 200000×;

FIGS. 149-151 depict an SEM image of NPs captured in first filtration at a magnification of 100000× in FIG. 149, an SE image of NPs captured in first filtration at a magnification of 50000× in FIG. 150 (b)-(e), and FIGS. 150 (f)-(g) depict an EDS mapping images of silver, titanium, oxygen, carbon, and gold, respectively;

FIGS. 152-154 depict an SEM image of NPs captured in second filtration with as magnification of 100000× in FIG. 152, an SE image of NPs captured in second filtration with a magnification of 50000× in FIG. 153 (b)-(e), and FIG. 154 (f)-(g) depict an EDS mapping images of silver, titanium, oxygen, carbon, and gold, respectively;

FIGS. 155-157 depicts an SEM image of NPs captured in third filtration with a magnification of 200000× in Ha 155, an SE image of NPs captured in third filtration with a magnification of 50000× in FIG. 156 (b)-(e), and FIG. 157 (f)-(g) depict an EDS mapping images of gold, titanium, silver, oxygen, and carbon, respectively;

FIGS. 158-160 depict in FIGS. 158 and 159 an SEM images of 118 nm and 61 nm polystyrene beads filtered separately at a magnification of 10000×, and with inserts that have a magnification of 50000×, wherein both of them shows polystyrene beads clustered into NPs “islands” as pointed by red arrows, and in FIG. 160 an SEM image of 10 nm gold NPs filtered separately, at a magnification of 50000×, and with an insert that has a magnification of 200000×;

FIGS. 161-163 depict SEM images of each step of separation in which FIG. 161 depicts an SEM image of first filtration at a magnification of 50000×, wherein the cluster of small NPs with big NPs was pointed out by red arrow, FIG. 162 depicts an SEM image of second filtration at a magnification of 100000×, and FIG. 163 depicts an SEM image of third filtration at a magnification of 250000×;

FIG. 164 depicts a plot of data for a UV-Vis spectra of AgCl suspension resulted from various concentrations of silver nano-powder, wherein the insert is a plot of data that shows the calibration line of concentration and absorbance;

FIGS. 165 and 166 depict plots of data for CV measurements of various silver NPs from both standard stock solution and three food supplement samples (experimental conditions: 50 mV/s scan rate and 10 μA/V sensitivity) in which the plot of FIG. 165 is a comparison of CV spectra of blank PAA membrane and standard 40 nm silver NPs covered PAA membrane and the plot of FIG. 166 is a CV spectra of three food samples;

FIGS. 167-169 depict plots of data for CV and DPV characterization of standard 40 nm silver NPs and food samples at various concentrations in which the plot of FIG. 167 is a comparison of DPV spectra of blank gold surface, blank PAA membrane and three food samples, the plot of FIG. 168 is multiple cycles of CV spectrum of 12 ppm standard 40 nm silver NPs, and the plot of FIG. 169 is a DPV spectrum of standard 40 nm silver NPs at various concentrations (experimental condition for DPV: 20 mV/s scan rate, 17 ms sample width, 50 ms pulse width, 200 ms pulse period and 1 mA/V sensitivity; experimental condition for CV: 50 mV/s scan rate and 100 μA/V sensitivity);

FIGS. 170-172 depict plots of data for electrochemical characterization of interference NPs in which the plot of FIG. 170 is a CV spectrum of gold NPs (experimental conditions: 50 mV/s scan rate and 10 μA/V sensitivity), the plot of FIG. 171 is a CV spectrum of ZnO NPs (experimental condition: 50 mV/s scan rate and 0.1 μA/V sensitivity), and the plot of FIG. 172 is a CV spectrum of silver NPs and ZnO NPs mixture sample in which ZnO NPs are 250 times concentrated than silver NPs (experimental condition: 50 mV/s scan rate and 1 μA/V sensitivity);

FIGS. 173 and 174 depict plots of data for CV measurements for samples washed with EDTA in which the plot of FIG. 173 is a comparison of CV spectra of silver ions on PAA membranes before and after washing with EDTA, the plot of FIG. 174 is a comparison of CV spectra of silver NPs on PAA membranes before and after washing with EDTA (experimental conditions: 100 mV/s scan rate and 100 μA/V sensitivity);

FIG. 175 depicts a schematic diagram of the mechanism of EDTA washing;

FIGS. 176 and 177 depict plot of data for calibration plots of AAS analysis based on absorbance of silver ions solutions with various concentrations at 328 nm in which the plot of FIG. 176 is for concentrations from 0.1 ppm to 10 ppm and the plot of FIG. 177 is for concentrations from 0.1 ppm to 100 ppm;

FIGS. 178-180 depict plots of data for CV measurement for various amount silver NPs solution added to buffer solution without NaCl in FIG. 178, CV measurement for various amount silver NPs solution added to buffer solution with NaCl in FIG. 179 (Experimental condition: 50 mV/s scan rate and 10 μA/V sensitivity), and multiple cycles of CV measurement of 4 ml silver NPs solution added to buffer solution with NaCl in FIG. 180 (experimental condition: 50 mV/s scan rate and 100 μA/V sensitivity); and

FIGS. 181-185 depict plots of data for CV measurements under various scan rates from 20 mV/s to 250 mV/s with a sensitivity of 0.1 mA/V in FIG. 181 and square root of scan rate compared to the current for each peak in FIGS. 182-185.

Where applicable like reference characters designate identical or corresponding components and units throughout the several views, which are not to scale unless otherwise indicated,

### DETAILED DISCUSSION

Broadly, the discussion that follows describes various embodiments of a filter device that utilizes a multi-layer structure. Examples of this multi-layer structure can comprise a substrate and a membrane, disposed on the substrate; although certain configurations may focus on the membrane (both as a singular layer and multi-layer structured embodiment. These examples can leverage certain advantages of poly(amic) acid that helps to formulate the layers (and/or layered structure) with a porous structure having pores with pore sizes of 100 nm or less. As further noted herein, these advantages further provide uniform and controllable pore size/structure/configuration to adapt the resulting membrane and/or filter device for use to capture, isolate, and/or detect nano-sized particulates,

### I. Discussion of Embodiments

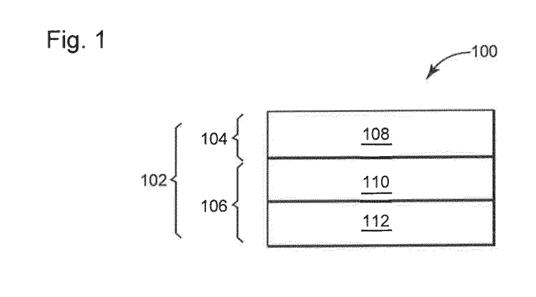

FIG. 1 depicts a schematic diagram of an exemplary filter device 100 that can filter nano-particles, e.g., out of a flow F. The filter device 100 includes a layered structure 102 with a plurality of layers a first layer 104 and a second layer 106). The first layer 104 includes a membrane 108. The second layer 106 may include one or more sublayers (e.g., a first sublayer 110 and a second sublayer 112), which can be of the same and/or different constructions.

At a relatively high level, embodiments of the filter device 100 can capture, isolate, and detect nano-particles, e.g., silver nano-particles (AgNPs). These embodiments incorporate pores and cavities, one or more of which may be interconnected to form three-dimensional pores and cavities. This construction traps and/or fixes nano-particles. Moreover, the resulting structure has sufficient porosity to avoid clogging that may reduce the efficacy of the filter device 100.

The membrane 108 affords the filter device 100 with features that facilitate removal of particulates, e.g., from the flow F. These features may include, for example, physical and/or chemical properties that prevent particles, e.g., nano-particles, from transiting through the layered structure 102. Examples of the membrane 108 can comprise poly(amic) acid (FAA) membranes and membranes of like composition, e.g., that include poly(amic) acid as a constituent component.

On the other hand, the second layer 106 may provide structural features that provide rigidity and support to the first layer 104. In one embodiment, the sublayers 110, 112 can exhibit finger-like (e.g., macrovoids) and sponge-like properties. Exemplary compositions for the sublayers 110, 112 can include porous materials (e.g., filter paper) as well as other materials compatible with filtration applications.

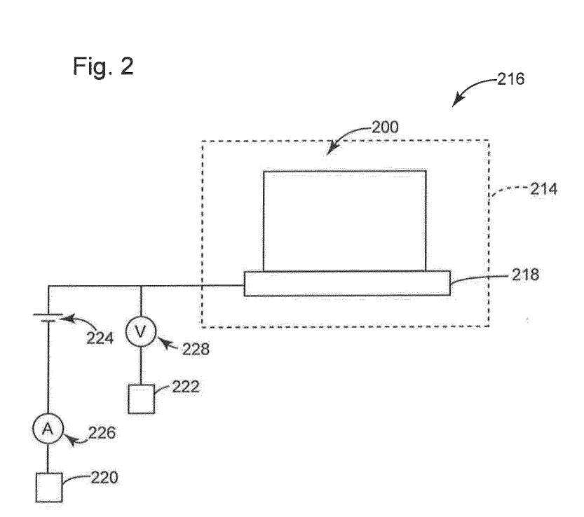

FIG. 2 depicts a schematic diagram of a filter device 200 as part of a sensor device 214 that operates as part of a measurement system 216. The sensor device 214 includes a first electrode component 218. The measurement system 216 also includes a second electrode component 220 and a third electrode component 222. In one example, the measurement system 216 also includes a power source 224 (e.g., a battery) and one or more meter devices (e.g., an amperemeter 226 and a voltmeter 228).

### II. Discussion of Implementation

The devices and membranes disclosed herein may embody biosensors, biochips, nano-sensors, electrocatalysts and microelectronic devices. Fabrication of the membranes, membranes, and like polymeric materials (collectively, “membranes”) may exploit a combination of strategies including chemical, electrochemical, hot embossing, and imprinting techniques. Imprinting techniques, for example, can allow sub-micrometer patterning with dimensions smaller than 100 nm on hard imprint materials. The oxidation of a π-conjugated conducting polypyrrole with gold trichloride, silver nitrate, palladium ions, and copper sulfate following photochemical reaction can produce conducting membranes having metal clusters in 5-100 nm range.

The techniques that are available to fabricate membranes for sensing and other applications include solvent casting, spin coating, chemical polymerization, and electro-polymerization. Of these, immobilization of biomolecules in electro-polymerized membranes allows for electrochemical control of various parameters such as the thickness of the membrane, the biocomponent loading, and/or the biocomponent location. However, the extreme hydrophobicity and insolubility of the polypyrrole matrix can trigger protein adsorption, which might be less ideal for some sensing applications. In other embodiments, membranes may possess a hydrophilic surface for low unspecific binding. Moreover, membranes can possess one or more functional groups that are configured to attach biomolecules or can be easily functionalized, e.g., for purpose of bonding with biomolecules. Some membranes may be suitable for operation in harsh conditions and, in this case, this disclosure contemplates membranes that are configured with special mechanical and chemical resistance, e.g., almost inert, for these conditions.

The membranes herein may find use in polyfunctional materials because of the presence of amide and carbonyl functionalities. An average functionality in these membranes are found in a range from about 160 to about 600 depending upon molecular weight. Reactive materials having two or more functionalities can crosslink the membrane to produce a high molecular weight cross-linked polymeric framework. The membrane can act as a precursor of PIs with cation complexing properties. Complexing power of the membranes may be significantly higher than that of the imide form; thus rendering the membrane with carboxylic acid groups that exhibit polyfunctional behavior. Moreover, in some embodiments, the membrane can comprise mono-dispersed, nano-scale particles (e.g., of noble metals) that can be used to create a high density of anchor groups for directed immobilization of biomolecules. Conversion of PAA to PIs typically occurs via thermal imidization process involving the loss of water molecules.

As noted herein, embodiments of the membranes (and related films, layers, coatings, etc.) can be highly flexible, mechanically strong, and ternary polymeric blends of PAA, Si—O—Si framework, and metal NPs. In one embodiment, the resulting copolymer can retain the functional moieties of the membrane with enhanced mechanical properties compared to the parent PAA. This disclosure also contemplates a new approach for creating flexible, stand-alone PAA hybrid co-polymers. The carbonyl and amide functionalities in PAA act as anchors resulting, in one example, in the fabrication of flexible, nano-structured, PAA-silicone-gold membranes. Although structurally and mechanically different from the parent PAA, copolymerization with silanes can significantly improve the porosity and mechanical property of the PAA membrane. Membranes of this disclosure are found to have properties including one or more of flexible, rigid, brittle, transparent, and mechanically strong, often depending on the synthesis conditions and composition.

As noted more below, the discussion provides several implementations to quantify and/or qualify embodiments of the membranes. In one implementation,

### A. Implementation I

All reagents are analytical grade unless otherwise stated. The following reagents were obtained from Sigma-Aldrich Co.: 4,4′-oxydianiline (ODA), pyromellitic dianhydride (PMDA), gold (III) chloride, N-[3-(trimethoxysilyl)-propyl]aniline (TMOSPA), 3-aminopropyl-trimethoxysilane (APTMOS), dichlorodimethylsilane (DCMS), N,N-dimethylacetimide (DMAc). Tetramethoxysilane (TMOS) was obtained from Thermo Fisher Scientific Inc. All water used was triply distilled de-ionized water with resistivity of 18 MΩ or better. Gold (III) chloride was dissolved in water to make 0.1M aqueous solution. Various silanes were dissolved in DMAc to make 150 mg/ml silane DMAc solutions. Thermal curing was achieved using a Fisher Scientific Isotemp programmable force-draft muffle furnace (Series 750, Model 126).

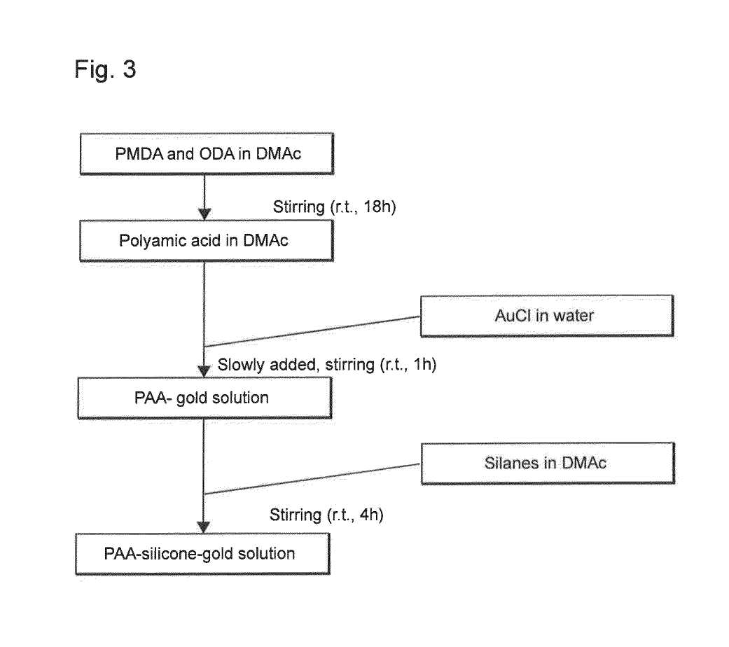

FIG. 3 illustrates an exemplary embodiment of a method to fabricate an example of a PAA membrane. PAA was first synthesized by dissolving ODA in DMAc and then PMDA was added slowly into the solution with continuous stirring for 18 hours. Aqueous Gold (III) chloride solution was added to the resulting yellow viscous solution of PAA that was prepared in DMAc as solvent. Following the addition of gold chloride solution, which completely dissolved in PAA DMAc solution, the stirring was continued for additional 2 hours. Finally various silanes that have been dissolved in DMAc were added into the above solution. The final solution was stirred for additional four hours resulting in an example of a PAA-gold-silicone (PSG) copolymer. The solutions without addition of one or more second component (also “additive”) (e.g., gold, silanes, etc.) led to examples of PAA-silicone (PS) and PAA-gold (PG), respectively. The final solutions were used to fabricate an example of PAA membrane and its derivative membranes and films through thermal curing process. Thermal curing process is dry phase-inversion process. In one example of the thermal curing process, PAA and its derivatives solutions were applied onto flat glass substrates and then heated in the furnace at 75° C. for 1 h to form thin membranes and/or films.

Copolymers were prepared using a fixed composition of PAA, gold, and silane while curing temperatures were varied. All PSG membranes in this series have similar weight ratio of 100:20:1 for PAA/silane/gold using two silanes, TMOS and TMOSPA (4:1 in weight ratio). The PSG membranes were heated at varying temperatures (75° C., 100° C., 150° C., 200° C., 250° C., 300° C.) in a temperature-controlled furnace.

In one example, copolymer membranes were prepared using a fixed composition of PAA and silanes with varying amounts of gold. The weight ratio of PAA/silanes/gold in these examples was 70:17:x (wherein, x is 1, 2, 3, etc.). The silanes added in this series are DCMS, TMOS and APTMOS (6:1:1 in weight ratio). The resulting polymer membranes and films containing different amount of gold were compared.

In another example, polymers have fixed composition of PAA and gold with various addition amounts of different silanes. The gold and PAA contents in PSG membranes has a weight ratio of 3:140 (gold:PAA). The polymer membranes resulting from various addition of silanes were compared.

Characterization of the membranes utilized proton NMR, ¹³C NMR, XRD, and FTIR techniques to obtain the chemical structure of the polymers. ¹H NMR and ¹³C NMR spectra were recorded on a Bruker AM 360 spectroscopic system equipped with 8.45 T magnet and multinuclear and inverse detection capabilities at 360 MHz and 20° C. Samples were dissolved in DMSO-d6 and prepared into 25 mg/ml DMSO solution. Infrared spectra were recorded with a Bruker Equinox 55 spectrophotometer equipped with OpusNT software version 2.06. Samples were grounded into fine powder and then mixed with KBr (FUR grade) in a 1:99 ratio; 0.1 g powdered mixture were pressed into pellet for IR analysis; 0.1 g pure KBr salt (FTIR grade) was also made into pellet as blank sample. The crystallinity of gold NPs was assessed from thin film XRD patterns obtained on a Siemens D5000 X-ray diffractometer with a Cu Kα₁ monochromatized radiation source (λ+1.540562 Å) operated at 40 kV and 30 mA.

A 1×2 cm PSG membrane slice was placed in a 3 ml quartz cuvette and measured by HP8453 UV-Vis spectrometer using empty quartz cuvette as blank. Two slices of different thickness (85 μm and 0.5 mm) were compared.

The flexibility and fatigue characterizations were tested on an open air fatigue tester. PAA, PG, and PSG solutions were dropped on a substrate (e.g., polyethylene terephthalate (PET) strips) to form thin membranes. The samples were wrapped on fatigue tester for bending test with bending radius of 3 mm. Images of sample surfaces were taken by Zeiss Axio Imager M1M Advanced Upright Compound Microscope before and after each bending test which bend these membranes for 1000 and 5000 times separately. Information regarding the membrane's thermal stabilities and degradation properties were collected using TGA and DSC techniques respectively. Thermogravimetric analysis was conducted using TA Instruments TGA-Q50 equipped with Q series Explorer software. The membranes were heated from room temperature to 800° C. with an increase of 20° C. per minute using ramp method. DSC was performed (TA Instruments DSC-Q200) using the ramp method with hermetic sample holders for the analytes and an empty sample holder as reference. The polymer samples were heated from −10° C. to 400° C. at the rate of 5° C. per minute.

In solubility tests, about 0.42 mg PAA series membranes were dissolved in 5 ml various solvents. Two sets of solvents were used. The first set were aqueous solutions of HCl and NaOH with various concentration and at different pH values. The concentrations of HCl solutions were from 1M to 10⁻⁶M with pH values from 0-6. The concentrations of NaOH solutions were from 1M to 10⁻⁶M with pH values from 8-14. Another set includes various organic solvents ranging from non-polar to polar; namely toluene, hexane, ethyl acetate, carbon tetrachloride, acetone, chloroform, methanol, ethanol, acetonitrile, dimethylformamide (DMF). DMAc and dimethylsulfoxide (DMSO). All chemicals were purchased from Fisher Scientific, Inc. (USA).

Electrochemical measurements were performed using an EG&G Princeton Applied Research 263A potentiostat/galvanostat equipped with M398 software. A conventional three-electrode system was employed in electrochemical measurements, which consists of a glassy carbon electrode (GCE) (with a geometrical area of S=0.11 cm²) as working electrodes, a Ag/AgCl reference electrode (RAS), and a platinum wire as auxiliary electrode. The working electrode was polished with alumina, sonicated for five minutes, and copiously rinsed with triply-distilled de-ionized water followed by methanol rinse. Cyclic voltammetry (CV) was used to characterize the electrochemical properties of the PSG membrane. In one example, PSG membranes are deposited onto Glassy Carbon Electrodes (GCE) by thermal curing process. The modified GCE electrode was used as working electrode. The bare GCE electrode was tested as the blank, PG membranes modified electrode was tested as the control or reference materials. To check the electroactivity of all these polymer membranes, the CV experiments were performed in 0.1M pH6 PBS solution²⁴ by scanning the potential between −400 mv to 1200 mv at a scan rate of 150 mV/s. Differential pulse voltammetry (DPV) was used to further investigate the electrochemistry of PSG on electrode using similar conditions as the CV. All electrochemical measurements were repeated more than three times using different GCE electrodes. NaH₂PO₄.H₂O and Na₂HPO₄.7H₂O were dissolved in water and adjusted with NaOH to prepare 0.1M pH 6.0 PBS buffer.

SEM and transmission TEM were employed for surface morphology and particle size characterization. EDS analysis was conducted to provide surface elementary information. SEM and EDS analyses were conducted on a Zeiss Supra 55 VP, analytical ultra high resolution FESEM+EDAX Pegasus EDS+EBSD, equipped with SmartSEM™. The acceleration voltage of SEM analysis was 5 kV with maximum magnification of 5×10⁶. The sample membranes were fixed on a 45°/90° aluminum SEM mount using carbon conductive tape. Elemental composition information of membranes was obtained at the same time using EDS. The acceleration voltage was 20 kV with magnification of 20000 and working distance about 10 mm. For TEM imaging, one drop (˜5 μl) of 8.4 mg/ml PSG DMAc solution was dropped on 300 mesh copper TEM grid purchased for Ted Pella, Inc., and then dried at room temperature before was imaged by a TEM microscope manufactured by Toshiba.

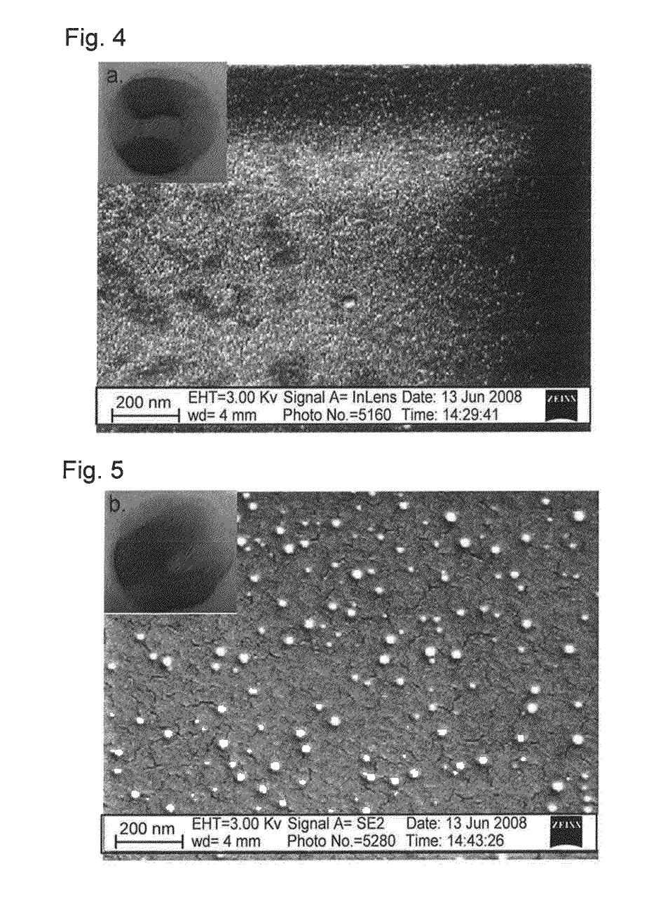

As shown in FIG. 4A, 4B, 4C, increasing temperatures can change the color of the membranes from yellow to green to brown. SEM data showed that both the number and size of NPs increased inside the copolymer (see also TABLE 1 below that describes a range of particle sizes and number on PSG membranes which are thermally-cured at various temperatures). Majority of the particles in the 100° C. PSG membrane were estimated to be ˜25 nm in size. Particles in membranes that were thermally cured at 1.50° C. PSG were close to 30 nm in size, while the particles in the 200° C. PSG membrane reached the 35 nm size regime. The increase in gold particle size can be attributed to the thermal motion as noted for the synthesis of silver NPs sequestered polymer in study of silver NPs in PI. As temperature increased, gold particles began to shift to the surface and subsequently aggregate. When the temperature reached 300° C., the membranes were physically observed to be damaged by the high temperature. SEM images at 250° C. and 300° C. curing temperatures showed that the NPs gradually disappeared from the surface, creating pores at the limiting curing temperatures of 300° C. The reason for this is unclear, but it could be attributed to the increased thermal motion of the particles at these temperatures, leading to the enhanced porosity. In order to retain the functional moieties in PAA polymer, 75° C. may be chosen for thermal curing to generate a PAA series of membranes.

TABLE 1

| | Range of particle size | Number of particles |
|---|---|---|
| Temperature | (nm) | in 1 μm² |
| 100° C. | 15-30 | 82 |
| 150° C. | 20-35 | 172 |
| 200° C. | 22-35 | 123 |
| 250° C. | 18-20 | 21 |
| 300° C. | 19-33^{a} | 115^{b} |

^{a}Range of pore size (nm).
^{b}Number of pores in 1 μm²

Increases in the gold concentration can prevent the PSG solutions to evenly disperse on the surface to form thin membranes due to increasing surface tension of the gold in the solution. In turn, this feature can also influence the mechanical properties of the resulting PSG membrane. TABLE 2 describes weight and molar ratios of PAA, gold, and silanes in PSG membranes. This information shows that PSG membranes with higher gold content were found to be rigid and opaque, while PSG membranes with lower gold content are flexible.

TABLE 2

| | | | silanes^{c} | | | |
|---|---|---|---|---|---|---|
| | | PAA:silicone^{b} | APTOMS:TMOS:TMOSAP | | | |
| Sample | PAA:gold^{a} | (weight ratio) | (weight/molar ratio) | Observation^{d} | | |
| 1 | 70:3/16:3 | 4:1 | 4:3:1 | T | F | B |
| 2 | 70:2/8:1 | 4:1 | 4:3:1 | T | F | B |
| 3 | 70:1/16:1 | 4:1 | 4:3:1 | T | F | S |

^{a}Weight and molar ratio of PAA and gold, as calculated from the initial amount of ODA, PDMA and gold salt, assuming complete reaction;
^{b}Weight of PAA and silicone, assuming complete reaction;
^{c}Weight ratio of silane;
^{d}T, transparent; F, flexible; B, brittle; S, strong

Observations of this set of membranes are summarized in TABLE 3 below, which indicates weight and molar ratios of PAA, gold and silanes in PSG. By varying the amount and types of silanes in PSG copolymer, the membranes can be prepared with certain properties (e.g., rigid or flexible; opaque or transparent; good or poor mechanical property, etc.). Among the silanes tested, DCMS did not produce desirable effect for thin membranes and membranes, while silanes such as APTMOS, TMOS and TMOSPA which were usually used as linkers and condensers, worked very well to produce thin PSG membranes. Also, it is found that it was easier to disperse the PSG solution containing high gold content when TMOS or TMOSPA were added than when they were absent. So APTMOS, TMOS and TMOSPA were used in further synthesis of PSG with a weight ratio of 4:3:1.

TABLE 3

| | PAA:gold^{a} | | | | | |
|---|---|---|---|---|---|---|
| | (weight/molar | PAA:silicone^{b} | silanes^{c} | | | |
| Sample | ratio) | (weight ratio) | (weight ratio) | observation^{d} | | |
| 1 | 140:3/32:3 | 4:1 | TMOS:APTMOS = 3:1 | O | R | B |
| 2 | 140:3/32:3 | 4:1 | TMOS:APTMOS = 4:1 | T | R | B |
| 3 | 140:3/32:3 | 7:3 | TMOS:APTMOS = 5:1 | T | R | B |
| 4 | 140:3/32:3 | 4:1 | DCMS:APTMOS:TMOSPA = 6:1:1 | T | F | B |
| 5 | 140:3/32:3 | 4:1 | DCMS:APTMOS:TMOSPA = 4:3:1 | T | F | B |
| 6 | 140:3/32:3 | 7:3 | DCMS:APTMOS:TMOSPA = 3:2:1 | T | F | B |
| 7 | 140:3/32:3 | 4:1 | DCMS:TMOS:TMOSPA = 6:1:1 | O | R | B |
| 8 | 140:3/32:3 | 4:1 | DCMS:TMOS:TMOSPA = 4:3:1 | T | F | B |
| 9 | 140:3/32:3 | 7:3 | DCMS:TMOS:TMOSPA = 3:2:1 | O | R | B |
| 10 | 140:3/32:3 | 4:1 | APTMOS:TMOS:TMOSPA = 6:1:1 | T | F | B |
| 11 | 140:3/32:3 | 4:1 | APTMOS:TMOS:TMOSPA = 4:3:1 | T | F | S |
| 12 | 140:3/32:3 | 7:3 | APTMOS:TMOS:TMOSPA = 3:2:1 | T | F | S |

^{a}Weight and molar ratio of PAA and gold, as calculated from the initial amount of ODA, PDMA and gold salt, assuming completely reaction;
^{b}Weight of PAA and silicone, assuming complete reaction;
^{c}Weight ratio of silanes;
^{d}O, opaque; T, transparent; R; rigid; F, flexible; S, strong; B, brittle.

According to the results of these optimization tests of copolymers, further studies were performed on PSG membranes using the composition with PAA/silanes/gold (70:17:1 in weight ratio) because it has desirable mechanical property including flexibility and transparency. The silane composition used was APTMOS/TMOS/TMOSPA (4:3:1 in weight ratio). In this PSG membrane, the molar ratio of PAA/gold was 16:1 and the molar ratio of PAA/APTMOS/TMOS/TMOSPA was 20:5:5:1.

The properties of PSG membranes were compared with membranes comprising pure PAA and/or PAA with or without addition of silicone component.

FIG. 5 and TABLE 4 below summarize the FTIR spectra (and vibrational frequencies) of PAA membranes and PSG membranes recorded in a 1% mixture with KBr. The absorption bands that occur around 3274 cm⁻¹ (broad), 1642 cm⁻¹, 1602 and 1377 cm⁻¹ indicate the presence of amide group, while the bands occurring around 2610 cm⁻¹ (broad) and 1716 cm⁻¹ can be assigned to the vibrational modes of carboxylic acid. A spike appearing at 3044 shows the existence of NH. The strong peak around 1100 cm⁻¹ is associated with a stretching vibration of the ether group. When compared with the peaks appearing around 1716 cm⁻¹, 1642 cm⁻¹ and 1602 cm⁻¹, the height of peak assigned to carboxylic acid group increased from PAA to PSG while the height of peaks assigned to amide group decreased from PAA to PSG. The height ratio of C═O stretch peak at 1716 cm⁻¹ and N—H bending peak at 1602 cm⁻¹ were about 1:1 in PAA while it changed to 4:3 in PSG. By designating the amount of carboxylic acid group as a constant, the magnitude of the amide group may decrease, e.g., by one forth. This reduction in magnitude implies that some amide groups reacted with gold (III) chloride during the formation of PSG copolymer. The —NH— group might have been oxidized by AuCl₃ and hydrogen might already have been lost from the amide group. This reaction is evidenced by the decreased peak height at 1602 cm⁻¹ assigned to the bending vibrational mode of N—H. There are also two small peaks indicating vibration of Si—O—Si and O—Si—O¹⁸⁹ at 788 cm⁻¹ and 463 cm⁻¹, thus confirming the co-polymerization of PAA-silanes formation in the resulting PSGs.

TABLE 4

| Compound | v_{CO—NH} | v_{COOH} | v_{N—H} | v_{C—O—C} | v_{Si—O—Si} | δ_{O—Si—O} |
|---|---|---|---|---|---|---|
| PAA | 3274 (broad), | 2610 | 3044 | 1098 | no | no |
| | 1642, 1602, | (broad), | (spike) | | | |
| | 1377 | 1716 | | | | |
| PSG | 3372 (broad), | 2604 | 3044 | 1112 | 788 | 463 |
| | 1649, 1604, | (broad), | (spike) | | | |
| | 1377 | 1720 | | | | |

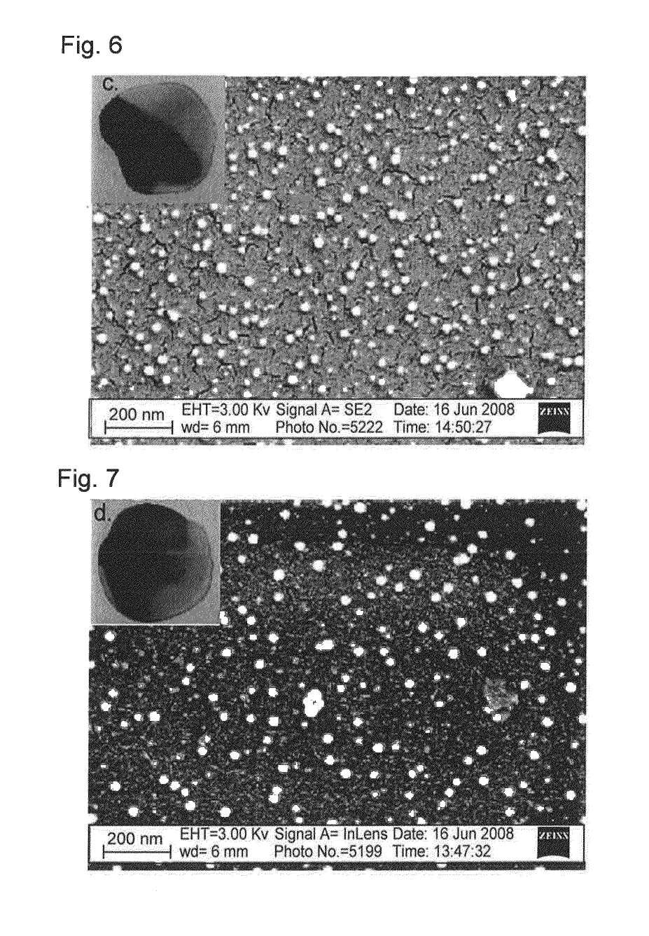

FIG. 6A, 6B, 6C depicts NMR spectra of various PAA copolymers to further characterize examples of the PAA-silanes co-polymer formation. Generally, ¹H NMR spectra of PAA was found to coincide with that of PSG and both were recorded in the range 6.2 ppm to 14 ppm (FIG. 6a). The peaks appearing around 10.55 ppm were attributed to the protons on the amide groups. The peaks in range of 6.6 ppm-8.4 ppm confirmed the presence of the aromatic protons. In both PAA and PG polymers, there was a soft peak between 12 ppm to 13 ppm which can be assigned to the protons on carboxyl group. However this peak was not shown in the PSG spectrum and may indicate the lost of protons on carboxyl group in the PSG. Since the major compositional difference between PSG from PAA and PG is Si—O—Si framework composition, the absence of the carboxyl peak is an indication of amide formation between Si—O—Si framework and PAA through their amine and carboxyl functionalities. This assertion is further strengthened by the data obtained from the ¹³C NMR studies showing the existence of peaks for carboxylic acid group around 167 ppm (FIG. 6b). Results from the ¹³C NMR experiments also confirmed the presence of amide groups in both PAA and PSG membranes through the appearance of peaks at 166 ppm. Another peak appearing at 165 ppm was assigned to anhydride groups at the end of PAA chain. The peak appearing at 153 ppm was due to the carbon next to the oxygen in ODA. ¹³C NMR peaks from 115 ppm to 145 ppm were assigned to the aromatic carbon atoms in the polymers. In accordance with their ¹H NMR spectra, most parts of ¹³C NMR spectra for both PAA and PSG were similar. However, there are additional ¹³C NMR peaks appearing at 112 ppm and 131 ppm respectively in PSG (circled in FIG. 6b). These two peaks may indicate the different aromatic carbon atoms in PSG from the ones in PAA. These differences had been attributed to the addition of silanes and the two new peaks quite possibly belong to the ortho and meta carbons on the benzene ring on TMOSPA. These peaks suggest the existence of Si—O—Si framework in PSG. The NMR results for PAA, PG and PSG are summarized in TABLE 5 below, which identifies NMR chemical shifts of PAA, PG, and PSG membranes. Although NMR did not show much evidence about the binding between the terminal anhydride group and amide group of APTMOS, this reaction has a high possibility of taking place. The possible reactions and structures of these polymers were shown in FIG. 6.

TABLE 5

| | | | | ¹³C NMR (ppm) | | | |
|---|---|---|---|---|---|---|---|
| | | | | | | | Ortho and |
| | Proton NMR (ppm) | | | | | | meta carbon |
| | Aromatic | Carboxyl | Amide | Aromatic | Carboxyl | Anhydride | on |
| | ring | group | group | ring | group | group | TMOSPA |
| PAA | 6.6-8.4 | 12.4 | 10.5 | 114.5-141 | 167 | 165 | no |
| PG | 6.6-8.4 | 12.6 | 10.5 | 115-141 | 167 | 165 | no |
| PSG | 6.6-8.3 | no | 10.6 | 115-144 | 167 | 165 | 112 and 131 |

FIG. 7 illustrates XRD spectra of examples of thermally-cured PAA series membranes. XRD analysis of PAA and PSG were performed to determine the chemical states of the gold incorporated within the PSG membranes. The diffractograms exhibit the peaks characteristics of crystalline state for metals. PAA gives peaks at 28.5°, 42.24°, 64.58° and 81.72°. PSG gives two additional peaks at 38.66° and 77.96°. All the peaks from 38.66° to 77.96° in PSG membranes coincided with peaks of synthetic Au in XRD PDF document 040784. The full width at half-maximum of the strongest characteristic reflection in PSG was used to estimate the average crystallite size of gold by applying the Scherrer Equation as illustrated in Equation (1) below. The crystallite size of gold particles in PSG membranes is around 25 nm

B=Kλ/L cos θ Equation (1)

wherein B is the width of the peak at half maximum intensity in radians, K is a constant between 0.89 and 1 (0.9 was used in this calculation), λ is the wavelength of incident x-rays which is 1.540562 Å, θ is Bragg angle, and L is the crystallite length.

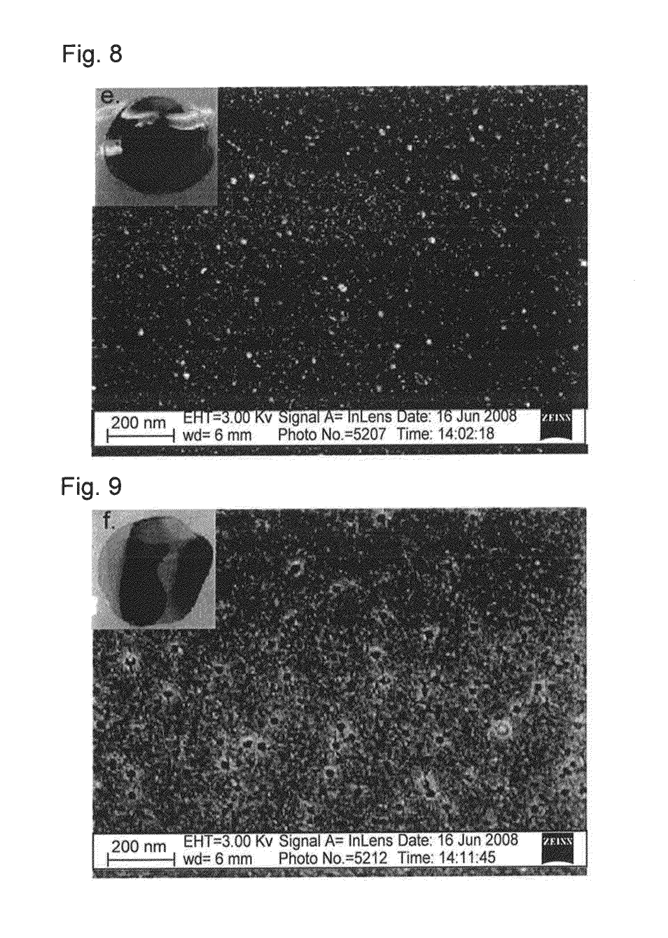

FIG. 8A, 8B illustrates one example of the possible reactions during synthesis process of PAA membrane. The results of these chemical composition and structural characterizations suggests that PAA was first synthesized by preventing its imidization to PI when it was thermally-cured at 75° C., and thus retained the carboxylic acid and amine functionalities. Following the addition of the gold salt, the amide group in PAA is oxidized by AuCl₃ to form the gold NPs. This step is followed by the formation of amide bonds between the PAA carboxyl group/anhydride group and the amino group of APTMOS, cross-linking the NP-containing PAA with TMOS and TMOSPA into silicone copolymer, and finally resulted in the production of a Si—O—Si framework.

With reference to FIG. 9, PSG membranes can have a reddish yellow color, and the UV-Vis spectra shows that PSG membranes are transparent in most light spectrum range except for an absorbance band from 280 nm to about 400 nm which depends on the thickness of the membrane. The absorbance band of the thicker membrane is broader than the thinner one.

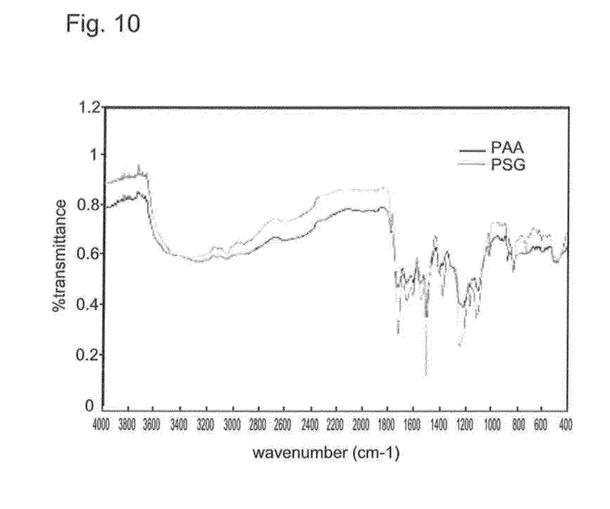

FIG. 10 illustrates images of various examples of PAA series membranes. PSG solution can be easily dispersed on PET surface to form a thin membrane at 75° C. As shown in FIG. 10a, PSG membrane was firmly coated onto the PET substrate. In FIG. 10b, images of PAA, PG and PSG membranes on PET taken by M1M microscope show that they were stable after even 5000 times bending. There were no obvious cracks, damage and detachment. And the minimum bend radius for these membranes is 3 mm.

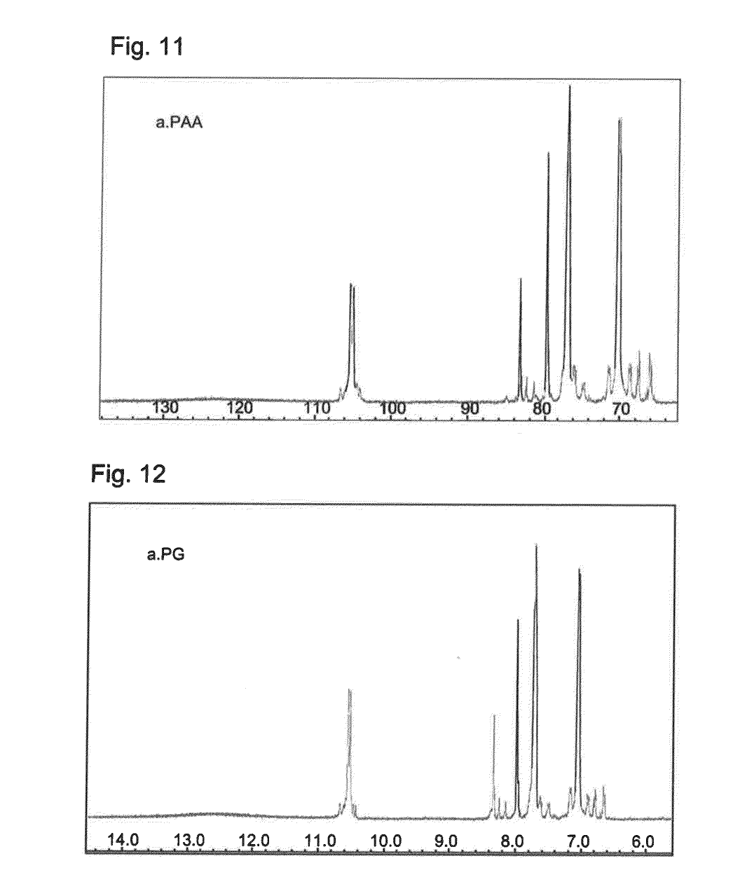

With reference to FIG. 11A, 11B, TGA experiments were carried out for all the membranes (PAA, PG, PS and PSG) and the results show similar thermal degradation properties (FIG. 11a). The change in the weight percentage can be divided into three parts accompanied with temperature change. Before 150° C. (Stage 1), there was a slight change in the weight percentage which was caused by the evaporation of water and DMAc. As temperature increased, the evaporation of DMAc superseded the evaporation of water and the mass loss became quicker when the temperature reached 150° C., approaching the boiling point of DMAc (165° C.) and simultaneous imidization of PAA (Stage 2). Hence the significant weight percentage change recorded at this stage is attributed to the loss of water released from the imidization process and evaporation of DMAc. Around 350-400° C., stable weight percent change was recorded. Stage 3 began from about 550° C., at this stage the membranes completely degraded and charred. The similarity in the TGA characteristics recorded for PG, PS and PSG due to the fact that majority of the membranes are mainly PAA. The TGA analysis also shows that these membranes were not stable beyond 150° C. and could lose functional groups under high temperature. FIG. 11b shows the typical results of DSC analysis. There were two sharp dips in both PAA and PSG, the first appeared at about 130° C. due to the evaporation of water and the other dip was observed at about 150° C. indicating the crosslink reaction because of the imidization process and evaporation of DMAc. These results coincide with the TGA data. The glass transition temperatures of PAA and PG were similar at about 100° C., while that of PSG was 122° C.

HCl solution, NaOH solution and pure water were used as solvents for solubility test. In one example, only the high pH (≧12) NaOH solution was found to “dissolve” PSG membranes. PSG membranes did not change or swell in other lower pH solutions. However, no PSG membranes recovered after exposed to high pH NaOH solutions. This observation implies that PSG may actually hydrolyze in this high pH NaOH solution instead of simple dissolution. Other PAA membranes showed the similar solubility behavior. TABLE 6 summarizes the solubility of PSG in aqueous solution at various pH values.

TABLE 6

| | HCl | | | | | | H₂O | | NaOH | | | | | | |
|---|---|---|---|---|---|---|---|---|---|---|---|---|---|---|---|
| Conc. (M) | 1 | 0.1 | 10⁻² | 10⁻³ | 10⁻⁴ | 10⁻⁵ | 10⁻⁶ | n/a | 1 | 0.1 | 10⁻² | 10⁻³ | 10⁻⁴ | 10⁻⁵ | 10⁻⁶ |
| pH | 0 | 1 | 2 | 3 | 4 | 5 | 6 | 7 | 8 | 9 | 10 | 11 | 12 | 13 | 14 |
| Solubility | n | n | n | n | n | n | n | n | n | n | n | n | ps | s | s |

n. Not soluble;
ps. Partially soluble;
s. Soluble

Several common organic solvents were tested for solubility and most PAA membranes only dissolved in highly polar organic solvents such as DMF, DMSO and DMAc. TABLE 7 summarizes solubility of PAA series membranes in organic solvents. In one example, the dissolved membranes can be recovered by evaporating the solvents.

TABLE 7

| Solvents | PAA | PG | PS | PSG |
|---|---|---|---|---|
| DMSO | s | s | s | s |
| DMAc | s | s | s | s |
| DMF | s | s | s | s |
| Acetonitrile | n | n | n | n |
| Ethanol | n | n | n | n |
| Methanol | n | n | n | n |
| Chloroform | n | n | n | n |
| Acetone | n | n | n | n |
| Carbon tetrachloride | n | n | n | n |
| Ethyl acetate | n | n | n | n |
| Hexane | n | n | n | n |
| Toluene | n | n | n | n |

n. Not soluble; s. Soluble

FIG. 12A, 12B shows the CV and DPV data obtained at PG, PSG modified GCE electrodes. PSG membranes were deposited onto GCE electrode by both thermal curing and wet phase-inversion process. Bare GCE electrode was tested as the blank while PG membranes modified electrode was considered as the control. As shown in FIG. 12a, PSG membranes gave three oxidation peaks and three reduction peaks at varying scan rates (TABLE 8 below, which shows oxidation and reduction peaks in CV and DPV characterization). These peaks are quite similar with peaks observed in conducting polymer such as PAA, polypyrrole, and polyaniline. The voltammetric currents for the first pair of redox peaks at about 300 mV and 100 mV were compared with square root of scan rate and a linear relationship was observed, indicating a reversible redox reaction. Since the scan rate at 150 mV/s enabled the best resolution and shape of these peaks, further CV experiments were performed in 0.1M pH 6.0 phosphate buffer solution (PBS) at a scan rate of 150 mV/s from −400 mV-1200 mV.

DPV was used to further investigate the electrochemistry of PSG on the solid electrodes. All electrochemical potentials were measured vs. silver/silver chloride. FIG. 12b shows the CV for PG and PSG modified electrodes. Both membranes are conductive and electroactive. PSG has three oxidation peaks at 303 mV, 592 mV and 971 mV respectively with two reduction peak at 111 mV and 578 mV. As summarized in TABLE 8 below, PSG membranes showed a reversible oxidation peak at 303 mV followed by one quasi-reversible oxidation peak and another irreversible oxidation peak. PG exhibit additional reduction peak at 631 mV compared to PSG which corresponds to a quasi-reversible oxidation at 884 mV. In addition, one oxidation peak was observed for PG at 1074 mV using the CV and this coincides with its DPV results (FIG. 12c). This peak can be assigned to the sequestered gold in the PG although PSG did not exhibit similar peak due to the presence of the Si—O—Si composition.

TABLE 8

| | CV | | DPV |
|---|---|---|---|
| Polymer | Oxidation peaks | Reduction peaks | Oxidation peaks |
| PG | 247 mv, 494 mv, | 71 mv, 431 mv | 214 mv, 441 mv, |
| | 884 mv, 1074 mv | | 835 mv, 1007 mv |
| PSG | 238 mv, 505 mv, | 119 mv | 183 mv, 442 mv, |
| | 990 mv | | 583 mv |

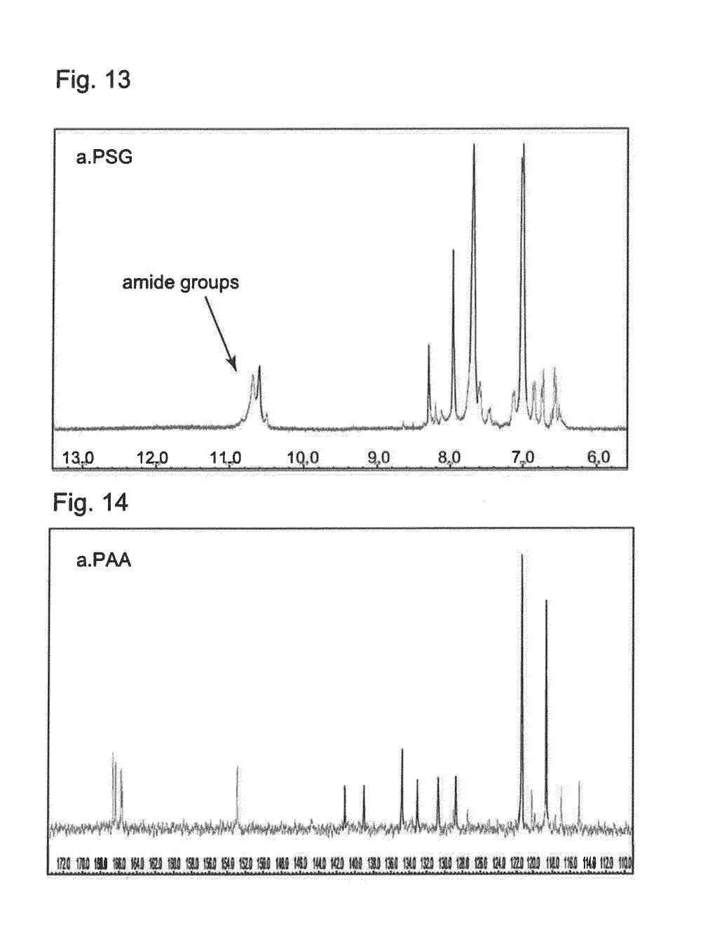

PG membranes with various gold concentrations were also tested with DPV method. The ratio of PAA and gold was the same as noted above. As shown in FIG. 13, with increasing gold concentration from PG3 to PG1, the peak at 1007 mV assigned to gold appeared and increased as well.

FIG. 14 illustrates various SEM images that are the result of SEM and EDS analysis performed on exemplary PG and PSG membranes. This analysis is meant to determine the morphology of the membranes and to identify the nature and distribution of metallic particles in PSG membranes. The images on the left side (FIGS. 14a and 14c) are the images of PG membranes and the images on the right side (FIGS. 14b and 14d) are the images of PSG membranes. The surfaces of PG membranes and PSG membranes are generally smooth. Gold NPs ranging from 30 nm to 120 nm are well dispersed on the surface of PG. Most of gold NPs are spherical and some bigger NPs are either triangular or hexagonal in shape (FIG. 14a circled). However few gold NPs were observed on the surfaces of PSG membranes (FIG. 14b). By comparing the gold NPs inside the PG with those inside the PSG membranes, it is obvious that there are more NPs sequestered within the PSG membrane than within the PG membrane (FIGS. 14c and 14d). The absence of gold NPs on PSG membrane surface could due to the addition of silicone which form cross-linked frame work and held the gold NPs inside the membrane instead of shifting to the surface.

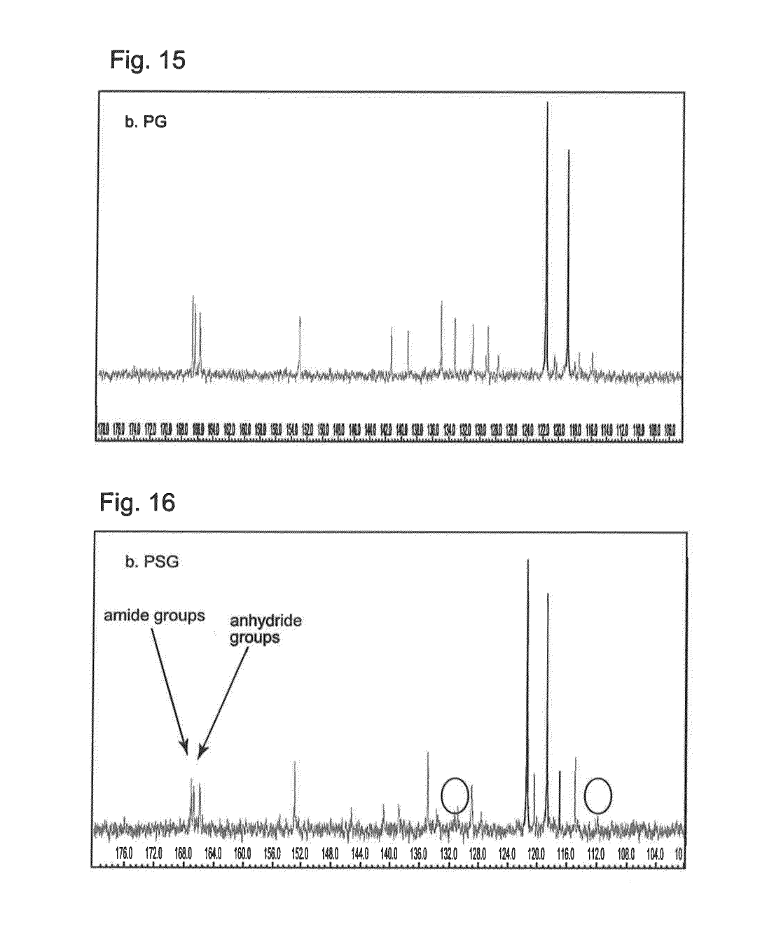

Referring now to FIGS. 15 and 16, EDS technique was used to confirm the elements on PSG membranes. EDS measurements identified carbon, and oxygen as the principal elements of this material. FIG. 15 shows that EDS also confirmed the existence of elemental gold, chlorine, and silicon in the membranes. In FIG. 16, the peaks for aluminum and sodium may come from the sample holder or impurity in sample. EDS mapping images, in which the color dots stand for the abundance of elements, confirmed that the NPs on the surface PG are gold NPs. The gold mapping showed extraordinary high abundance in the corresponding area of NP in the SE image. The round gold NP showed in FIG. 16a was about 70 nm while the triangle gold NPs showed in FIG. 16b was about 100 nm.

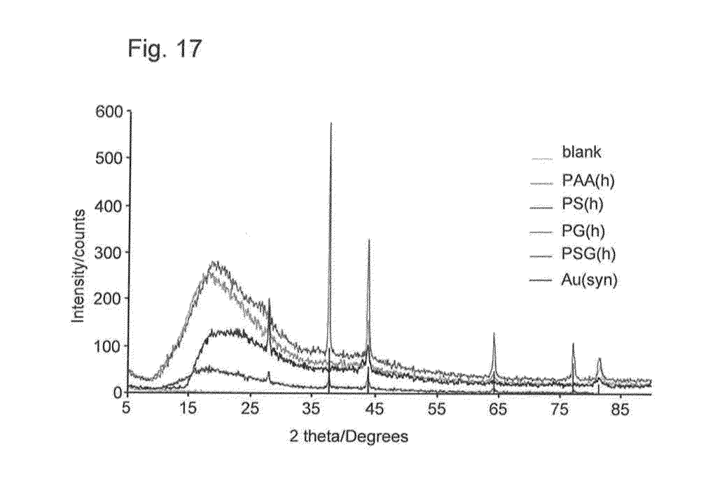

FIG. 17 shows addition SEM images of an example of a membrane. The effect of gold concentration to the gold NPs size and quantity on PG membrane surface was also considered. It was thought that both size and quantity of gold NPs should increase with increasing gold concentration in PG. As shown in FIG. 17, the average size for gold NPs in PG1, PG2, and PG3 were around 35 nm, 39 nm and 33 nm, while the gold to PAA weight ratio decreased in these samples from 3/70 to 1/70. The concentration of gold in PG1 was three times higher than the concentration of gold in PG3. But the NPs size and quantity did not show much difference.

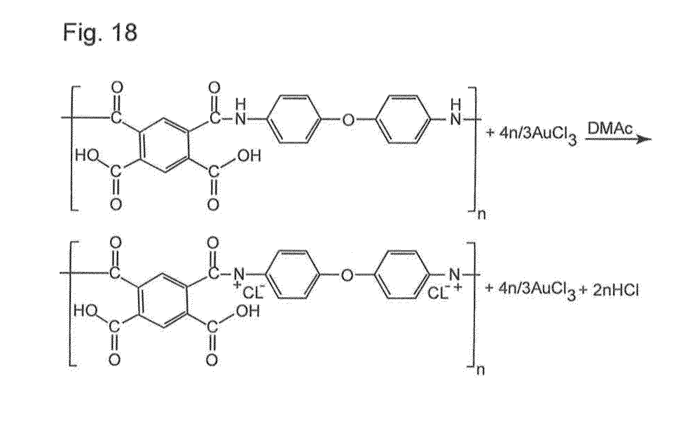

FIG. 18 includes examples of PG membranes that were fabricated containing a wider range of gold concentration. This set of PG membranes has a PAA/gold molar ratio from 1:0.005 to 1:0.2. Instead of heating directly at 75° C., these examples were preheated at 35° C. for half an hour and then heated at 75° C. for one hour. The colors of these membranes were significantly different as the concentration of gold increased. From optical observation studies, membranes with a PAA/gold molar of 1:0.005 to 1:0.02 have yellow color. The membrane with 1:0.04 molar ratio of PAA/gold was reddish brown. The membranes with higher molar ratios of PAA/gold (1:0.08 and 1:0.1) became purple-red. The membranes with highest molar ratio of gold was brown. However, in SEM images there were no obvious differences in size of increasing concentration of gold in PAA. The average size of gold NPs had a range of 15-20 nm. Few gold NPs appeared on the surface of PG membranes. This may due to the gentle heating process and gold NPs did shift to the surface from inner membrane without enough thermal energy. It is also possible that the gold content was insufficient to generate large size of gold NPs.

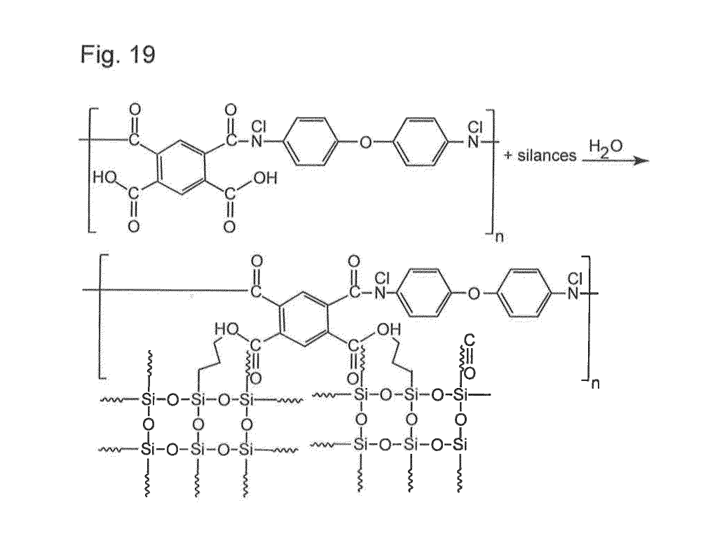

PG membranes with constant PAA/gold molar ratio (1:20) were heated at various temperatures. Generally, with increasing thermal curing temperature, the color of membrane changed from brownish purple to purple and then reddish purple as shown in FIG. 19a. The SEM images (FIG. 19b, 19c, 19d, 19e, 19f, and 19g) recorded the gold NPs on PG membranes at various temperatures (35° C., 75° C., 100° C., 150° C., 200° C. and 250° C.). Except for the samples prepared at 100° C., all other samples showed a trend with respect to either the size or the amount of gold NPs increasing with increasing curing temperatures. At 35° C., there were only some less than 10 nm gold NPs on the surface. When temperature increased to 75° C., a lot of 20 nm gold NPs formed on the surface. Then the size of gold NPs generally grew bigger with increasing thermal curing temperature. The samples heated at 150° C. and 200° C. have similar size gold NPs. However, more gold NPs appeared on the PG membrane cured at 200° C. than on the PG membrane cured at 150° C. The PG membrane heated at 250° C. has less gold NPs on its surface but it has biggest gold NPs size reaching 0.7 μm.

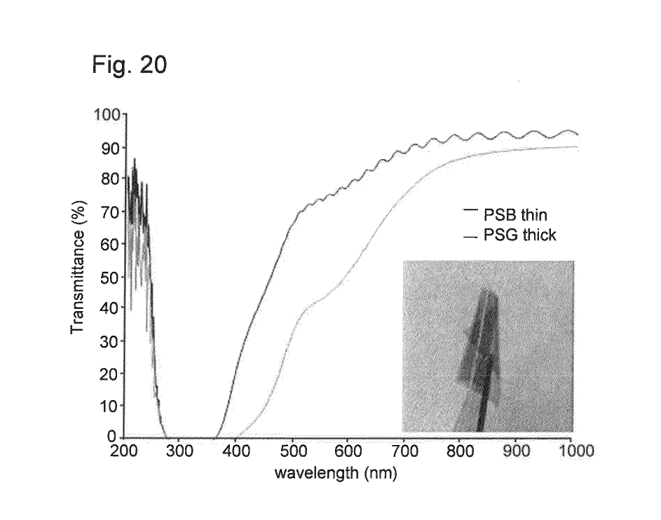

Other concentration that commonly used for PSG membrane fabrication also imaged, but they did not give a clear image due to their high concentration leading to a thick membrane on TEM grid. 8.4 mg/ml is a ten times diluted PSG solution and it gave a brighter background because it formed a thinner membrane than the others. In FIG. 20, the grey background came from PAA polymer around and the grey network was the cross-linked silicone framework. The black dots in silicone network were gold NPs (100 nm) which were about 10 times bigger than the gold NPs on PG membranes from regular concentrations which were imaged using SEM. This means gold NPs aggregated into bigger particles due the lack of surrounding PAA. Common TEM is not an effective method in this case to evaluate the size of gold NPs in PSG membranes. Cross-section TEM using PSG membrane instead diluted PSG casting solution would provide more precise information about NPs size and shape.

In view of the foregoing, a new class of flexible nano-structured materials encompassing a ternary PAA-silane-gold nano-composite has been successfully synthesized. Solutions of copolymers that were synthesized from these composites have been used to fabricate a range of mechanically and optically distinct stand-alone membranes using thermal curing technique. This approach avoids the cyclization of PAA into PI at low temperature and utilizes the unique reactivity of PAA to form designed polymer-assisted nano-structured materials. In one implementation, by way of an appropriate selection of the experimental variables (temperature, gold and silane composition), it is possible to create PSG nano-structured membranes with controlled morphology, particle size, particle distribution and mechanical property. The characterization of this material also shows they are electroactive with unique morphology. These materials could find a wide range of uses including sensors, bioelectronics and interconnect applications. For example, the presence of free carboxylic acid groups in the PSG membranes may enable their functionalization for the immobilization of biomolecules in immunoassays, molecular bioelectronics and biosensor devices. The presence of gold NPs could allow the PG and PSG membranes to be employed in surface enhanced Raman spectroscopy. In addition, their flexibility makes them compatible with flexible electronics and interconnects technologies.

### B. Implementation II

The discussion that follows describes fabrication and morphology studies of novel phase-inverted PAA membranes. This discussion also describes the possible conversion between phase-inverted and thermally-cured PAA membranes as well as their method of storage.

The reagents and synthesis procedures are as described in Section A (Implementation 1) above. However, after the solution based PAA and its derivatives polymer were synthesized, the examples of Section A were casted onto hard substrates or flexible substrates with subsequent phase inversion process instead of heating into solid membranes. The hard substrates used to fabricate PAA and its derivatives membranes include glass slides (e.g., from Thermo Fisher Scientific, Inc.) and gold working electrodes (e.g., from Bioanalytical Systems, Inc.). The flexible substrates include PI and PET sheet (e.g., from Endicott Interconnect Technologies, Inc.) and filter papers (e.g., from Whatman Ltd. (USA)). The discussion hereinbelow identifies examples and embodiments derived from the fabrication of phase-inverted PAA membranes, wherein the fabrication process has been divided into two parts (1) stand-alone membrane and (2) membrane coated filter paper, respectively.

In one implementation, 20 μl PAA solution was dropped and dispersed on a piece of glass slide to form an even thin layer. The glass slide was immersed in water and DMAc diffused into water. The pale yellow PAA membrane began to show off immediately on the glass slide. After about 2 minutes PAA membrane slowly peeled off by itself from glass slide. The resulting membrane was then taken out and immersed in a clear water trough for another 10 minutes in order to thoroughly remove the DMAc solvent. The membrane was then exposed in air for 15 minutes to dry. Other PAA membrane derivatives were made utilizing a similar method and/or procedure.

The amount of casting solution applied on glass slide was optimized. Various amounts (5 μl, 10 μl, 15 μl, 20 μl, 25 μl and 30 μl) 0.2M PAA solutions were pipetted on round glass slides with 18 mm diameter and the pores size of resulting PAA membranes were compared

Grade 1 (11 μm pore size) qualitative filter paper (e.g., purchased from Whatman Ltd.) was applied in this section. Since filter paper can absorb PAA casting solution, 25 μl instead of 20 μl casting solution was used to coat the filter paper surface. First, 25 μl was dispersed on 15 mm dia. round glass slides. The slide was used as a stamp to transfer PAA casting solution to the filter paper. After filter paper absorbed PAA casting solution, it was placed into water until the yellow PAA coating layer began to show off on its surface. Then the filter paper was transferred into fresh water and immersed for another 10 minutes followed by drying in air.

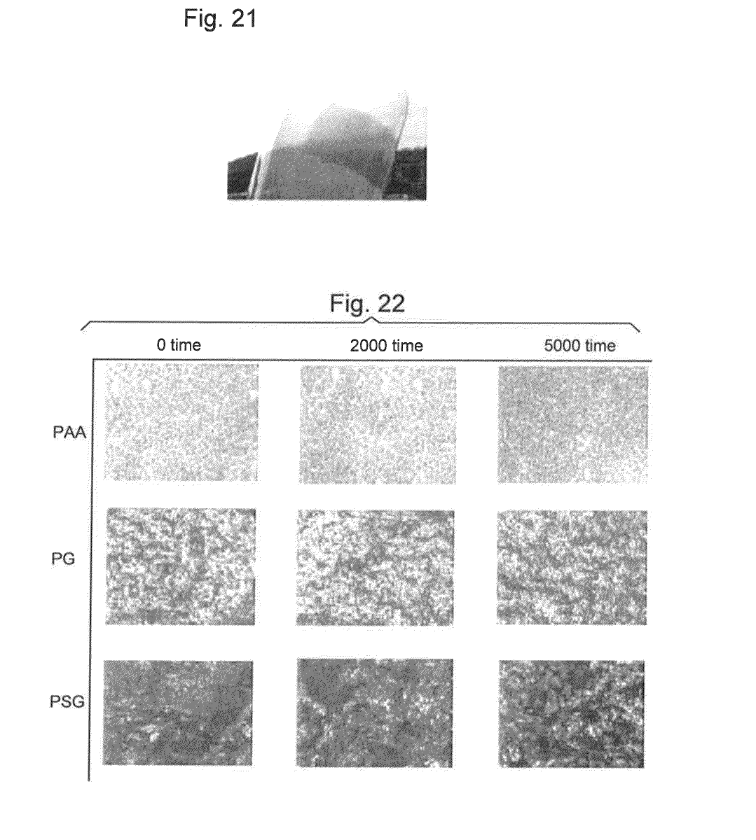

FIG. 21 shows PAA and PSG membranes. PAA membrane and PS membranes have same light yellow color while PG and PSG membranes have a pink color because of the addition of gold NPs.

In optimization of the amount of casting solution dropped on substrate, PAA solution was used. FIG. 22 shows SEM images of an examples of PAA membranes to illustrate surfaces resulting from different casting solution amounts. The amount of casting solution applied on glass slide substrate did not affect much of surface pores of PAA membranes. However, 5 μl 0.2M PAA solution was insufficient to cover the whole surface of 15 mm dia. round glass slide, while 30 μl was found to be too much to form an even layer on the surface. 15 μl, 20 μl and 25 μl casting amounts resulted in a uniform porous surface with a similar pore size range of 50 nm to 200 nm. The relation between casting volumes and average pore sizes was summarized in TABLE 9. In order to be consistent for all membrane fabrication, 20 μl was chosen as the casting amount for PAA and its derivatives phase-inverted membranes fabrication in further studies unless other amount was specially stated.

TABLE 9

| | Volume (μl) | | | | | |
|---|---|---|---|---|---|---|
| | 5 | 10 | 15 | 20 | 25 | 30 |
| Average pore | 136 | 125 | 121 | 110 | 127 | 172 |
| size (nm) | | | | | | |

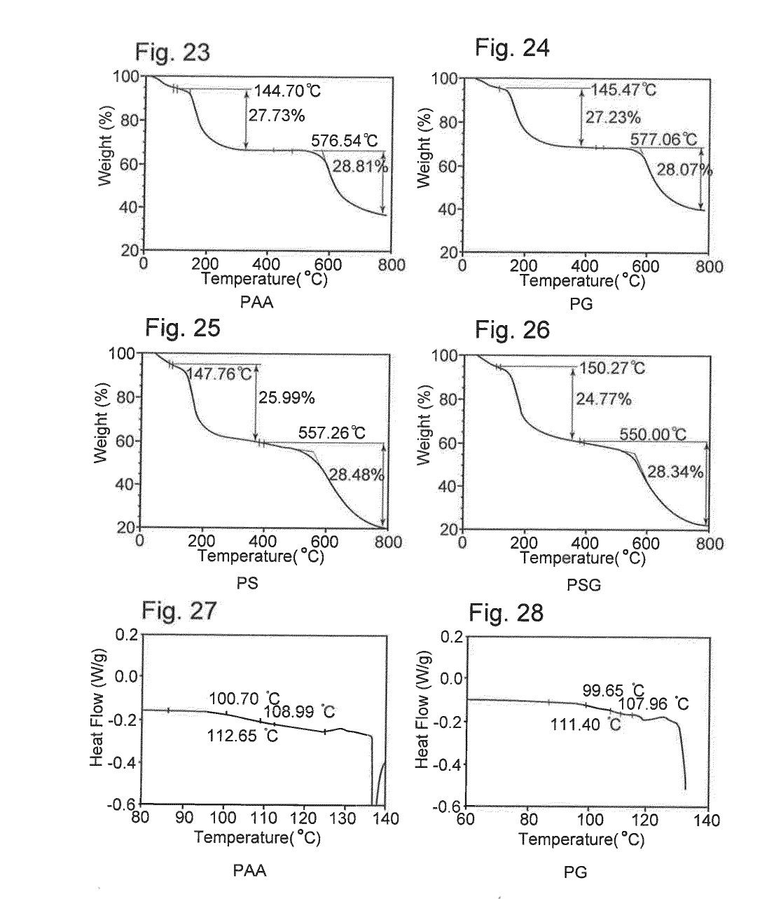

This fabrication step gives the PAA membrane a durable support without affecting the functional surface. The resulting PAA coating layer on filter paper coated with PAA membranes were smoother than PAA stand-alone membranes. FIG. 23 depicts SEM images that show the PAA-coated layer has more uniform pores on its surface with smaller pore size range than the PAA stand-alone membrane does.

Unlike thermally-cured membranes, examples of the phase-inverted membranes are opaque, thus their fluorescence properties were studied instead of UV-Vis absorption characteristics.

Although PAA, PS and PG, PSG have different color because of gold NPs (FIG. 21), they have similar emission behaviors. As shown in FIG. 24, when these membranes were excited at 450 nm, emission peaks at 477 nm were detected by fluorimeter and a broad peak appeared at 645 nm. PAA and PS had similar emission intensity, and their emission intensity was much higher than emission intensity of PG and PSG. Various incident lights (from 350 nm to 600 nm) were also applied and same results were observed. PAA had highest emission intensity while PSG had the lowest.

The emission intensities of PAA series membranes increased with increasing excitation wavelength until they reached their maximum with excitation wavelength at 460 nm, and then decreased at longer excitation wavelength (FIG. 25). The four PAA series membranes showed similar trend due to the fact that the major component is PAA. When excited at different wavelengths, these membranes always gave an emission peak with a 25-27 nm blue shift to excitation wavelength. However the broad peak appeared at various wavelengths as summarized in TABLE 10.

TABLE 10

| | Wavelength (nm) | | | | | |
|---|---|---|---|---|---|---|
| | 350 | 400 | 450 | 500 | 550 | 600 |
| Peak (nm) | 375 | 425 | 477 | 527 | 577 | 627 |
| Broad peaks | 611 | 619 | 645 | 645 | 645 | 667 |
| (nm) | | | | | | |

Although the emission of PAA series membranes at single excitation wavelength is quite similar as fluorescent emission, several results were inconsistent with the principles of fluorescence spectroscopy. First of all, the fluorophore's absorption and excitation spectra, in most cases, should be symmetric with each other, which is the mirror image rule¹⁹⁶. This rule is applicable to the peaks of PAA series membranes which can be considered as a Stokes' shift as shown in FIG. 24a. However, the broad peaks of their spectra did not follow this rule. There is no corresponding absorption peak corresponding to the broad peak around 650 nm. Secondly, some polymer membranes with similar chemical structure, such as PET, PI, also have a peak appearing at the same wavelength as PAA membrane when they are excited by same incident light.

As shown in FIG. 26, although the emission intensity of PET and PI were much lower than that of PAA membrane, all of these polymers had similar emission behavior. This phenomenon cannot be explained by the principles of fluorescence spectroscopy because in most cases fluorescence emission spectrum is unique for each fluorophore. Specific structure of each fluorophore leads to a specific energy gap between different electronic states and hence determines the unique fluorescence emission. Furthermore, the continuous shifts of the emission peaks with changes in the incident light wavelength are rare in common fluorescence spectroscopy. Usually emission spectra are independent of the excitation wavelength. The intensity of emission peak changes according to the change of excitation wavelength, but not the wavelength of emission peak. Finally, when their casting solutions were excited at the same incident lights, no obvious trend was observed and the emission intensity was fairly low.

FIG. 26b exhibits the emission of PAA/DMAc solution at various excitation wavelengths. Although PAA solution still showed highest emission when it was excited at 450 nm as did the membrane, the emission peak had a big red shift, almost 50 nm. Also, the broad peak disappeared (FIG. 26b). This is quite different from the behavior of normal fluorophores because they should have similar emission spectra regardless of the phase, either solid or liquid phase. Put together, these fluorescence investigation of PAA solution and its membranes led us to conclude that these polymers are non-fluorescent.

If these PAA series are non-fluorescent, the question remains: what is the source of their emission peaks as recorded in FIGS. 24, 25, and 26. There are two possibilities for the emission peaks of PAA series membranes. First, the emission peak could come from the 0-0 transition between the lowest vibrational level of the ground state and the lowest vibrational level of the excited state (the 0-0 bands). Secondly, the emission peaks could also be due to Raman scattering which leads to a final vibrational state with higher energy than initial state, and emits a photon with lower frequency than excitation photon. And the high baseline at the beginning of emission spectra could be the result of Rayleigh scattering.

FIG. 27 shows results of PAA Raman spectroscopy. Since the instrument utilized in this experiment is only applicable to enhanced Raman scattering, the strong signal recorded here indicated that PAA membrane can give out enhanced Raman scattering emission. The peaks and corresponding vibration of functional groups are summarized in TABLE 11. The unique surface enhanced Raman scattering ability of phase-inverted PAA membrane may due to its nano-scale roughness and conducting polymer nature.

TABLE 11

| Functional | v | v | v | v | v |
|---|---|---|---|---|---|
| groups/Vibration | (N—H) | (C═C—H) | (C═C) | (C—N) | (C—O—C) |
| Wavenumber (cm⁻¹) | 3330 | 3246 | 1590 | 1359 | 803 |

As for the intensity change for each polymer membranes, the spectrum of Xenon lamp should be discussed. As shown in FIG. 28, xenon lamp has highest output light intensity around 460 nm. This may explain why all the membranes have the highest emission peak when excited at 450 nm or 460 nm, especially when we consider the peak is due to Raman scattering. However, this does not explain why PAA and PS had higher emission than PG and PSG. The gold NPs sequestered within PG and PSG membrane did not enhance. Conversely, they significantly decreased the emission when compared with the membranes without gold NPs. Because the broad peaks in all the membranes' emission spectra do not fit the second order grating Rayleigh scattering, they are considered to originate from the membranes themselves, thereby resulting in PAA, PG and PSG membranes that are Raman active. These unique optical properties of phase-inverted PAA membranes and its derivatives were never observed or reported in any literatures.

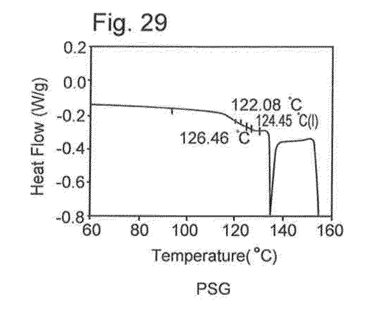

Casting solutions of different polymers can be easily dispersed on PET surface to form phase-inverted membranes by immersing them in water. The results are stand-alone membranes. However, these phase-inverted membranes did not peel off from the PET substrate as they did on glass substrates. After drying out in open air, a thin phase-inverted membrane of each polymer attached very firmly to PET surface. FIG. 29a shows an example of PSG phase-inverted membrane on PET membrane. FIG. 29b shows images of the membrane, which show that these polymer coatings on PET membrane are quite stable and there were no detachment or major cracks after thousands of times of bending.

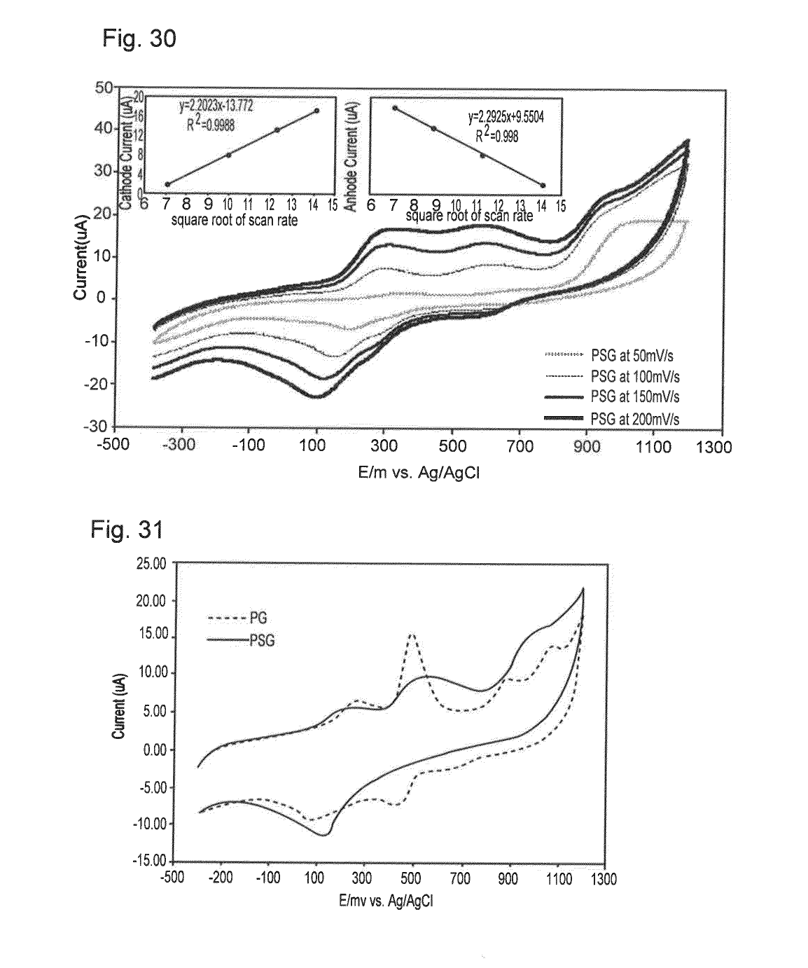

PAA series phase-inverted membranes showed different thermal degradation properties compared to their corresponding thermally-cured membranes. As shown in FIG. 30, the thermal degradation can be divided into 3 stages according to the change of weight percentage. Before 170° C. (Stage 1), a slight change in the weight percentage occurred, which was caused by the evaporation of water and DMAc. As temperature increased, the evaporation of DMAc superseded the evaporation of water and the mass loss became greater when the temperature reached 160° C., approaching the boiling point of DMAc (165° C.) and simultaneous imidization of PAA (Stage 2). The significant change in weight percentage at this temperature range is due to the loss of water released from the imidization process and the evaporation of DMAc. Due to the phase-inverted fabrication process, these membranes have less DMAc left inside and due to the porous structure of phase-inverted membrane, which decreased the contact between polymer molecules, the imidization reaction has been impeded. In one example, the change in weight percentage of phase-inverted membranes due to the imidization process and evaporation of DMAc were much less than their thermally-cured membranes which have a compact solid structure and contain more DMAc because of incomplete evaporation. Around 250-550° C., stable change in weight percent was recorded. Stage 3 began from around 580° C., at this stage the membranes were completely degraded and charred. The similarity in the TGA characteristics recorded for PAA, PG and PSG were due to the fact that majority of the membranes is mainly PAA. The TGA analysis also shows that these membranes were not stable beyond 160° C. and could lose functional groups under high temperature. The DSC results of phase-inverted membranes were similar to their thermally-cured membranes. The glass transition temperatures of PAA and PG were found to be around 100° C., while that of PSG was around 122° C. This is the first time the thermal degradation properties of PAA and its derivatives were studied and recorded.

Examples and embodiments of phase-inverted membranes may have unique porous structures. These embodiments may comprises a thin dense top layer and thick supporting layer with macrovoids. In FIG. 31, an example of a PAA-series membrane may have a thin top layer with dense nano-size pores supported by a thick sublayer with micro size finger-like macrovoids. The PAA-series membranes truly exhibit phase-inverted membranes characteristics. Usually the thickness of the whole membrane (e.g. fabricated from 20 μl casting solution) ranges from 60 μm to 100 μm depending on the concentration of the casting solution. However, the top thin layer has a thickness of 20-30 nm regardless of solution concentration. FIG. 31 shows the top side, back side and cross section of 0.25M PAA membrane. The pores on the top side have an average size of 36.8±4.6 nm while the back side has micro size pores ranging from 300 nm to 2 μm. Because of the huge difference in pore size from top to back side and the distinguishing two layers in membrane structure, PAA membrane could be an anisotropic membrane. Cross-sectional view shows the thickness of the membrane is about 75 μm while the top layer, which is the bottom side in images, (FIGS. 31c and 31d) is around 30 nm thick.

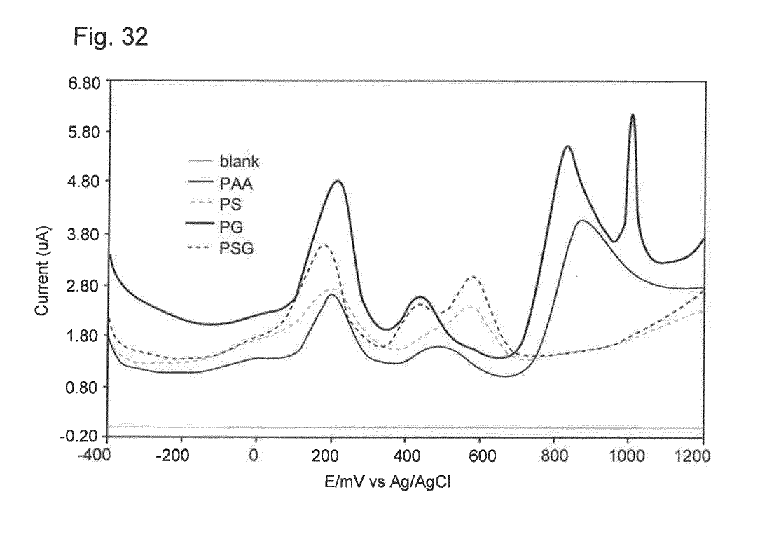

PAA coated filter paper has similar surface structures as PAA stand-alone membrane. However, the surface morphology of filter paper is significant modified because of the addition of PAA coating layer. Due to the absorption of casting solution by the filter paper, the sublayer in the PAA stand-alone membrane could be readily observed. The filter paper's structure mixed with this sublayer and became the support for the top PAA layer. FIG. 32 shows the comparison of filter paper and PAA coated filter paper membranes.

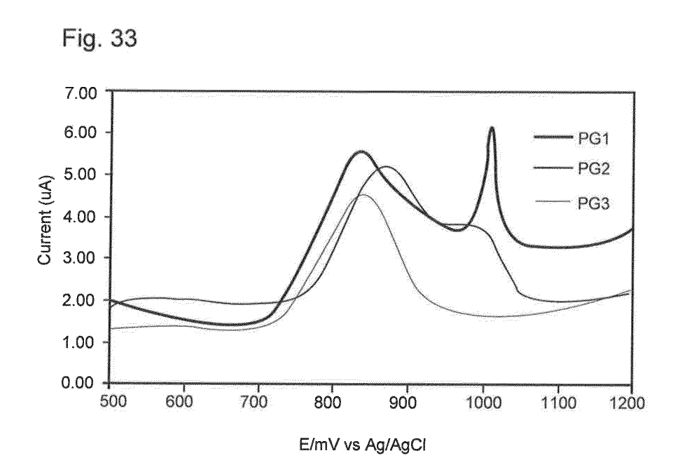

As shown in FIG. 33, the PSG membranes containing NPs were found to have similar surface morphology and inner structures as PAA membranes with no NPs. Moreover, they also have NPs shown off on their surface and inside.

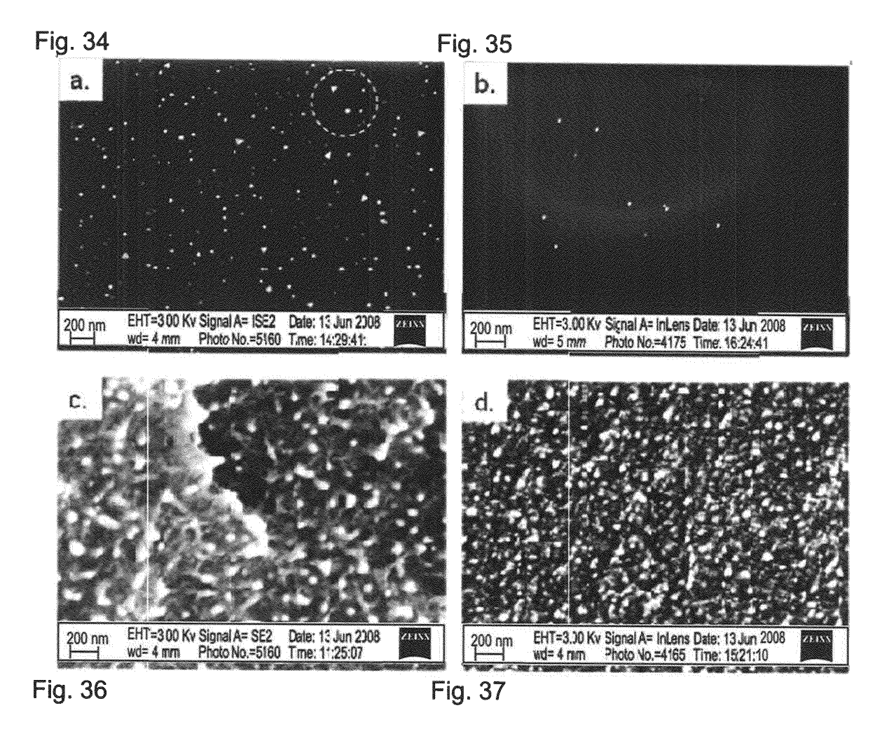

The surface pore size of phase-inverted membrane is greatly depended on it's the concentration of the corresponding casting solution. As shown in FIGS. 34A, 34B, and 35, with increasing concentration, the surface pore size of PAA membrane decreases. The image results are summarized in TABLE 12 below, which shows the relationship between pore size and polymer concentrations for PAA-coated filters and stand-alone membranes.

TABLE 12

| | | Av. | | | | Av. | |
|---|---|---|---|---|---|---|---|
| Conc. | Range | Pore size | | Conc. | Range | Pore size | |
| (M) | (nm) | (nm) | SD | (M) | (nm) | (nm) | SD |
| 0.20 | 30-200 | 110 | 24.7 | 0.20 | 100-200 | 100 | 34.2 |
| 0.21 | 30-180 | 95.8 | 22.1 | 0.21 | 100-200 | 100 | 30.7 |
| 0.22 | 20-100 | 45 | 17.1 | 0.22 | 20-60 | 35 | 18.2 |
| 0.23 | 20-60 | 42.1 | 11.4 | 0.23 | 20-70 | 32.5 | 19.8 |
| 0.24 | 10-40 | 27.9 | 8.3 | 0.24 | 10-50 | 25.4 | 6.5 |
| 0.25 | 15-50 | 25.8 | 4.6 | 0.25 | 10-40 | 24.9 | 6.3 |
| 0.26 | 10-50 | 22.6 | 8.4 | 0.26 | 10-40 | 21.8 | 5.5 |
| 0.27 | 15-60 | 28.3 | 10.2 | 0.27 | 10-60 | 29.1 | 11.8 |
| 0.29 | 10-30 | 21.1 | 5.5 | 0.29 | 6-55 | 28.4 | 6.7 |
| 0.3 | 8-35 | 20.1 | 8.7 | 0.3 | 8-45 | 34 | 10.8 |
| 0.32 | 5-20 | 17.6 | 6.1 | 0.32 | 8-25 | 20.83 | 11.2 |
| 0.34 | 5-18 | 12 | 4.1 | 0.34 | 5-20 | 15.9 | 8.3 |
| 0.35 | 5-20 | 14.2 | 6.5 | 0.35 | 5-35 | 16.7 | 6.2 |
| 0.36 | 5-18 | 11.5 | 3.5 | 0.36 | 5-30 | 15.2 | 5.7 |
| 0.37 | 5-15 | 10.8 | 4.0 | 0.37 | 5-33 | 14.8 | 6.1 |
| 0.38 | 5-15 | 10.4 | 3.1 | 0.38 | 5-15 | 13.9 | 4.8 |
| 0.42 | 4-12 | 11 | 3.4 | 0.39 | 5-15 | 12.9 | 2.7 |
| 0.44 | 4-10 | 8.2 | 2.3 | 0.42 | 4-15 | 13 | 5.6 |
| 0.45 | 4-15 | 11.8 | 2.8 | 0.44 | 3-15 | 11.7 | 3.3 |
| 0.46 | 4-10 | 6.2 | 1.1 | 0.45 | 3-12 | 10.6 | 1.8 |
| 0.47 | 2-9 | 4.1 | 0.6 | 0.47 | 2-8 | 6 | 0.7 |

Membranes made from casting solutions with concentrations between 0.2M and 0.47M were imaged. Casting solution with concentration lower than 0.2M was too diluted to form stand-alone membrane, while with increasing concentration, casting solution became too viscous to be dispersed on the substrates. The casting solution with higher concentration than 0.47M was not discussed here. Between 0.2M and 0.23M, the pore size decreased dramatically. However, the pore size changed slowly leveling off with increasing concentration after 0.23M. Generally, PAA coating membranes on filter paper had a smoother surface than the PAA stand-alone membrane. At the low concentration range (0.2M-0.22M), PAA coating layer may have bigger pore size than these PAA stand-alone membrane. This is attributed to the absorption of filter paper and hence the presence of less PAA casting solution on its surface. In middle concentration range (0.23M-0.30M), PAA coating layer generally had a smaller pore size range and more uniform pores than the stand-alone membranes. At the concentration range (0.31M-0.47M), the pore sizes are quite similar for both PAA coating layer and PAA stand-alone membrane. The surface pores of the high concentration membranes were more uniform and in a smaller size range than the pores at low concentrations. Utilizing statistical analysis software SigmaPlot 12.0 developed by Systat Software Inc., indicates that single component exponential decay fitting (FIG. 36) is the best curve to interpret the results in TABLE 12 above. The relationship between concentration and pore size was described by Equation (2).

Y=a+b*exp(−cX) Equation (2)

wherein, X is the concentration in M, Y is the corresponding pore size in nm, a, b and c are the coefficients. For PAA stand alone membranes, these constants are 11.77, 237063.59 and 38.77 respectively. The R value of 0.9748 and R² value of 0.9502 were recorded. For PAA coated filter paper, these constants were 16.06, 901330.28 and 45.97, with R value of 0.9271 and R² value of 0.8594.

Unlike PI, PAA is not stable when exposed in light, heat and moisture. PAA casting solution usually became darker over time when exposed to light. Generally, fresh PAA solution is light yellow and it eventually turns to light orange. The color change of the casting solution indicates the gradual onset of imidization and hence the formation of PI. In addition to the color changes, the homogeneous PAA solution also changes with time. A gel-like light orange material precipitates from the PAA solution finally when left standing over time. Both casting solution and membrane can absorb moisture slowly from air, and the PAA content in the casting solution will gradually become hydrolyzed by the moisture. If the casting solution is exposed under light or air, it will expire within a week. If it is covered by aluminum foil and stored in a dark place, it can remain stable and could be used for fabrication over one or two months. Phase-inverted PAA membrane has a much short life than its casting solution. Once the membrane becomes totally dry in air, it will be brittle and lose flexibility in just one day. So a method must be developed to keep PAA membrane stable. One easy way is to store the casting solution and fabricate PAA membrane whenever it is needed. However, this is not convenient when there are no fabrication tools and conditions. Another way is to store PAA membrane directly under stipulated conditions without exposure to air, light or moisture.

To store PAA membranes, light and heat should be prohibited. But the most important thing is to maintain the equilibrium between wetness and hydrolysis. Without moisture, PAA membrane will become brittle; however, it may also be hydrolyzed with too much moisture. In one example, the storage solution was a mixture of several common solvents. Tests for the present implementation utilized water, ethanol, acetone, DMAc, and DMF. One piece of PAA membrane was immersed in each 2 ml storage solution which was kept in a drawer and was physically observed after 2 weeks. The storage solution was sealed with Parafilm to prevent evaporation and exposure to air.

However, results showed that no combination provided the suitable storage solution for phase-inverted membranes. Among all the solvent mixtures tested, a combination of polar nonsolvents and solvents shows better result than that containing only polar nonsolvents. For instance, the combinations involving ethanol/DMF, water/DMAc and ethanol/DMAc retained the shape, size, color and some flexibility of PAA membranes. The best case out of all these imperfect combination is ethanol/DMF with a volume ratio of 90/10. However, the combinations made of only nonsolvents usually result in a more brittle membrane, and eventually hydrolysis. These preliminary data may eventually lead to the development of permanent storage solution for the phase-inverted membranes. The ideal storage solution should have both the nonsolvent and the solvent in order to maintain the equilibrium of the phase-inverted process. In that respect, polar nonsolvent other than water can be used. In this way, it can keep the wetness of the membrane, and also prevent hydrolysis.

In view of the foregoing, the method for fabrication of PAA stand-alone phase-inverted membrane and PAA coating filter paper were described. The surface morphology shows that these new classes of PAA membranes have similar surface morphology, while PAA coating membranes are smoother than their stand-alone membranes. The amount of casting solution applied did not affect the surface pore size. The pore size was greatly depended on the concentration of the casting solution. The trend in the pore size was the same for both PAA coated layer and stand-alone membranes. Increasing concentration produced a decrease in pore size and size range.

Although phase-inverted PAA membranes have similar chemical composition as their thermally-cured membranes, and they can converted between each other, these two PAA forms have different physical properties. The phase-inverted membranes were not transparent and were found to exhibit unique enhanced Raman scattering emissions. This is a significant finding as it could lead to the development of novel materials for sensing and filtration.

The results show that PAA series phase-inverted membranes are a class of flexible, opaque, and porous sponge-like membranes. They can find wide applications in membrane filtration because of their special nano-size pores and their anisotropic structures. Moreover, because of their optical and electrochemical properties, these membranes may also find applications as sensing materials.

### C. Implementation III

As noted above, the nano-porous surface and isotropic sublayer structure of PAA membranes are especially promising for application in NPs filtration. The surface pore size range can be easily adjusted by its casting solution concentration, and hence generate a series of membranes with various size range for separation purpose. The discussion below describe in various examples and implementations the performance of PAA membrane applied in UF and continuous separation.

Broadly, PAA membranes were fabricated as described in herein (see, e.g., Section A) using related reagents for synthesis. Several NPs and nano-powder samples are used in this implementation including: QSH620 (CdSe/ZnS QDs in H₂O—Carboxyl) purchased, e.g., from Ocean NanoTech, LLC. (Springdale, Ark., USA) with the majority of QDs being 20 nm in size. The original solution was diluted using deionized water into various concentrations ranging from 500 nM to 0.5 nM. Aqueous dispersion of TiO₂ NPs (<150 nm (DLS), 33-37 wt %) were purchased from Sigma Aldrich (USA). Aqueous dispersion of TiO₂ NPs was diluted into 0.1 mg/ml for filtration test. 10 nm, 20 nm, 50 nm and 200 nm gold NPs, and 40 nm and 60 nm silver NPs (10 ppm) aqueous samples were purchased, e.g., from Ted Pella Inc (Redding, Calif., USA). MesoSilver (>20 ppm) was purchased, e.g., from Purest Colloids Inc (Westampton, N.J., USA). Colloidal Silver (35-45 ppm) was purchased, e.g., from Golden Touch Mfg./Ultra Pure (Benton, Ky., USA). Sovereign Silver (10 ppm) was purchased from Natural Immunogenics Corp (Pompano Beach, Fla., USA)²¹¹. 13 mm Anodisc™ anopore aluminum oxide membranes (0.02 μm) were purchased from Whatman Ltd (USA). Qualitative filter papers No. 1 was purchased from Whatman International Ltd. (England). 13 mm nylon filter membranes were purchased from Grace Davison Discovery Science (USA). 61 nm and 118 nm polystyrene beads aqueous solutions were purchased from Phosphorex, Inc. (Fall River, Mass., USA).

The surface of PAA membranes (before and after each filtration) were imaged by a Zeiss Supra 55 VP analytical ultra high resolution SEM with inlens and second electron detectors, equipped with software SmartSEM™. Elementary information was obtained by an EDAX detector integrated with SEM. All the image samples were coated with a 5 nm gold layer for SEM. The samples for EDX were coated with about 8 nm carbon. The accelerating voltage for SEM was 5 kV and the one for EDX was 10 kV. Fluorescence emission was recorded by Panorama Fluorat-02 Fluorimeter (Analytical Instruments LUMEX Ltd.) equipped with Panorama Pro, and CaryEclipse (Varian) Fluorescence Spectrophotometer equipped with CaryEclipse Scan application. UV absorbance was measured on a HP Hewlett Packard 8453 UV-Visible spectrometer was equipped with Chemstation software 845X UV-Visible System, and with a integration time 0.5 s, interval 1 nm.

In order to distinguish cascaded separation of various NPs, the filtration may be defined as the isolation of single type of NPs with one nominal particle size from liquid matrices.

FIG. 37 depicts an example of a filter system that incorporates one or more examples of a membrane described herein. The entire filtration process was conducted manually: 1 ml syringe was used to inject the NPs solution into a Milipore Swinny stainless steel 13 mm filter holder which held the PAA membrane inside. The average delivery speed was 0.5-1 ml/min. The filtrate was collected into a cuvette for further characterization.

The filtration or capture efficiency is defined as the percentage of NPs captured on the filter. Since the volume of sample is not changed before and after filtration, concentration was used instead of direct NPs number. Equation (3) below shows the filtration efficiency (or capture efficiency) based on the change of NPs number and their concentration. Where η is filtration efficiency, N is number of NPs, C is concentration.

$$\begin{matrix}η = \frac{N ( captured )}{N ( total )} \times 100 \% \\ = \frac{C ( captured )}{C ( total )} \times 100 \% \\ = \frac{C ( total ) - C ( filtrate )}{C ( total )} \times 100 \%\end{matrix} \qquad Equation ( 3 )$$

In efficiency test of PAA membrane for filtration of QDs, the QDs solution were diluted into 500 nM, 160 nM, 80 nM, 50 nM, 20 nM, 10 nM, 5 nM, 1 nM, and 0.5 nM. The fluorescence emissions of their solutions were measured before filtration. The excitation wavelength was set at 570 nm while the measuring range for emission was 585-670 nm. A calibration equation was generated by comparing the concentration with the corresponding emission intensity. Following filtration using 0.42M PAA membrane, the filtrate fluorescence emissions were measured repeated and the filtrate concentrations determined by calibration equation.

The efficiency of PAA membrane for silver NPs was calibrated using MesoSilver sample. MesoSilver was mixed with deionized water into a series of diluted samples with different percentage concentrations (from 5% to 80%) compared to its original concentration (100%). The filtrate from PAA membrane was measured and concentration was compared with its original concentration.

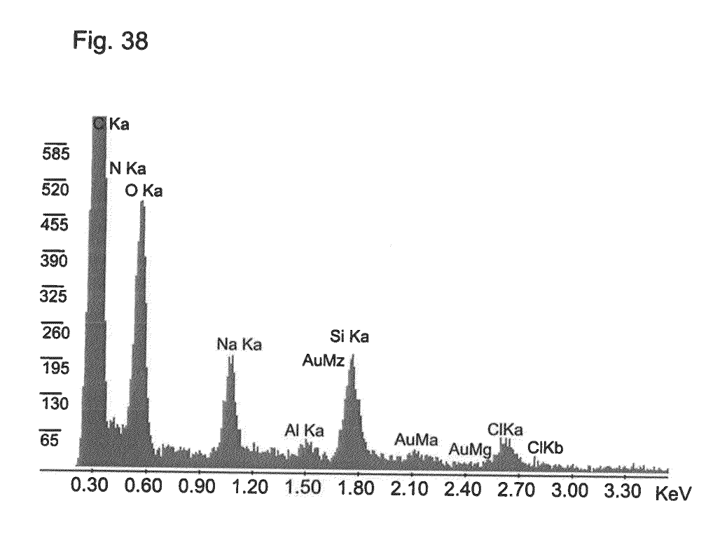

The separation is based on continuous filtration. Solution of NPs mixture made of three different particle sizes was filtered three times in sequence using PAA membranes of various pore sizes. Each filtration used the same setup as shown in FIG. 38. In one implementation, the first filtration was designed to capture large NPs, the second was used to trap NPs of medium size, and the third filtration captured the remaining smallest NPs.

Three sets of NPs mixture were tested for separation by PAA membranes. TABLES 13, 14, AND 15 below provide information related to these tests. In TABLE 13, set 1 was made of 1.5 ppm 200 nm, 50 nm and 20 nm gold NPs. The membranes used for set 1 were 0.2M PAA, 0.23M PAA and 0.36M PAA with pore sizes of 110 nm, 42.1 nm and 11.5 nm respectively. Set 2 (TABLE 14) was made of 0.004 mg/ml TiO₂ NPs, 4 ppm 60 nm silver NPs and 0.8 ppm 10 nm gold NPs. Set 3 (TABLE 15) was made of 1.2×10¹⁰ particles/ml 118 nm polystyrene beads, 8.0×10¹¹ particles/ml 61 nm polystyrene beads and 5.7×10¹² particles/ml 10 nm gold NPs. The membranes used for sets 2 and 3 were 0.21M PAA, 0.23M PAA and 0.44M PAA with pore sizes of 95.8 nm, 42.1 nm and 8.2 nm respectively.

TABLE 13

| | | | | Size of PAA |
|---|---|---|---|---|
| | Type of | Size of NPs | Type of PAA | membrane |
| | NPs | (nm) | membrane | (nm) |
| First filtration | Gold | 200 | 0.2M | 110 |
| Second filtration | Gold | 50 | 0.23M | 42.1 |
| Third filtration | Gold | 20 | 0.36M | 11.5 |

TABLE 14

| | | | | Size of PAA |
|---|---|---|---|---|
| | Type of | Size of NPs | Type of PAA | membrane |
| | NPs | (nm) | membrane | (nm) |
| First filtration | Titanium | <150 | 0.21M | 95.8 |
| | dioxide | | | |
| Second filtration | Silver | 60 | 0.23M | 42.1 |
| Third filtration | Gold | 10 | 0.44M | 8.2 |

TABLE 15

| | | | | Size of PAA |
|---|---|---|---|---|
| | Type of | Size of NPs | Type of PAA | membrane |
| | NPs | (nm) | membrane | (nm) |
| First | Polystyrene | 118 | 0.21M | 95.8 |
| filtration | beads | | | |
| Second | Polystyrene | 61 | 0.23M | 42.1 |
| filtration | beads | | | |
| Third | Gold | 10 | 0.44M | 8.2 |
| filtration | | | | |

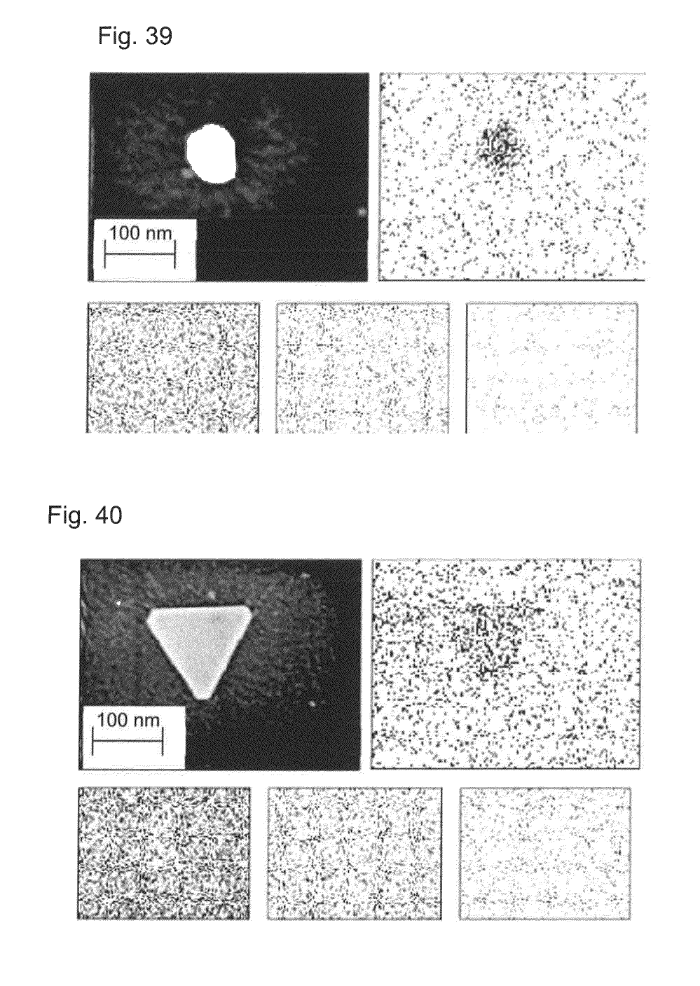

QSH620 QDs have an orange-red color under normal light. After filtration using 0.42M PAA membrane, the resulting solution became colorless, irrespective of the original concentration. It was observed that the light yellow PAA membrane turned into orange-red because of the captured QDs on its surface. FIG. 39A, 39B shows the SEM image of the QDs after they were captured on PAA membrane while EDS result in FIG. 39c confirmed the existence of QDs on the PAA surface due to the peaks for Se, S and Cd. As measured in FIG. 39b, QDs have an average size of 20 nm as described by the manufacturer. It was noted that the captured particles aggregated on the surface of PAA membrane after filtration.

The filtration results using PAA membranes are found in TABLE 16 below. Their filtration efficiencies for different concentrations were calculated according to Equation (3) and calibration plots are shown in FIG. 40. Generally, PAA membrane have failure rates at low filtration efficiency regardless of the concentration of sample solution. The failure is due to the surface defect of membranes which cannot be eliminated and hence some QDs can still pass through.

PAA membranes exhibited stable performance. Except for some experiments at 10 nM, all the filtration efficiencies were above 80% with one single experiment reaching 99.97%. Although the efficiencies generally decreased with increasing concentration, the concentrations of filtrates were quite consistent in most experiments regardless of the original filtered concentrations. Majority of the concentrations of filtrates determined using the PAA membrane were between 2-5 nM. Because of the defects of membrane filters, NPs bigger than the nominal pore size can still remain in the filtrate. So a high total amount of filtered NPs or increasing original concentration will lead to a higher amount of NPs in filtrate or increasing concentration of filtrate. However, the concentration of filtrate will remain constant when the surface of the filter has been saturated or clogged by NPs. The consistent efficiencies recorded in the majority of the experiments suggest that the pores have been clogged at the specific concentration although water can still be pushed through and no obvious pressure increase was observed.

In all the filtration experiments, PAA membranes are easy to handle because they are flexible, soft, and durable under pressure. PAA membranes were also found to have a higher total average efficiency (87.46%) with lower SD (6.87%).

TABLE 16

| Original | | Concentration | | | |
|---|---|---|---|---|---|
| concentration | | after | | Average | |
| and | | filtration | Efficiency | efficiency | |
| experiments | | (nM) | % | (%) | SD (%) |
| 200 nM | QSH1 | 1.883106 | 99.05845 | 96.782 | 3.338166 |
| 200 nM | QSH2 | 9.901805 | 95.04910 | | |
| 200 nM | QSH3 | 1.692718 | 99.15364 | | |
| 200 nM | QSH4 | 16.63373 | 91.68314 | | |
| 200 nM | QSH5 | 2.070155 | 98.96492 | | |
| 100 nM | QSH1 | 14.91015 | 85.08985 | 88.962 | 5.221124 |
| 100 nM | QSH2 | 14.98831 | 85.01169 | | |
| 100 nM | QSH3 | 13.29312 | 86.70688 | | |
| 100 nM | QSH4 | 9.358280 | 90.64172 | | |
| 100 nM | QSH5 | 2.639487 | 97.36051 | | |
| 80 nM | QSH1 | 3.810922 | 95.23635 | 93.366 | 5.548773 |
| 80 nM | QSH2 | 5.324313 | 93.34461 | | |
| 80 nM | QSH3 | 12.88992 | 83.88760 | | |
| 80 nM | QSH4 | 1.781285 | 97.77339 | | |
| 80 nM | QSH5 | 2.728308 | 96.58961 | | |
| 50 nM | QSH1 | 14.58077 | 70.83846 | 84.25 | 10.82634 |
| 50 nM | QSH2 | 9.996547 | 80.00691 | | |
| 50 nM | QSH3 | 1.098142 | 97.80372 | | |
| 50 nM | QSH4 | 9.989713 | 80.02057 | | |
| 50 nM | QSH5 | 3.710448 | 92.57910 | | |
| 20 nM | QSH1 | 3.363131 | 83.18434 | 84.527 | 1.425902 |
| 20 nM | QSH2 | 2.919365 | 85.40317 | | |
| 20 nM | QSH3 | 2.786505 | 86.06748 | | |
| 20 nM | QSH4 | 3.309646 | 83.45177 | | |
| 10 nM | QSH1 | 0.002646 | 99.97345 | 73.497 | 20.23719 |
| 10 nM | QSH2 | 4.549392 | 54.50608 | | |
| 10 nM | QSH3 | 2.197169 | 78.02831 | | |
| 10 nM | QSH4 | 3.854601 | 61.45399 | | |

| | | | |
|---|---|---|---|
| Total average efficiency (%) | 87.46055 | Total SD | 6.871553 |
| | | (%) | |

TABLE 17

| Original concentration | Average efficiency | |
|---|---|---|
| of QSH620 | of PAA (%) | SD (%) |
| 200 nM | 96.78 | 3.34 |
| 100 nM | 88.96 | 5.22 |
| 80 nM | 93.37 | 5.55 |
| 50 nM | 84.25 | 10.83 |
| 20 nM | 84.53 | 1.43 |
| 10 nM | 73.5 | 20.24 |

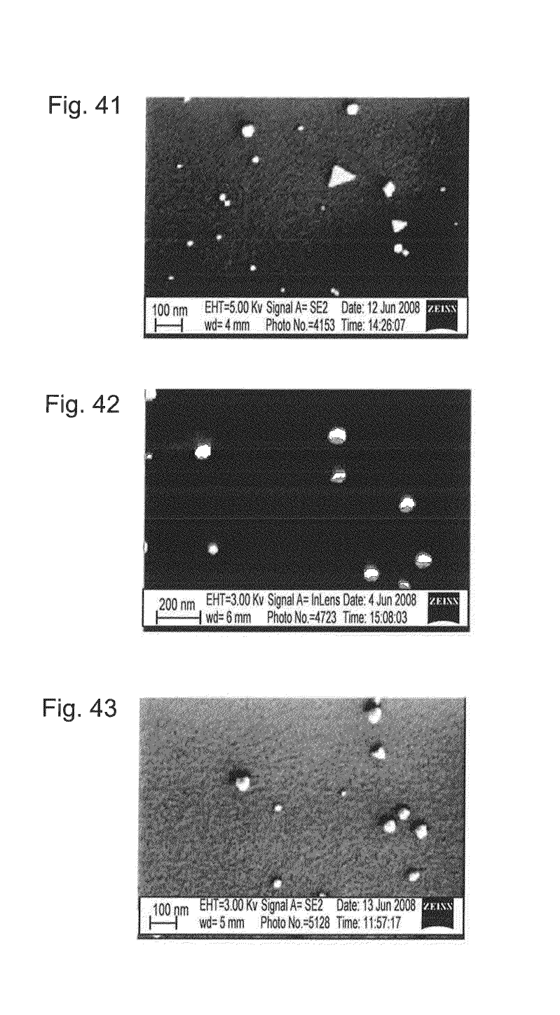

The PAA membrane tested were used to filter 1 ml 200 nm QSH620 solution. The signal recorded for PAA membranes was about 772.7863A.U. This high emission could be explained by solid state fluorescence emission and the amount of quantum dots accumulated on the PAA surface. As best shown in FIG. 41, PAA membrane seemed to enhance the signal of quantum dots. The reason for this enhancement is not clear. But it could be due to an enhancement by Raman scattering of PAA membrane discussed above. This scattering had a blue shift from excitation which in turn led to a 2 nm blue shift of fluorescent emission of QDs.

The original silver NPs samples have light yellow to greenish colors. After being filtered by 0.36M PAA membrane, the solutions of silver NPs found colorless and the yellow PAA membranes were coated with a thin layer of black shining material.

FIGS. 42A, 42B depict various SEM images. FIGS. 42a and 42b show the SEM of 40 nm silver NPs on PAA membrane. Generally, silver NPs evenly dispersed on the surface and they tended to gather into NPs islands without aggregation. The uniform shape and size of single silver NPs can be clearly observed. Most of these particles have round shapes and size of approximately 40 nm. MesoSilver silver NPs preferred to aggregate on the surface of PAA membrane, and it is difficult to recognize their shapes and exact size (FIG. 42c). Similar results were recorded for Colloidal silver NPs (FIG. 42d). Only Sovereign Silver sample showed discrete NPs with easily identified shapes and sizes (FIGS. 42e and 42f). It was noted that small silver NPs in the Sovereign Silver sample were spheres. Some large square shapes silver NPs were found to be around 70 nm.

EDS technique and mapping were used to identify the dark materials captured on PAA membranes as silver NPs. FIG. 43b shows the SE image of distribution of dark material on the surface. However, in the SE image, the color for the dark material was converted into white and the yellow PAA background was showed as black. So the parts in SE image is the location of dark materials on the PAA. FIG. 43c-43f are EDS mapping results in which colorful dots indicate the abundance of each element. Silver element (yellow dots) has a higher abundance on the right corner which coincides with the position of white parts in SE image. This proved that the dark or black material captured on PAA membrane is silver NPs.

FIG. 44 shows a sharp absorption band in the 400 nm region recorded for the silver NPs. The solid lines in UV-Vis spectra were the measurement results of the MesoSilver samples at various percentages from its original concentration. The calibration lines were the percentage concentrations corresponding to their UV-Vis absorbance. The dotted lines demonstrate the effectiveness of the PAA membranes compared to the commercial filters. As summarized in TABLE 18 below, the qualitative filter paper captured virtually no silver NPs, hence its average efficiency was 1.24%, whereas the commercial nylon filter membranes showed a much better performance, capturing more than half the silver NPs in the MesoSilver sample. The poor filtration performance recorded for these commercial filters are expected because they were not designed to filter nanometer-size materials. Also, these commercial filters lacked the functional groups to facilitate the surface interaction with the particles. In contrast to the commercial filters, PAA membranes exhibited superior particle capture characteristics for silver NPs. It gave consistent results for multiple filtrations testing reaching an average filtration efficiency of 98.5%. The significant filtration characteristics of the PAA membranes may be attributed to the charged silver NPs being stabilized by the PAA matrices and the repulsive forces between the charged particles which prevent their aggregation. According to the studies of Alvarez-Puebla et al. and Faulds et al., silver citrate colloids (filtrated) are stable in a much wide range of pH values, extending from pH 2 to 12. The overall charge with citrate ligands is negative and the bare silver NPs are positively charged. During the filtration, some ligands were washed off from the surface of silver NP, leaving the positively charged surface exposed to PAA membrane. Hence, the carboxyl and amine groups on PAA act as molecular anchors that bind the NPs to the surface.

TABLE 18

| | Average percentage of | | |
|---|---|---|---|
| | silver NPs remaining | Average filtration | |
| | in filtrate (%) | efficiency (%) | SD (%) |
| Qualitative | 98.76% | 1.24% | 1.33% |
| Filter Paper (FP) | | | |
| Nylon filter | 55.48% | 44.52% | 3.15% |
| membrane (NL) | | | |
| PAA membrane | 1.50% | 98.50% | 0.10% |
| (PAA) | | | |

PAA coated filter was tested for its filtration property instead of PAA stand-alone membrane. Three PAA coated filter paper from three casting solutions at various concentrations were compared for filtration of same TiO₂ samples. The three concentrations tested were 0.2M, 0.26M and 0.32M respectively. It was noted that the diluted 0.1 mg/ml TiO₂ NPs have no uniform size. According to the manufacturer's description, the particles are smaller than 150 nm. After 1 ml TiO₂ NPs aqueous dispersion was filtered by each PAA coated filter paper, the change of milky white TiO₂ NPs dispersion was obvious but not much color change was noted on PAA coated filter membranes because TiO₂ NPs are white. FIG. 45A, 45B SEM images show that TiO₂ were trapped on the surface of PAA coated filter paper (FIG. 45a-c). 0.2M PAA coated filter paper had a pore size range between 100 nm-200 nm, and most of the TiO₂ NPs trapped were bigger than 80 nm. 0.26M and 0.32M PAA coated filter papers had smaller pore size of 0.2M PAA coated filter paper and hence more TiO₂ NPs with smaller size were captured (FIG. 45b-d). More than 65% TiO₂ NPs captured on 0.26M PAA coated filter paper were smaller than 60 nm. Results showed that more than 50% TiO₂ NPs on 0.32M PAA coated filter paper were smaller than 45 nm, although these small NPs had aggregated heavily into bulky particles. Both EDS spectrum and mapping confirmed that the captured NPs on PAA membrane surfaces were TiO₂ NPs. The EDS mapping images in FIG. 46d-f showed the presence of carbon, nitrogen and oxygen elements. This is reasonable because the substrate had been coated with a layer of PAA membrane. However, titanium simply shows in the center of surface (FIG. 46c) and this mapping shape is coincides with the white part in SE image (FIG. 46b).

As summarized in TABLE 13 above, the NPs tested in this set were same kind but with various sizes. The SEM images in FIG. 47A, 47B show gold NPs with different size filtered separately by the 0.36M PAA membrane. These all have uniform size and spherical shape. Gold NPs with sizes of 50 nm and 20 nm did not disperse well from each other and tended to form clusters.

FIG. 48A, 48B shows gold NPs being captured after each step of separation. The majority of gold NPs being captured in first filtration on 0.2M PAA membrane were 200 nm gold NPs (FIG. 48a). However some 50 nm and 20 nm gold NPs were also trapped as shown by the red-circled. This unexpected trapping may due to absorption because of the presence of the carboxyl and amine groups in PAA serving as molecular anchors that bind the NPs to the surface. Similar results were noted for the 20 nm gold NPs in second filtration using 0.23M PAA membrane (FIG. 48b yellow circle). Although most of the gold NPs captured during the second filtration were 50 nm gold NPs, there were still some 20 nm gold NPs trapped. In addition, it was observed that some 200 nm gold NPs missed during the first filtration step were capture by the second filter (FIG. 48b yellow dashed circle). As discussed herein, membrane filtration has its limitations. One of these is the defect of membrane filter which will allow some particles to pass through even if they have a much bigger size than the nominal pore size of the membrane. The final filtration should capture any gold NPs left in the mixture. This included 20 nm gold NPs and some 50 nm gold NPs that were missed by second filter because of the defect of PAA membrane.

FIG. 49A, 49B shows their sizes and shapes after they were filtered separately by 0.44M PAA membrane. TiO₂ NPs have no uniform size or shape and they heavily aggregated into bulky blocks on PAA membrane. Most of 60 nm silver NPs have uniform size of about 75 nm and are spherical in shape. Several of these are rod-like. Some are as small as 15 nm. All 10 nm gold NPs have uniform size and spherical shapes.

FIG. 50A, 50B shows the NPs captured during the first filtration. Since TiO₂ NPs do not have uniform size and shape, it is hard to recognize what was captured by simple estimating the size and shape. So EDS mapping was utilized to identify the NPs left on PAA membrane. In FIG. 50a, silver nano-rods can be easily recognized by their unique shape. It is still difficult to determine whether spherical silver NPs and gold NPs were there or not by SEM images merely. Comparing SE image (FIG. 50b) with corresponding EDS mapping images (FIG. 50c-g), further confirms that both TiO₂ and silver NPs have been captured on the membranes by focusing on the white areas in the SE image is PAA membrane. However, gold mapping shows a very low abundance compared with carbon. This means there was a few gold NPs captured on surface. The trapping of silver NPs is due to the lack of pores on membrane surface because TiO₂ covered most part of PAA membrane causing clogging. As discussed previously, few gold NPs were captured because of adsorption.

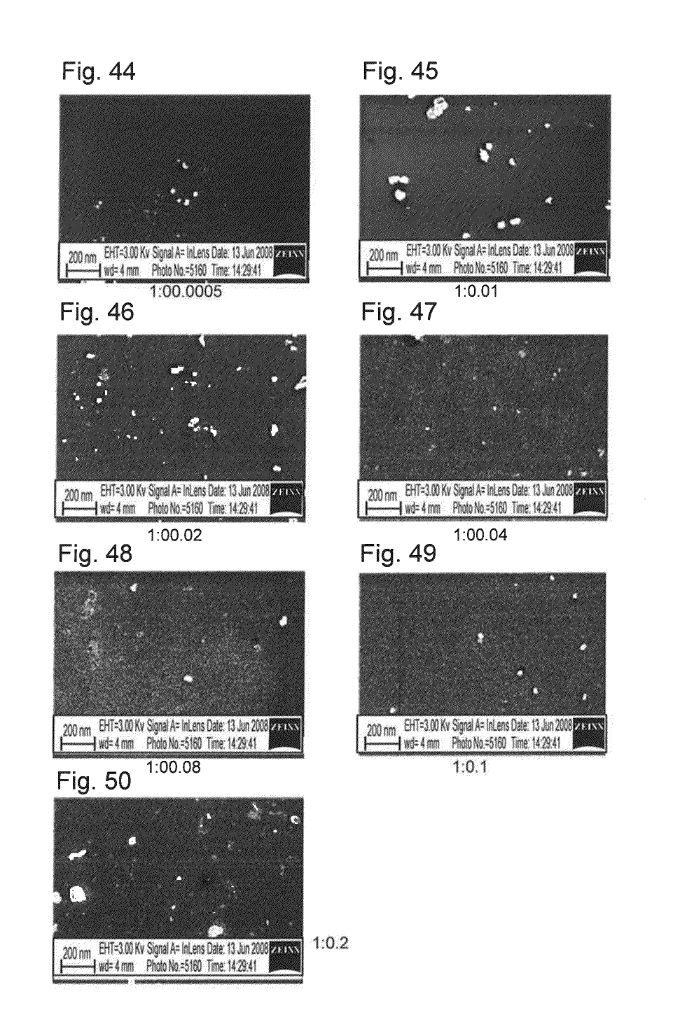

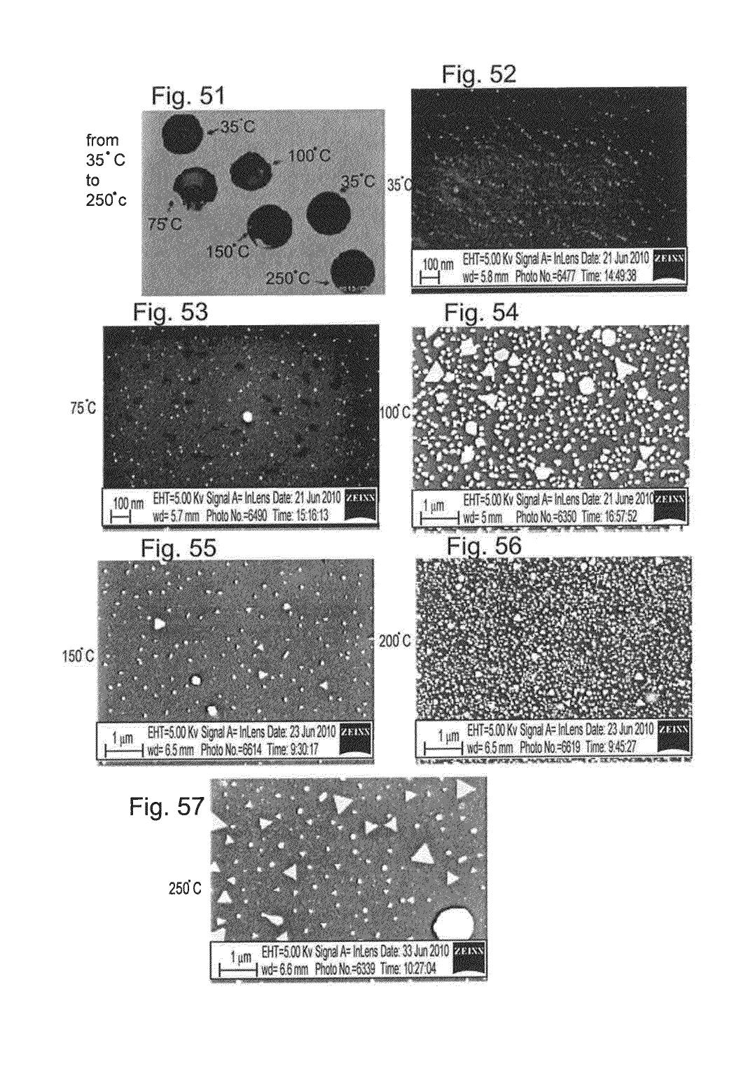

FIG. 51A, 51B shows the NPs in mixture solution captured in second filtration of separation. EDS mapping images were used to further identify the NPs. The results show that both TiO₂ and silver NPs have been captured in the second filtration (FIG. 51 b-e). Few 10 nm gold NPs were left on 0.23M PAA membrane (FIG. 51g). However, no bigger than 80 nm NPs were found on the 0.23M PAA membrane when compared with first filtration step (FIG. 51 a). Most of the NPs captured in the second filtration were within a size range of 35-80 nm.

The final filtration step utilized 0.44M PAA membranes to capture all the NPs in the mixture. As shown in FIG. 52, it is not easy to recognize each NP at this stage due to aggregation, however most of NPs captured on the third filtration membrane have size of approximately 10 nm. EDS mapping of silver confirmed that the white particles in the SE image are gold NPs, while both titanium and silver had a very low abundance which indicates that there are few TiO₂ and silver NPs on the 0.44M PAA membrane.

It was noted in this work that the separation is not absolute because of the defect of PAA membranes. Although the irregular shape and size in the TiO₂ NPs posed difficulty to identify each kind of NPs according to their appearances, EDS mapping provided solid support for identification. TiO₂ NPs were found in both first and second filtration but the trapped TiO₂ NPs have different size range when used. This result indicates that PAA membranes for separation were not based on the chemical composition of the NPs but according to their sizes

As shown in FIG. 53A, 53B, all the NPs are spherical but 61 nm and 18 nm polystyrene beads do not have a uniform size as described by their manufacturer. The size range for these two polystyrene beads is very wide, 10 nm-200 nm. 61 nm polystyrene beads have less than 118 nm polystyrene beads. Polystyrene beads have very poor dispersion on PAA membrane after filtration. They preferred to cluster and “cake” on one part instead of dispersing evenly on the surface, while filtered 10 nm gold NPs had much better dispersion.

The separation results were shown in FIG. 54A, 54B. Because polystyrene beads have no uniform size and they consist of carbon, oxygen and nitrogen elements, both SEM and EDS mapping cannot distinguish between 118 nm polystyrene beads, 61 nm polystyrene beads and gold NPs respectively. However, despite their chemical composition, PAA membranes can still show some selectivity according to particle size. As shown in FIG. 54a, the majority NPs captured by 0.21M PAA membrane in first filtration were about 200 nm, however there were also many small NPs attached to big NPs as pointed by red arrow, and retained on 0.21M PAA membrane. In second filtration, much less 200 nm NPs were observed. Most of the NPs were within a range of 40-100 nm (FIG. 54b). The third filtration (FIG. 54c) simply captured all the remaining NPs in the mixture including some large NPs that were missed by the previous two PAA membranes because of their defects. These NPs preferred to gather together with poor dispersion.

Embodiments of the PAA membrane shows superior filtration efficiency and performance compared to qualitative filter papers, nylon analytical filter membrane with a single efficiency up to 99.7%. These embodiments also show great potential for application for NPs separation. Although it does not show much selectivity according to the NPs' chemical composition, it shows its ability to separate efficiently based on NPs' size. Due to the limitation of membrane filtration, PAA membranes cannot separate the NPs' absolutely and hence some NPs bigger than the nominal pore size were not filtered. However, majority of NPs trapped on PAA membrane were still bigger than its nominal pore size. It was observed that due to NP nature of aggregation and “caking”, some difficulties in separation were recorded. In summary, PAA membranes can be applied in UF and NF for NPs' isolation and separation.

### D. Implementation IV

Silver is a non-essential toxic element while silver NPs are increasingly used in a variety of applications including medical devices, water treatment, nutraceuticals, food colorants, food storage containers, baby pacifiers and antimicrobial agents. Bactericidal activity of silver NPs is dependent on their shape and size, with particles of sizes less than 100 nm showing optimal antibacterial activity. The knowledge of the ability of silver to kill harmful bacteria has made it popular in creating various consumer products. In spite of these useful applications, silver NPs have been reported to be toxic as introduced. Besides the on-going debate about the safety and potential risks of engineered silver NPs are already being used in the food industries as food additives and packaging materials. Although the use of silver NPs may bring about a range of benefits to the food sector, such as new taste, textures and sensations, improved packaging, and traceability of food products, the presence of silver NPs in food, beverages and storage containers may also cause unintended harm to human health that may be difficult to trace. Furthermore, there is currently no standard analytical method for monitoring these nano-sized analytes in food samples.

As noted above, PAA membrane show filtration properties for NPs with a filtration efficiency as high as 99.97%. The discussion below describes the quantitative detection application of examples of PAA membranes for, e.g., silver NPs. In this implementation, four food supplement samples containing silver NPs purchased from various manufacturers were evaluated using examples of the PAA membrane. The resulting concentrations were compared with result of atomic absorbance spectroscopy. Moreover, this disclosure presents optical method and electrochemical method without PAA membrane, as well as methods for silver NPs detection with and without PAA membrane.

All reagents were analytical grade unless otherwise stated. Stock solutions were prepared using triply distilled deionized Nanopure water with resistivity of 18 MΩ or better. The following reagents were obtained from Sigma-Aldrich Co. These include: sodium ethylenediamine (EDTA), silver nitrate (99.99%), ODA, PMDA, and DMAc. Zinc oxide (ZnO) nano-powder (<50 nm) was obtained from Aldrich, ZnO 6% doped with Al. Silver nano-powder (100 nm), hydrogen peroxide aqueous solution, sodium chloride were purchased from Fisher Chemical. Nitric acid was purchased from J. T. Baker. Gold-coated glass slides with 200 Å continuous gold coating layer were purchased from Asylum Research (USA). Aqueous colloidal solutions of silver NPs (Standard 40 nm) and gold NPs (standard 50 nm) were purchased from Ted Pella Inc. (USA). Silver NPs food supplement samples were purchased from various sources including MesoSilver (>20 ppm), Purest Colloids Inc (USA); Colloidal Silver (35-45 ppm), Golden Touch Mfg./Ultra Pure (USA); and Sovereign Silver (10 ppm), Natural Immunogenics Corp (USA). Other reagents were purchased from Thermo Fisher Scientific Inc. (USA).

The 40 nm silver NPs standard aqueous solution (Ted Pella Inc.) was diluted with Nanopure water in various concentrations. These solutions were used as silver NPs standards for electrochemical measurements. 10 ppm silver nitrate and 0.01M EDTA (adjusted to pH=7) aqueous solutions were prepared by dissolving corresponding salt with deionized water. ZnO NPs suspension (5 mg/ml) was made by dissolving ZnO NPs into water and sonicating for 10 minutes. Two phosphate buffer solutions were prepared. One is 0.01M Na₂HPO₄ with 0.25M NaCl adjusted to pH7.0, and the other without NaCl. All the aqueous solutions of NPs were sonicated for 5-10 minutes before use.

1 mg silver nano-powder was first dissolved in 1 ml solution of nitric acid and H₂O₂ with a v/v ratio of 1:10. Then the resulting solution was then reacted with 4M NaCl solution. The reaction ratio is shown in TABLE 19 below. Two silver nano-powder samples with concentration of 13.18 μg/ml and 18.67 μg/ml were prepared separately. The solutions were measured using UV-Vis spectrometer immediately after reacting with NaCl solution. A solution mixed with water and NaCl solution was used as blank.

TABLE 19

| Amount of silver | | | Final concentration |
|---|---|---|---|
| nanopowder | Amount of | Amount of NaCl | of reacted silver |
| solution (μL) | H₂O (μL) | solution (μL) | nanopowder (μg/ml) |
| 1 | 599 | 400 | 1 |
| 2 | 598 | 400 | 2 |
| 5 | 595 | 400 | 5 |
| 8 | 592 | 400 | 8 |
| 10 | 590 | 400 | 10 |
| 15 | 585 | 400 | 15 |
| 20 | 580 | 400 | 20 |
| 25 | 575 | 400 | 25 |

Examples of phase-inverted PAA membranes were fabricated as described above. 1 ml various samples were filtered with each piece of membrane. Silver NPs were captured onto PAA membranes and applied to the gold-coated glass slides having surface area of 15 mm×15 mm. This PAA/Au glass slides was used as a working electrode in a three electrodes system, with Ag/AgCl as reference and Pt as auxiliary electrodes. Phosphate buffer solution with NaCl (pH 7.0) was used as the supporting electrolyte. All electrochemical experiments were conducted using BAS 100B potentiostat. Both Cyclic voltammetry (CV) and Differential Pulse Voltammetry (DPV) techniques were employed in the detection measurements. The PAA membranes having various amounts of standard silver NPs were first tested and the peak currents resulting from the oxidation and reduction of the silver NPs were used to generate calibration plots. The PAA membranes with silver NPs from food samples were subsequently tested the same way and their concentrations were estimated using standard silver NPs.

In tests for interfering NPs, gold and ZnO NPs were filtered separately and were captured on PAA membrane. The PAA membranes with these NPs were then applied on gold electrodes and tested electrochemically under same condition as tests for silver NPs. Also ZnO and silver NPs mixture, in which ZnO was 250 times abundant than silver NPs, was tested as well. Silver nitrate solution in which silver ions was same concentration of silver NPs was filtered by PAA membrane and then tested on gold electrode. In order to estimate the effect of silver ions on the electrochemical detection of silver NPs, EDTA solution was filtered through PAA membrane after silver ions or silver NPs were filtered.

This experiment was carried out in a three electrodes system which included a gold working electrode, a platinum auxiliary electrode and a Ag/AgCl reference electrode purchased from Bioanalytical Systems, Inc. Two buffer solutions were used including phosphate buffer solutions with and without NaCl.

During the experiments, 4 ml buffer solutions were used as blank. 1 ml MesoSilver solution was then added to the buffer solution each time until the total addition reached 8 ml. By using two buffer solutions, the effect of NaCl was compared.

In test of reversibility of this method, 4 ml MesoSilver solution was mixed with 4 ml buffer solution with NaCl and tested with various scan rates from 20 mV to 250 mV.

AgNO₃ stock solutions (from 50 ppb to 100 ppm) were measured by Perkin Elmer Model AAnalyst 300 atomic absorption spectrometer. The source of light was Fisher Scientific Au/Ag cathode lamp having slit width setting of 0.7 nm at measuring time of 5 sec. The oxidant rate setting was 101/min while the fuel rate was 31/min using time average measurement method. The absorption line at 328 nm was used to generate a calibration line of Ag ions. 5 ml each of the food supplement samples was mixed separately with 5 ml acid mixture consisting of concentrated nitric acid and sulfuric acid at 3:1 ratio. This acid mixture was used to oxidize silver NPs to silver ions in food supplement samples. The oxidized solutions were diluted into 50 ml solution using 3-times distilled water. The concentrations of silver NPs were estimated using AAS calibration line of Ag ions at 1:1 ratio.

Silver nano-powder dissolved in acidic hydrogen peroxide was oxidized into silver ions by hydrogen peroxide. The resulting silver ions were then reacted with NaCl to form AgCl. The chemistry for the reactions of silver nano-powder is shown below.

2Ag+H₂O₂+2HNO₃→2AgNO₃+2H₂O

AgNO₃+NaCl→AgCl↓+NaNO₃

The final solution changed from clear colorless solution to white milky solution because of AgCl particles suspended in water. This suspension has an UV absorbance at 255 nm as shown in FIG. 55. Eight concentrations of silver nano-powder listed in TABLE 19 above were measured and recorded as solid lines in FIG. 55. As concentration increased, the absorbance increased linearly as shown in FIG. 55 insertion. Two separately prepared samples were oxidized and measured using the same method. Their UV-Vis spectra were shown as dashed lines. According to calibration line, the concentrations of these two samples were 14.16 μg/ml and 18.32 μg/ml, resulting in recoveries of 107.4% and 98.11% respectively.

40 nm silver NPs aqueous solution was oxidized in same way and reacted with NaCl solution. However, there was no color change in solution. The solution remained clear and colorless, and no white cloudy AgCl suspension formed. The reason for different results to silver nano-powder and silver NPs in aqueous solution may be due to their structure. As described by its manufacturer, silver nano-powder was made by thermal plasma without addition of capping layer. While silver NPs solution were synthesized by recovery of silver nitrate with sodium citrate, and the resulted silver NPs have citrate ions as capping layer. The capping layer on silver NPs may protect silver from oxidization by hydrogen peroxide, and hence no silver ions formed to react with NaCl.

Electrochemical techniques provide significant advantages for in-situ monitoring applications due to their rapid response, remarkable sensitivity, selectivity, inherent miniaturization, low cost and independence of sample turbidity. The electrochemical oxidation of silver metal produces silver ions and electrons accompanied by a reversible redox signal^{224,225}. Upon reduction, the silver ions return to the surface and a reduction current is measured. As shown in FIG. 56a, the PAA membrane produced no redox peaks between the range of −150 mV and 350 mV, whereas silver NPs exhibited a pair of sharp reduction and oxidation peaks irrespective of the sample tested. Silver NPs filtered from 1 ml of 12 ppm standard silver NPs aqueous solution produced an oxidation peak at 120 mV and a reduction peak at 0 mV. These results agreed with previous studies and the pair of redox peaks can be attributed to the oxidation/reduction of the Ag⁰/Ag⁺ couple that was accompanied by the formation of oxide layers.

Moreover, all the three food supplement samples exhibited these redox peaks at similar potentials with a slight shift that may be due to the interaction between the silver NPs, the sizes and shapes of silver NPs²²⁶ and their capping organic citric acid molecules. This interaction had been well demonstrated by the voltammetric signals recorded for Colloidal Silver in FIG. 56b. In this case, the oxidation peak was split in two separate peaks at ˜100 mV and ˜200 mV respectively. As observed previously²²⁴, oxide formation was actually composed of two peaks, possibly, because of transition of different oxidation states of silver. It was also observed that the peak separation became obvious in the presence of small organic molecules having negative charges. Correspondingly, the silver NPs utilized in this work possess peripheral citrate ions. Since sodium citrate was employed in the synthesis, the silver NPs had been coated with a layer of citrate ions. Moreover, both PAA membrane and citrate ions have excess carboxyl groups in their structures that can provide the necessary charges. Most of the citric acid on silver NPs may have been washed off during the filtration steps with some residual charges on the surface. In addition, the force of the flow pushing these particles to the surface of PAA may overcome the weak surface charges. Indirect evidence using SEM showed that many silver NPs did aggregate, inferring that most of the surface of silver NPs was bare following the filtration step.

In electrochemical detection, DPV technique was also used to monitor the electrochemical oxidation of silver NPs following its isolation from the food supplements samples. DPV has higher sensitivity than CV and could provide a better resolution as well as quantitative information related to trace amounts of silver NPs concentrations. FIG. 57 shows results that all food supplement samples produced oxidation peaks at approximately the same potential while the control surfaces consisting of the blank gold and blank PAA membrane did not produce any peak in the range of −200 mV-400 mV. In addition, the DPV of these food supplements not only produced the expected sharp oxidation peaks for the silver NPs, they also showed some tailing after each peak. This can be attributed to transition of different oxidation states of silver oxides. Since the heights of these DPV peaks represented the amount of silver NPs in each samples, the concentrations of these food supplements samples was calculated from the calibration plots.

The DPV data for the standard 40 nm silver NPs produced an oxidation peak which was quite stable as shown in FIG. 57b. Hence various concentrations of the standard 40 nm silver NPs aqueous solutions were used to generate the calibration plot shown in FIG. 57c insertion. The concentrations of these food supplement samples were 23.3 ppm (MesoSilver), 17.2 ppm (Colloidal Silver) and 10.9 ppm (Sovereign Silver) according to their DPV results. The detection limit, which is defined as 3× the standard deviation of the blank, was 1 ppm, which can be easily improved by increasing the filtration volume of the sample. In these experiments, only 1 ml of each concentration (except for 24 ppm) was filtered and its silver NPs was captured on the PAA membrane. The detection limit could be lowered by increasing the volume of the samples filtered. For example, when 2 ml sample was filtered, the detection limit was halved at 0.5 ppm. At 10 ml sample volume, the detection limit was 0.2 ppm with a final LOD of 100 ppb recorded at 15 mL volume. This indicates that lower detection limit is achievable by increasing the volume of the samples filtered.

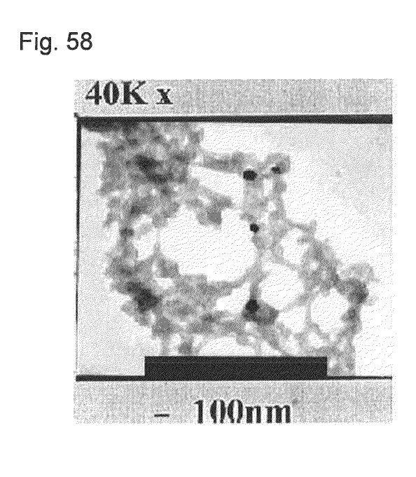

In order to confirm the selectivity of this method for detection of silver NPs, some common NPs such as gold NPs and ZnO NPs that are also easily obtained from the market and widely used in consumer products were tested with electrochemical method as silver NPs. As shown in FIGS. 58a and 58b, both gold NPs and ZnO NPs did not give any distinguishing redox peaks in this potential window (−200 mV-400 mV). Even when ZnO NPs were 250 times concentrated than silver NPs, sharp redox peaks for silver NPs were not obscured by the existence of ZnO NPs (FIG. 58c).

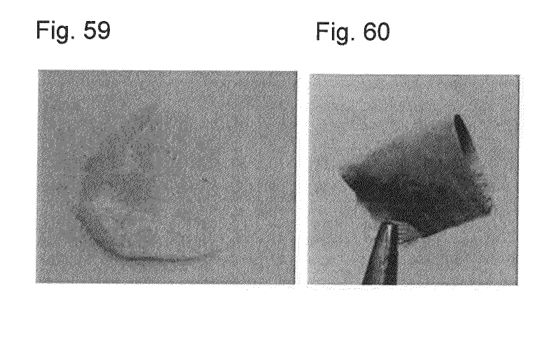

A successful detection method should not only identify silver NPs from other NPs, but also tell the difference between various silver elemental status, from non-oxide to oxidated status. In this case, silver ion is the major concern which may interfere with the detection of silver NPs. In order to mask the effect of silver ions in the detection of silver NPs, EDTA was used to wash off silver ions from PAA membrane surface. Although we assumed that the major mechanism of trapping silver NPs on PAA membrane surface was due to the surface pore size and hence ions should flow through membrane with solution, we still observed silver ions redox peaks when we only filtered silver nitrate solution by PAA membrane (FIG. 59). This suggested possible electrostatic interactions between positively charged silver ions and negatively charged carboxyl groups on PAA polymer. And the latter ones held the silver ions on PAA membrane surface, instead of letting them filter through. In this case, the domain mechanism for filtration is the chemical bonding between cations and anions other than size selectivity. However, by using a strong chelating agent such as EDTA, silver ions preferred binding with carboxyl groups on EDTA to the ones on PAA membranes, and then were washed off from PAA membrane with EDTA solution. FIG. 59b shows there are no many silver ions left on PAA membrane after washing with EDTA since the redox peaks decreased significantly. The formation constant for Ag-EDTA complex²²⁷ is 2.09×10⁷, and the calculated conditional formation constant is 1.09×10⁴ at pH7. Both formation constant and conditional formation of Ag⁺ are much lower than constants of most metal ions. Only several main group metal ions such as Na⁺, Li⁺ and K⁺, which are usually not electroactive, have lower formation constants than Ag⁺²²⁷. This indicates that EDTA can remove most metals from PAA membrane and hence eliminate metal ions' effect from silver NPs detection. The proposed mechanism is illustrated in FIG. 60.

Silver NPs were also washed with EDTA after they were captured by PAA membrane. However, unlike silver ions, the height of redox peaks assigned to silver NPs did not change much (FIG. 59b), which means that majority of silver NPs sample solution is silver NPs and they were retained on PAA surface. Furthermore, EDTA may improve the signal for silver NPs by eliminating the effect ions from membrane because the redox peaks before washing with EDTA are broader than the redox peaks after washing with EDTA. The broader peaks may be due to the existence of silver ions while the peaks for pure silver NPs are much sharper. The slight difference on redox peaks' height is caused by individual samples prepared separately on two gold electrodes. Overall, compared with silver ions which are more easily taken by EDTA in liquid phase, silver NPs were not washed off from PAA membrane because the trapping mechanism is membrane filtration based on the pore size of membrane, and silver NPs which themselves are solid particles preferred binding with carboxyl group on solid PAA membrane instead of EDTA in liquid phase as illustrated in FIG. 60.

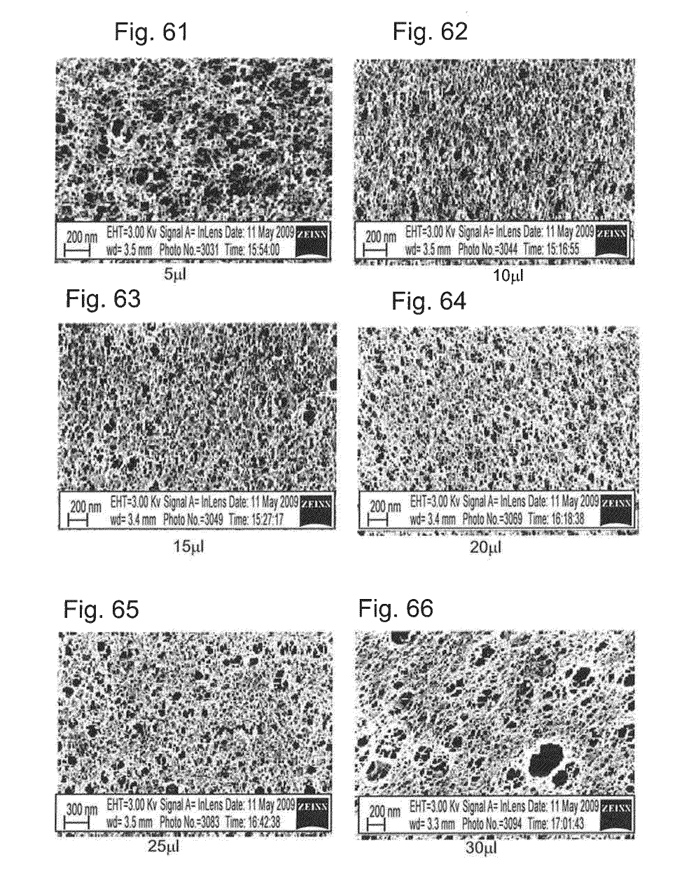

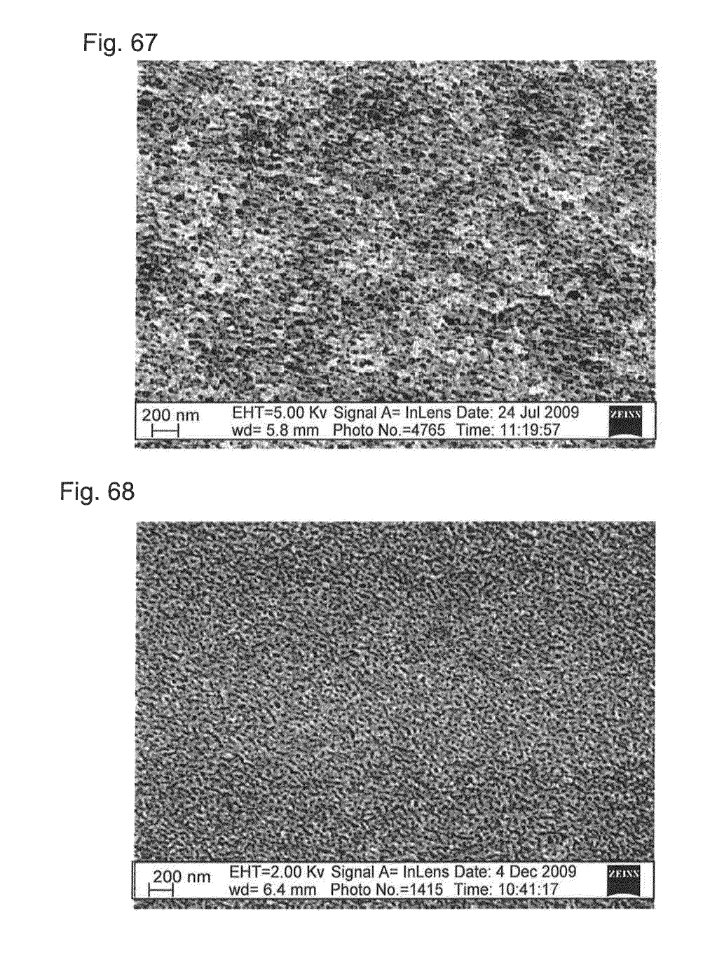

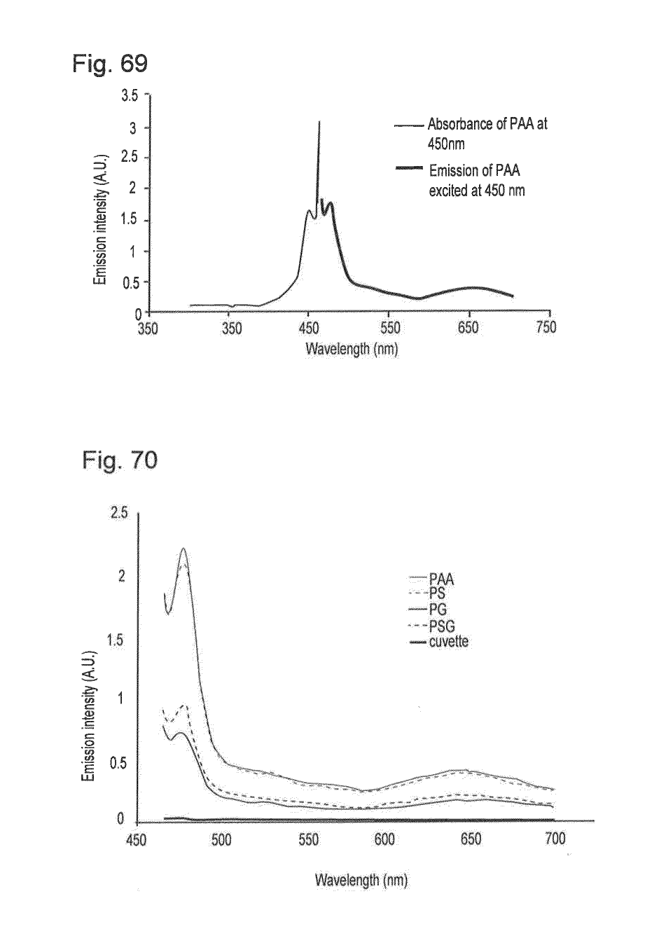

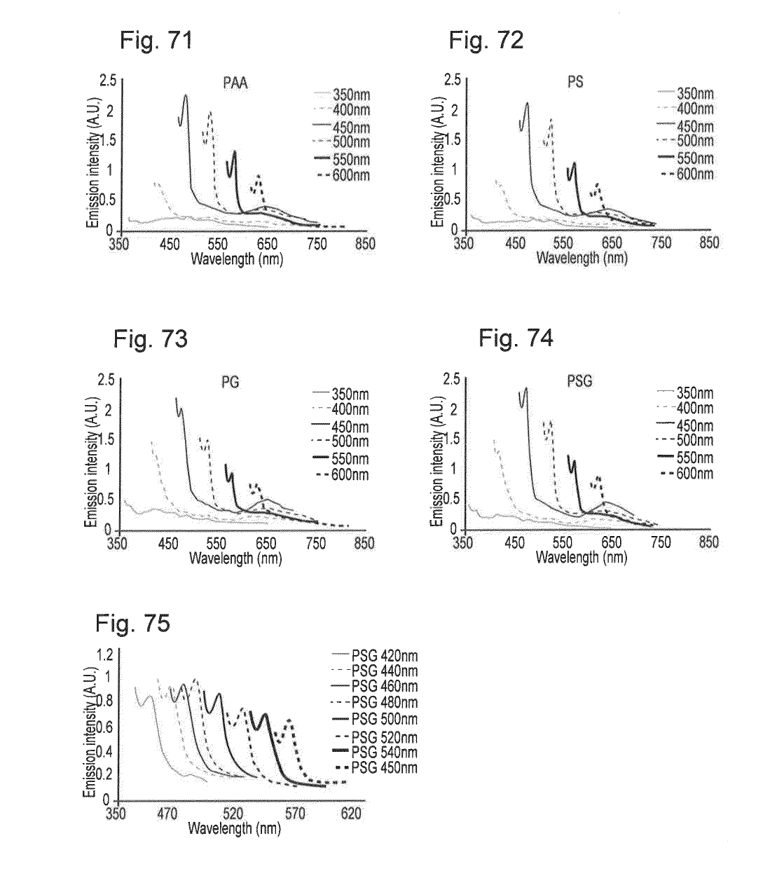

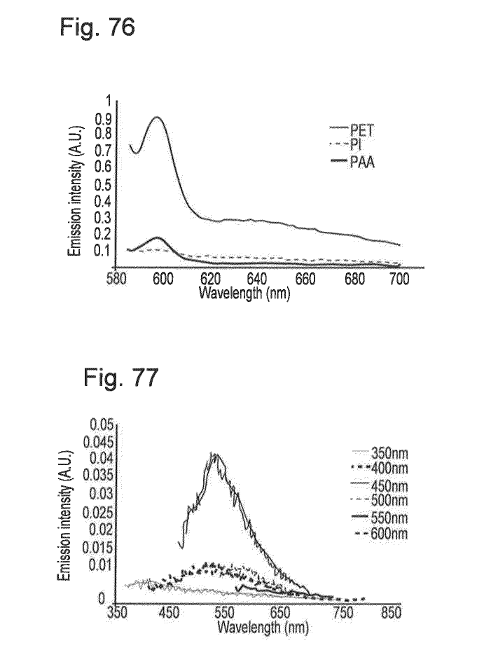

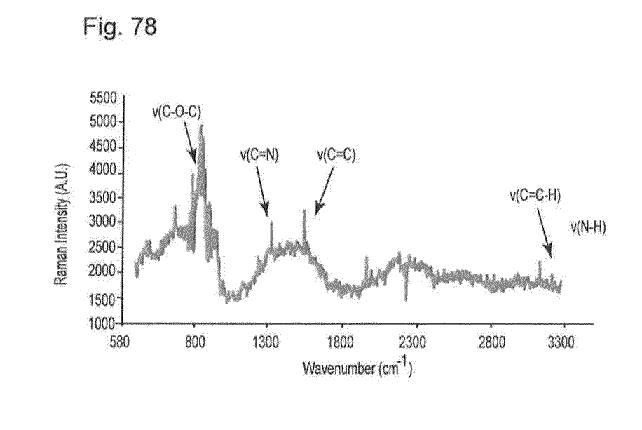

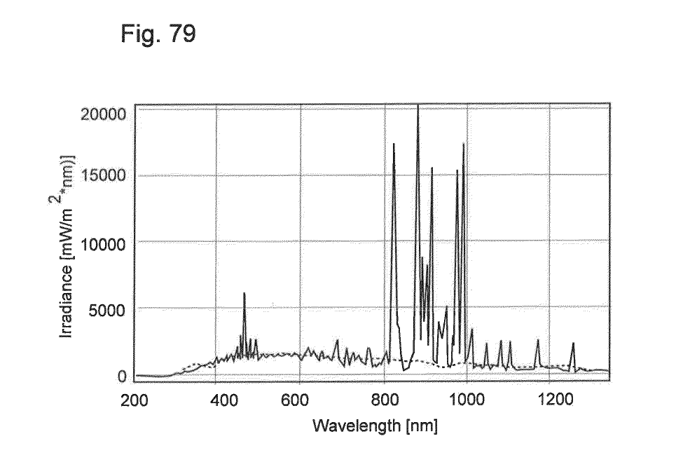

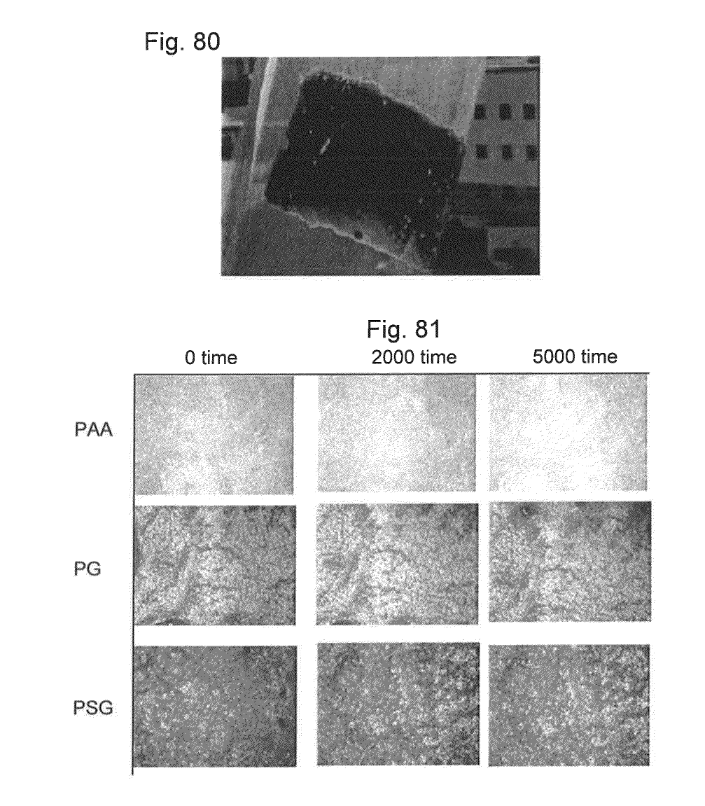

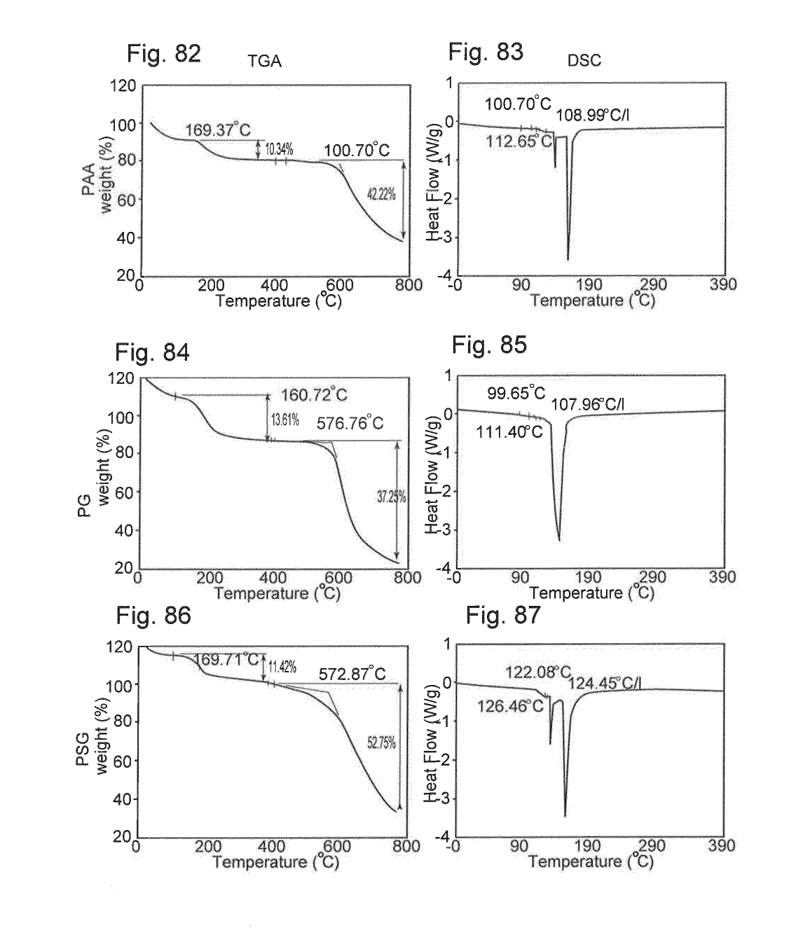

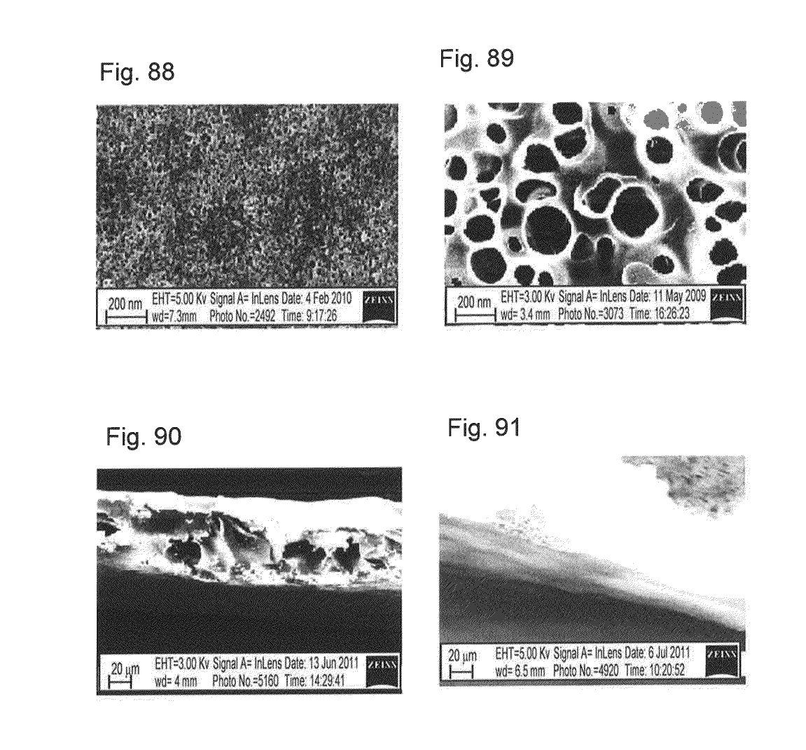

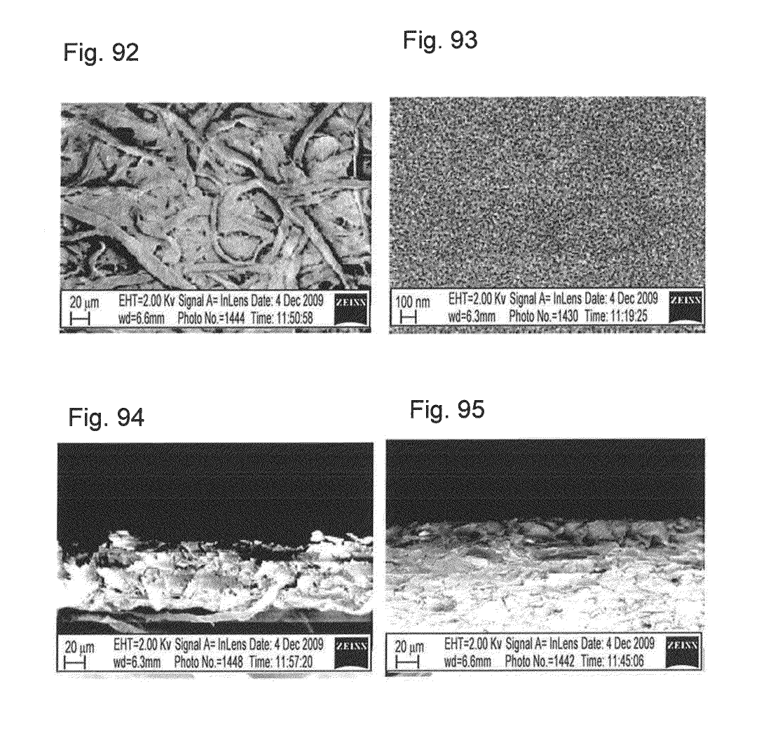

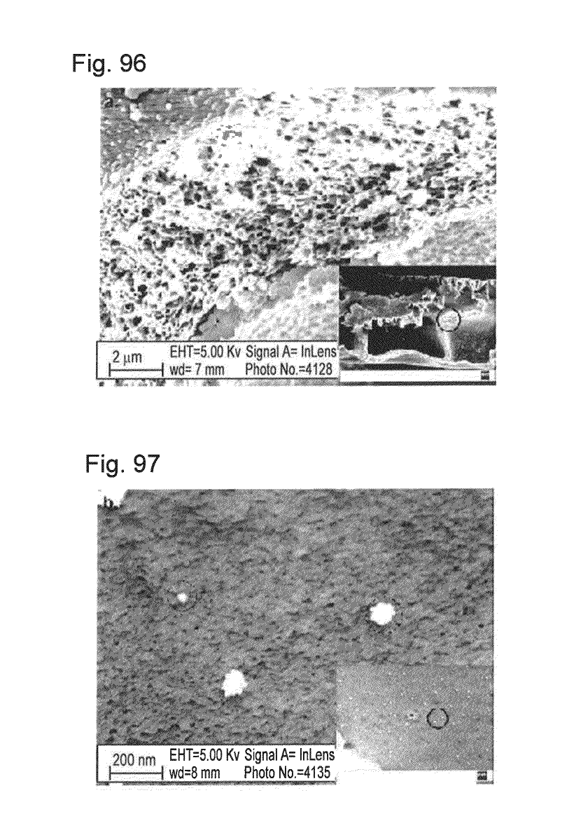

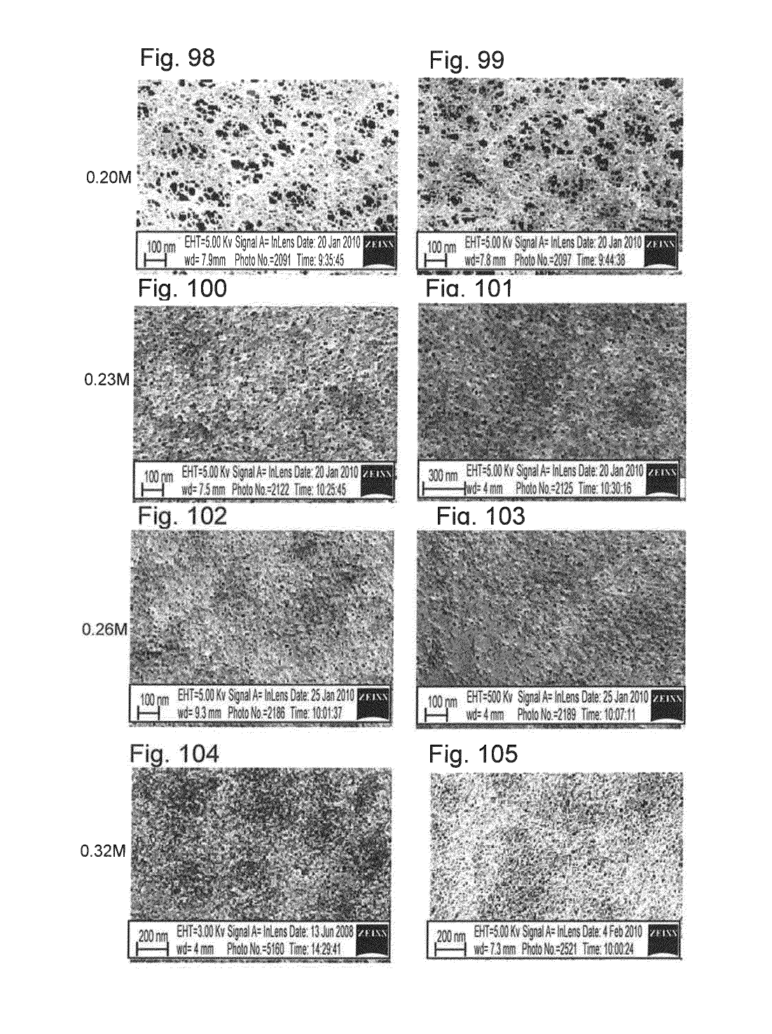

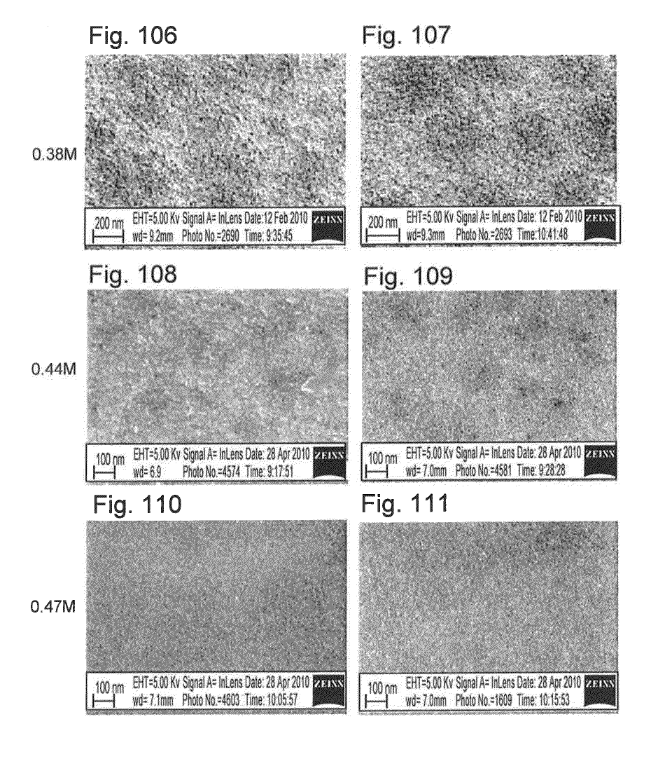

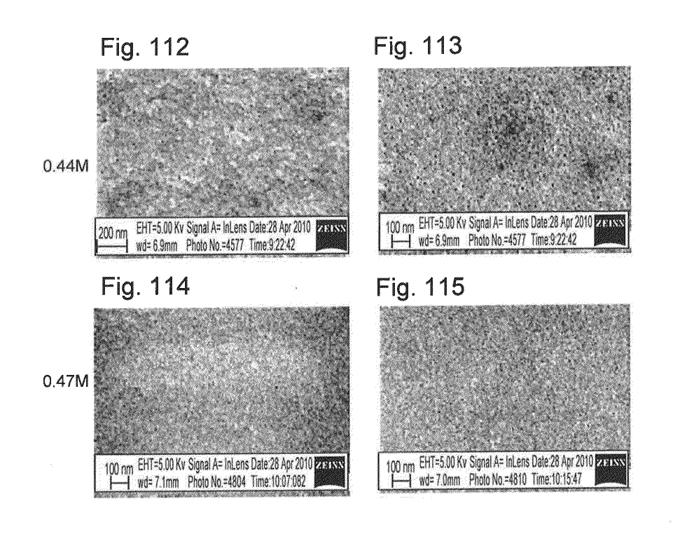

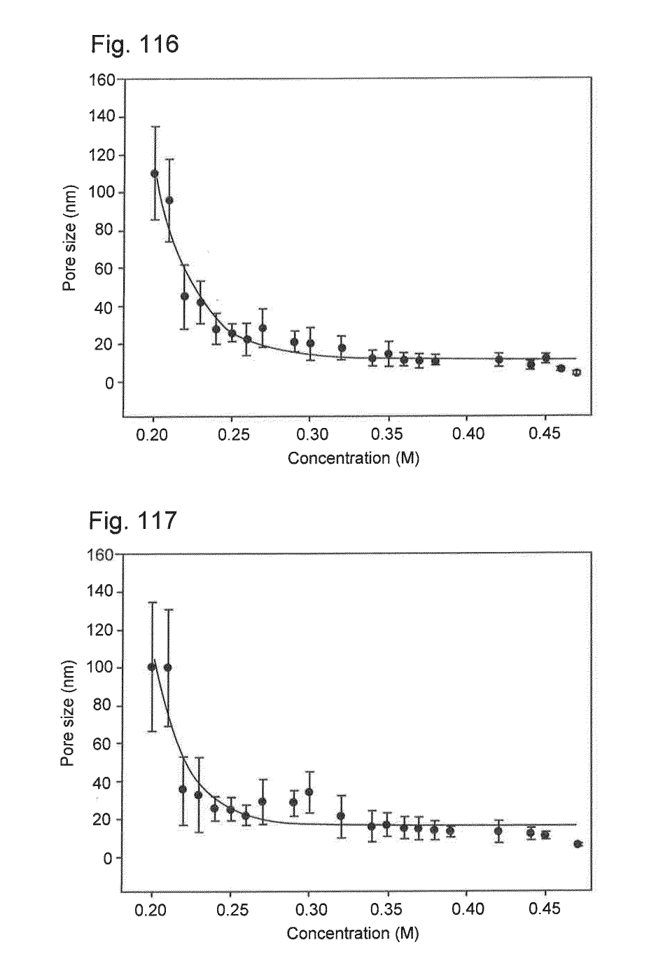

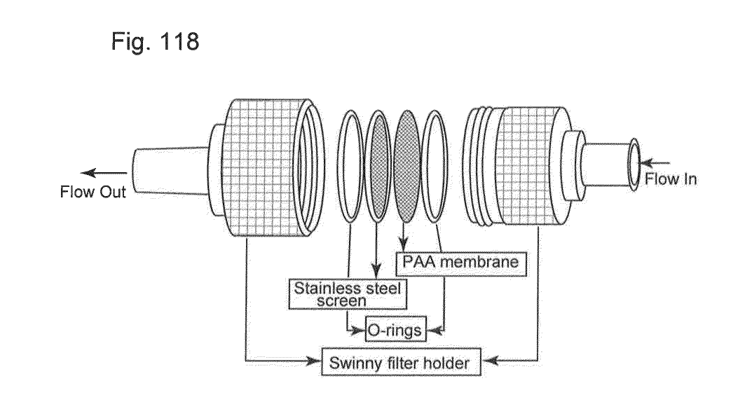

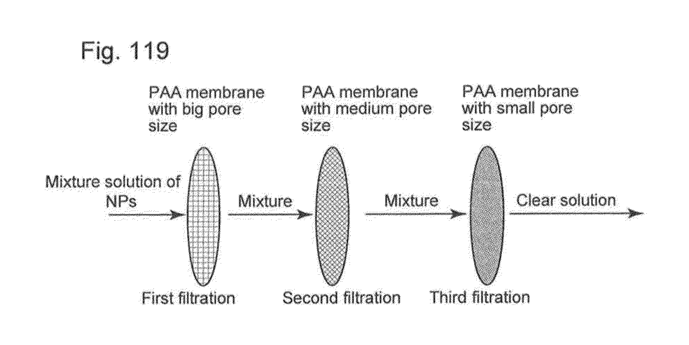

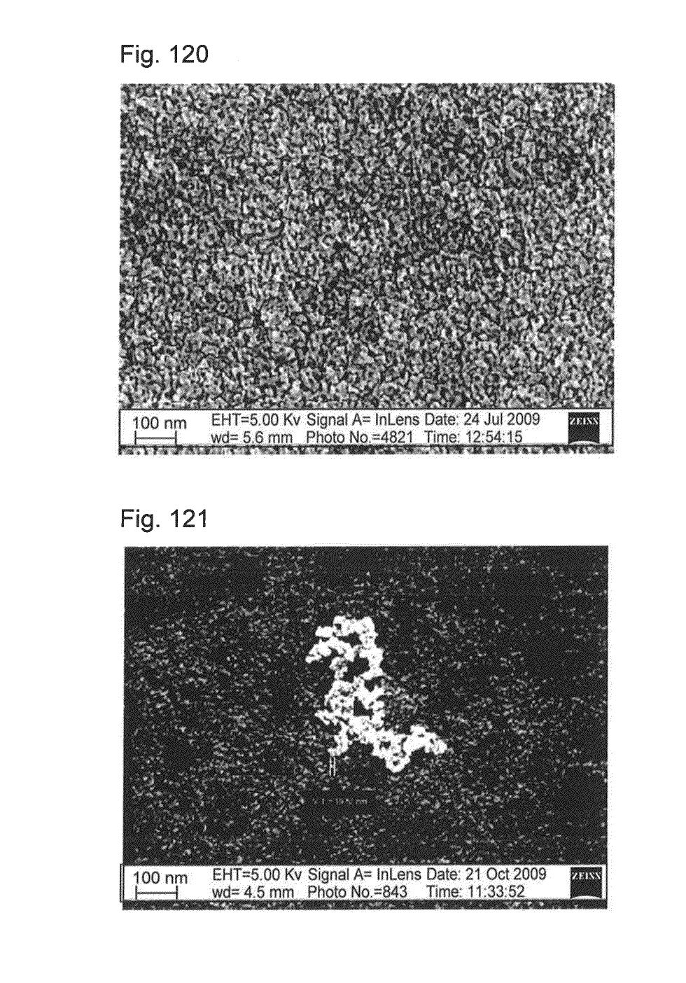

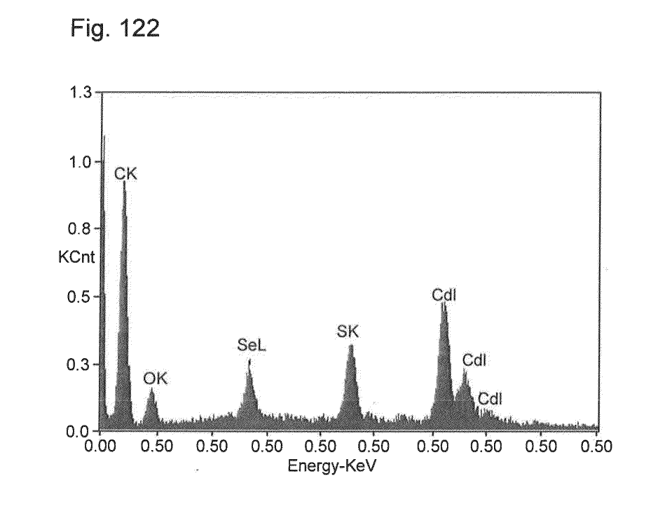

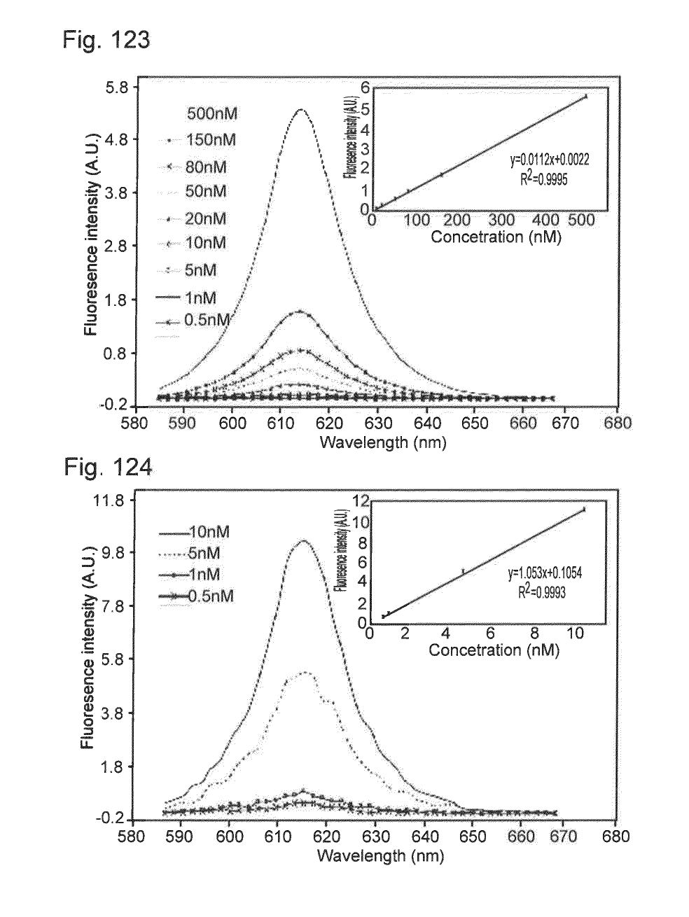

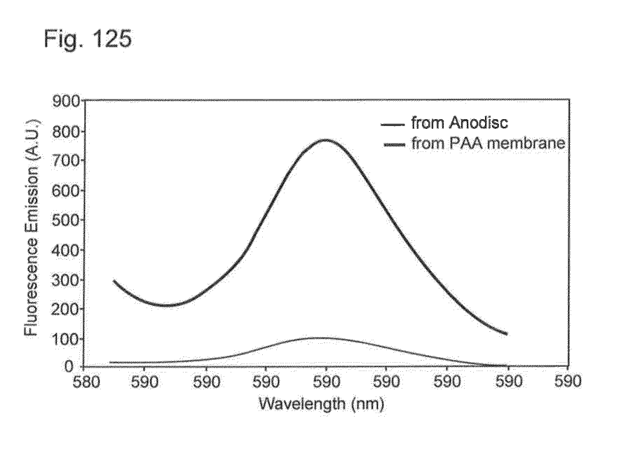

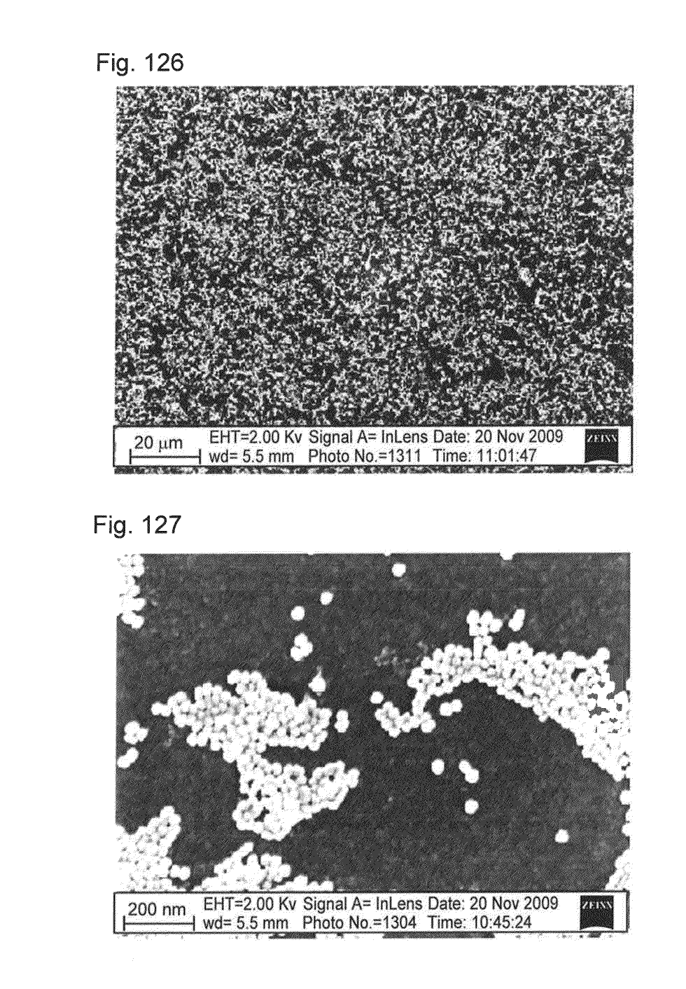

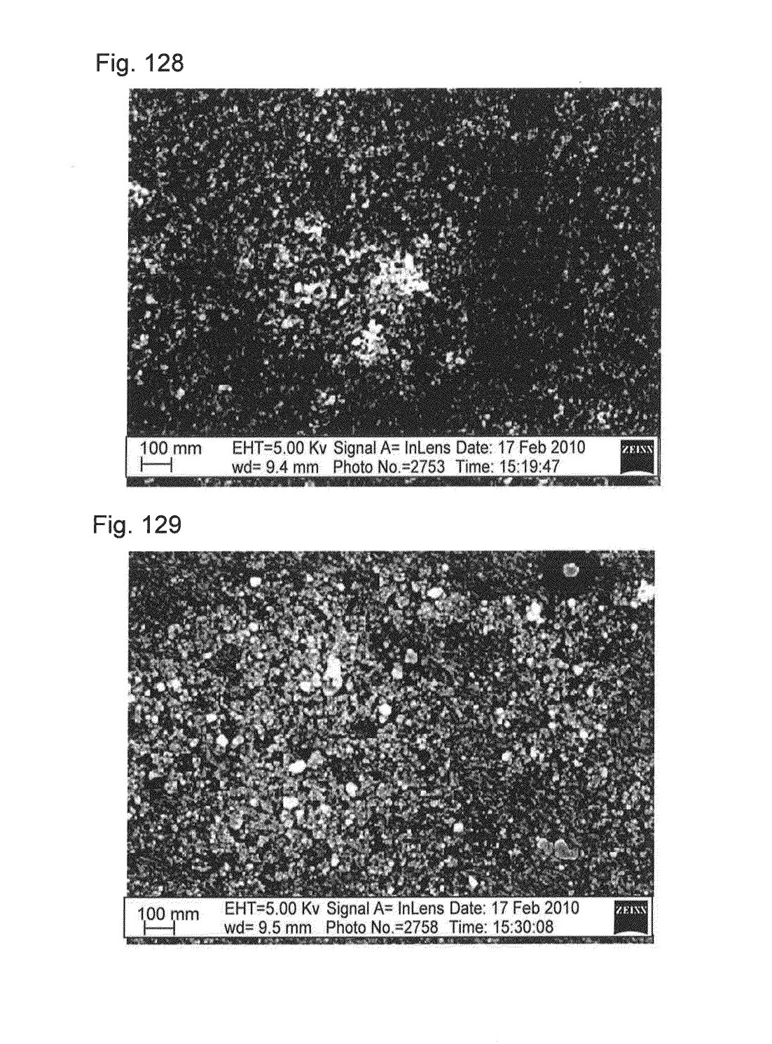

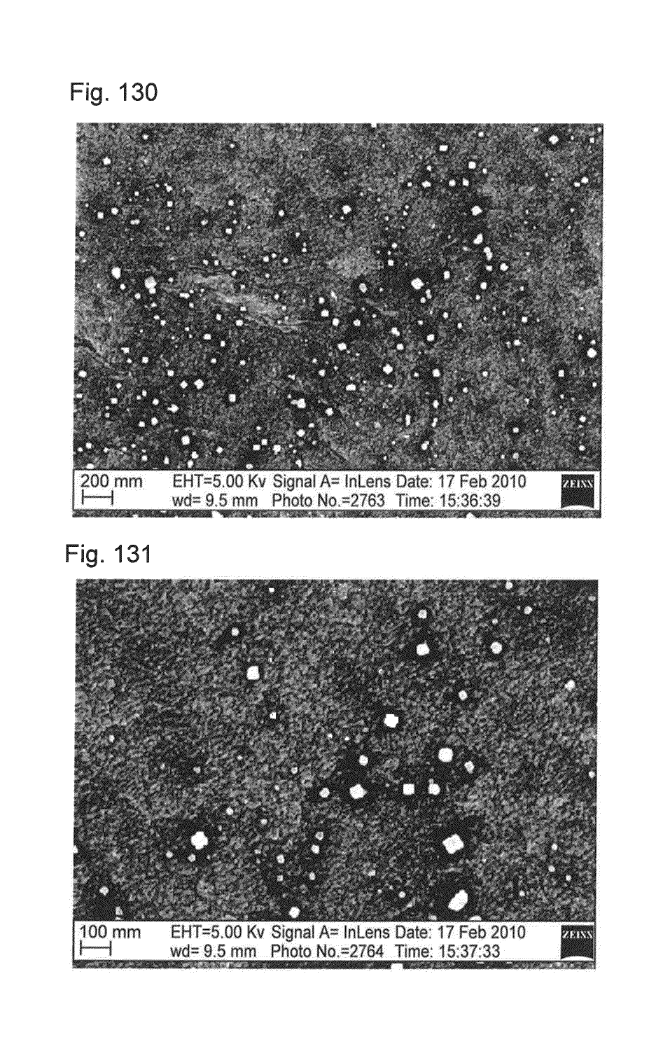

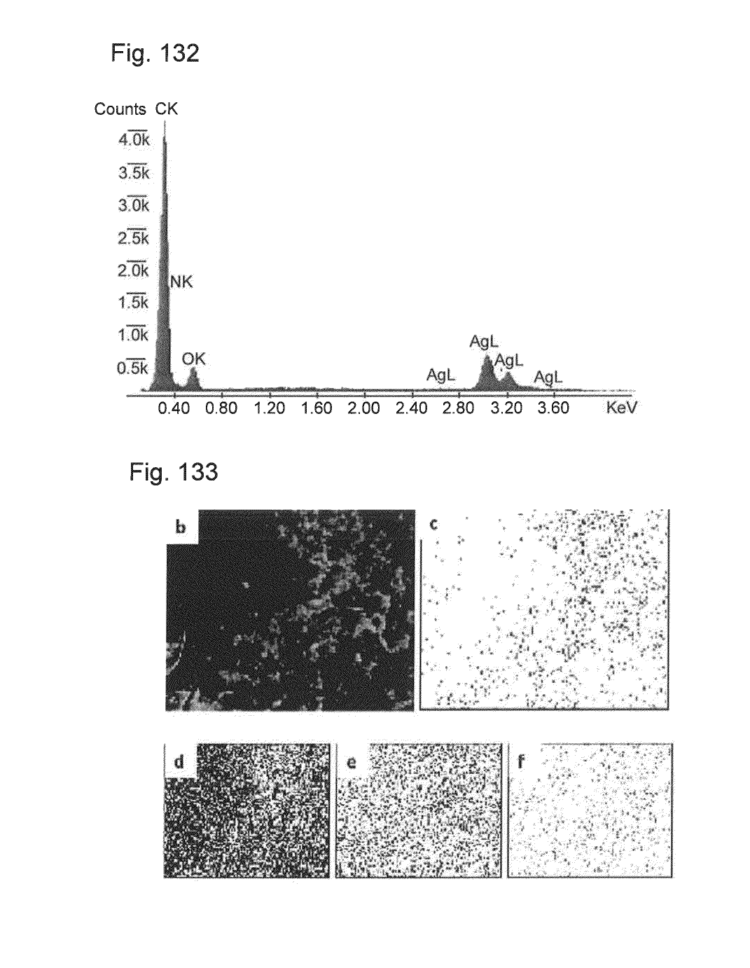

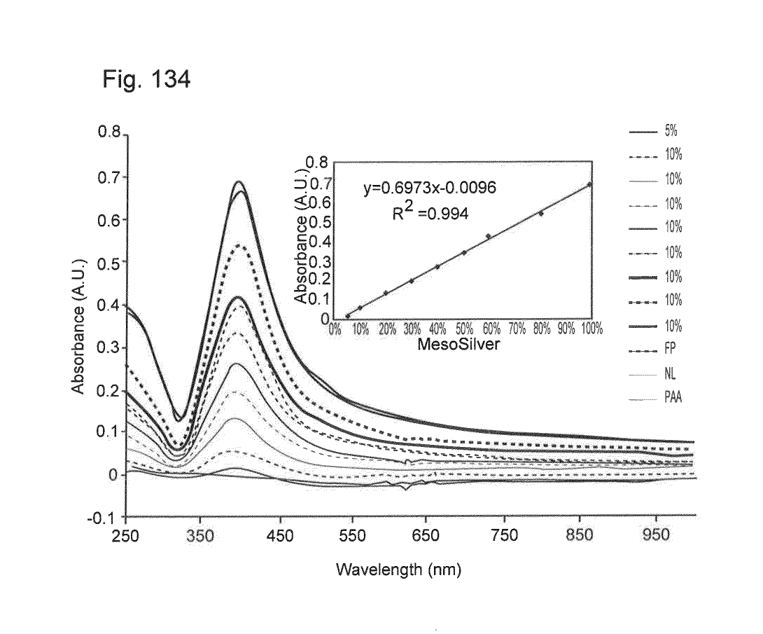

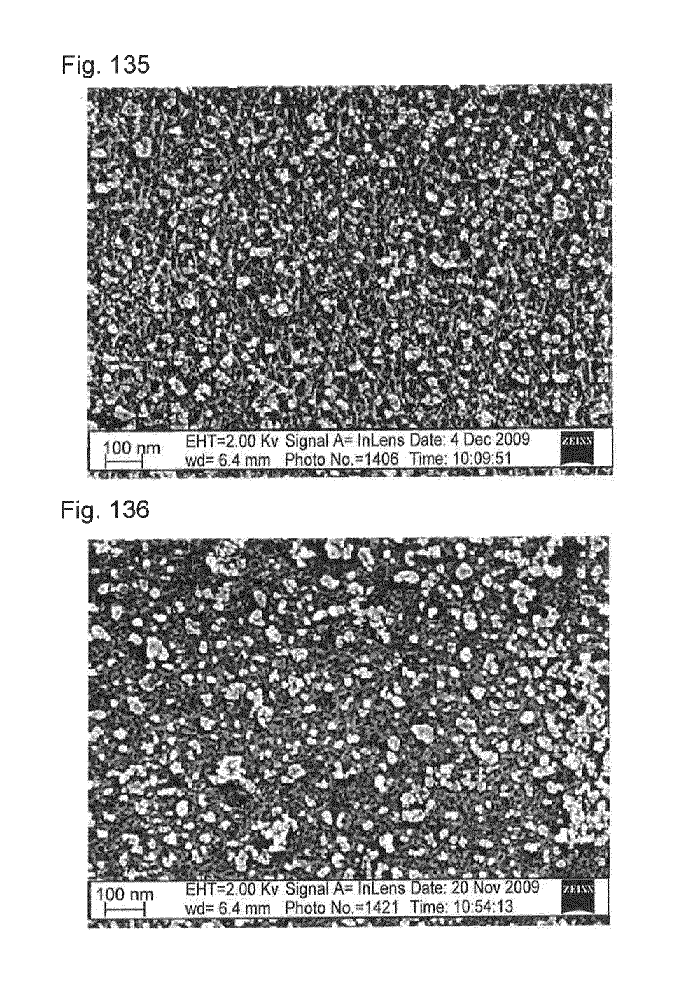

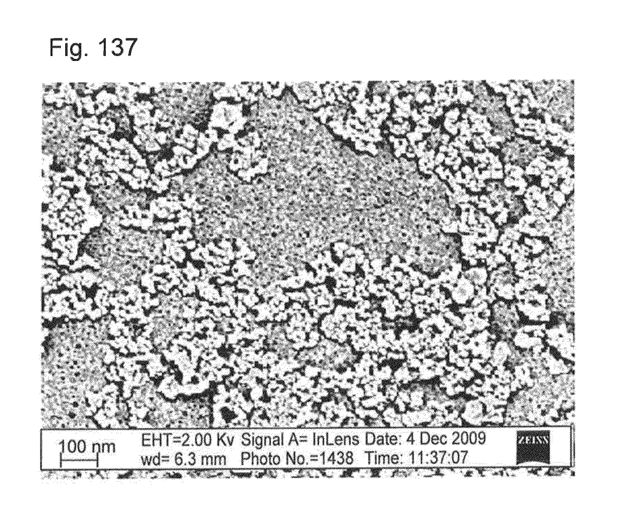

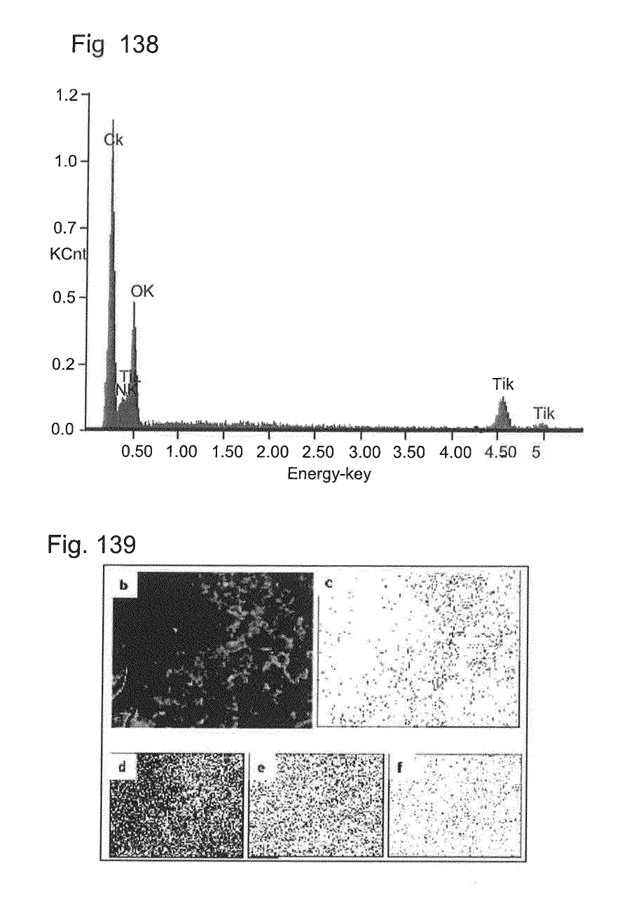

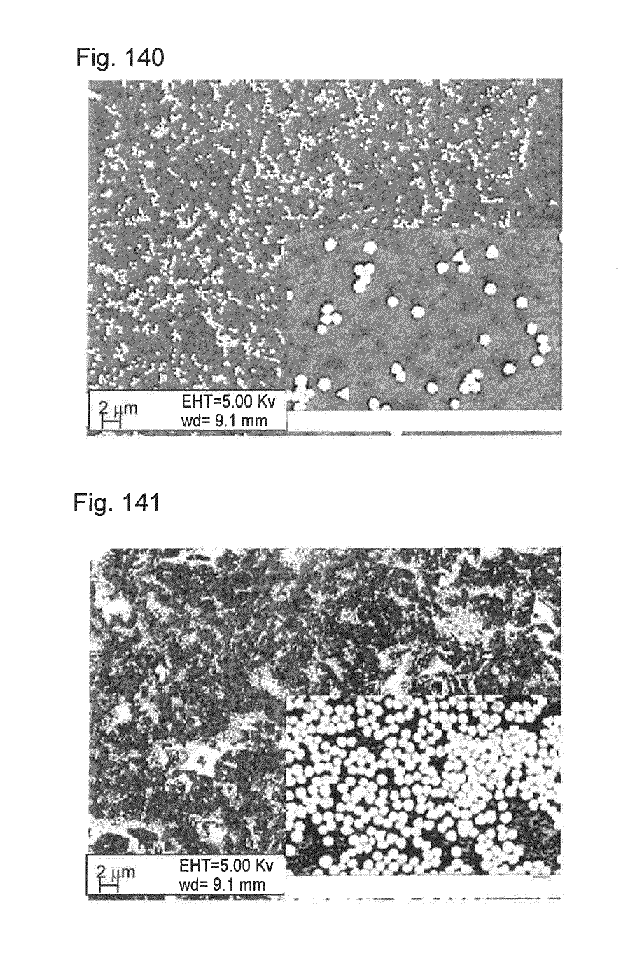

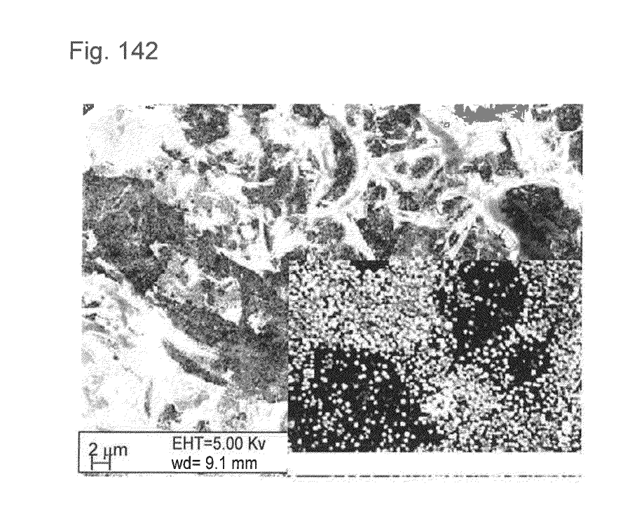

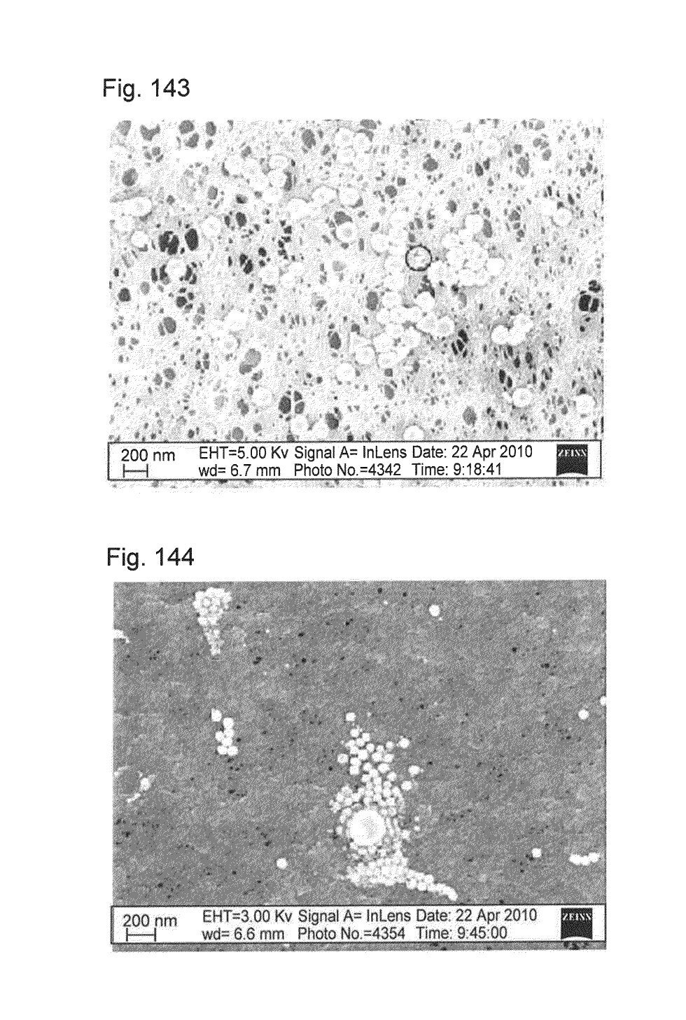

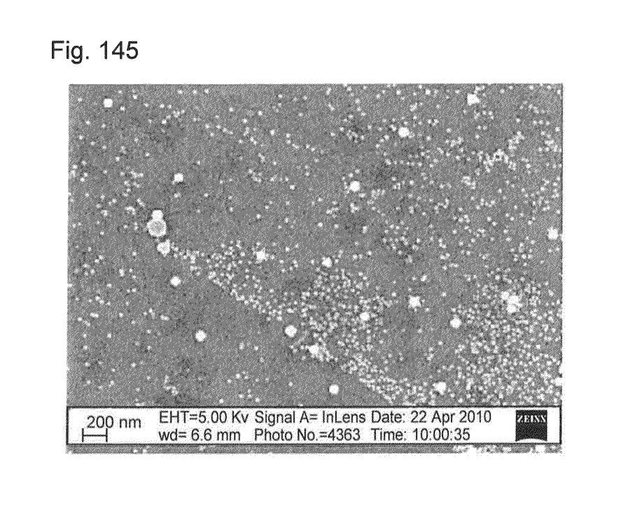

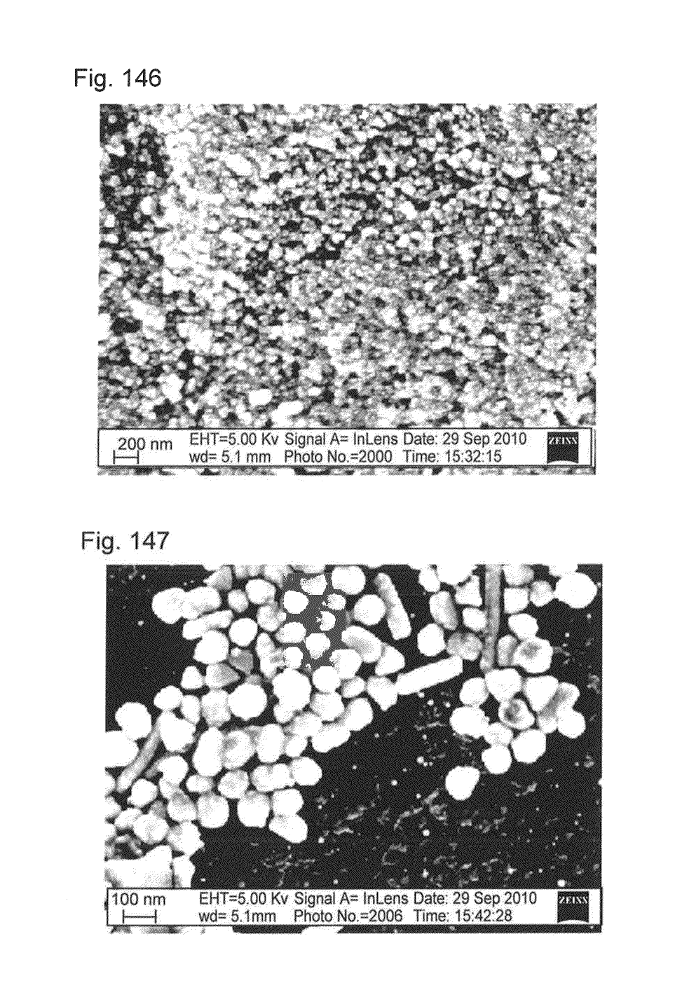

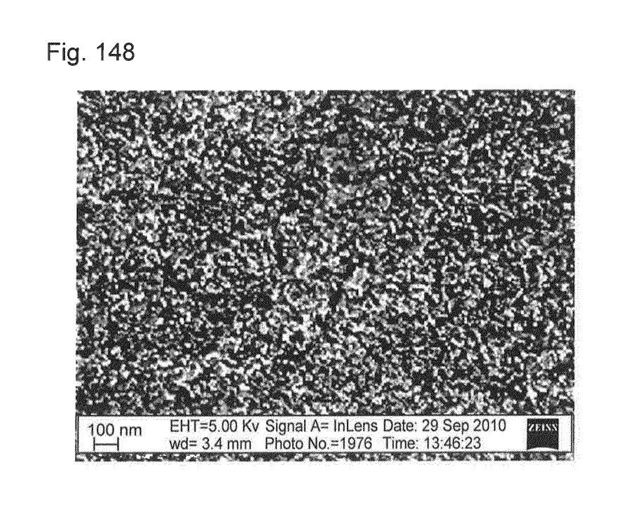

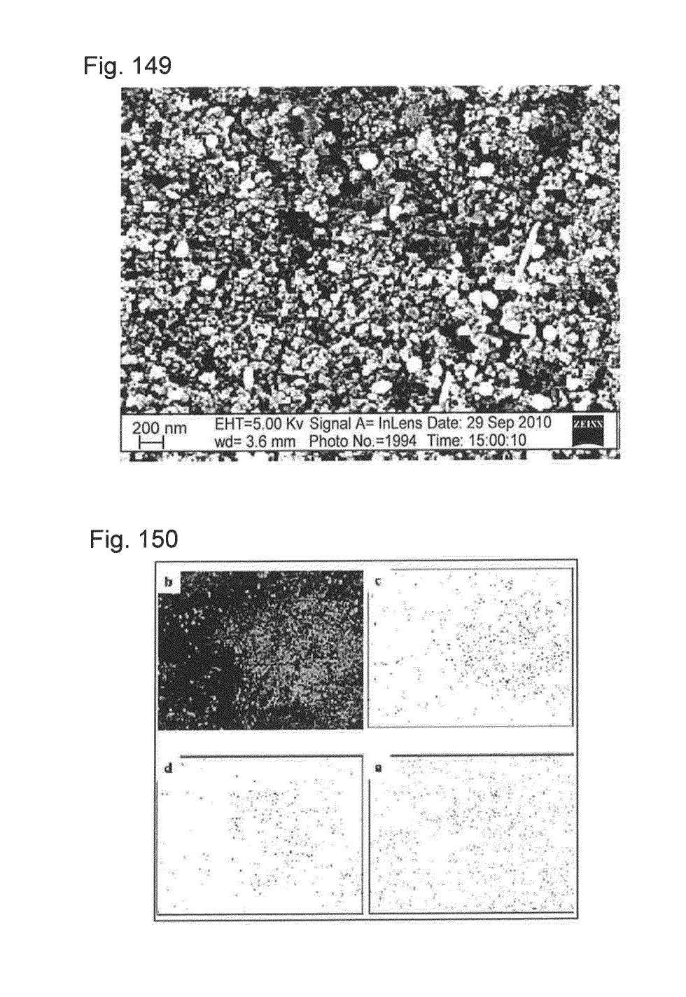

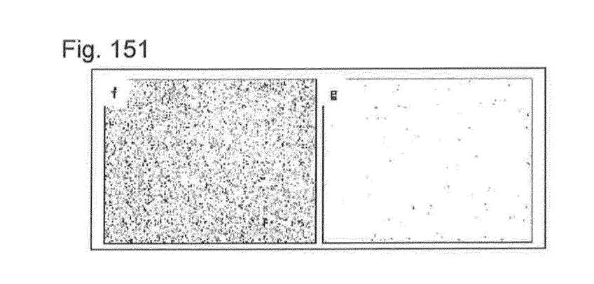

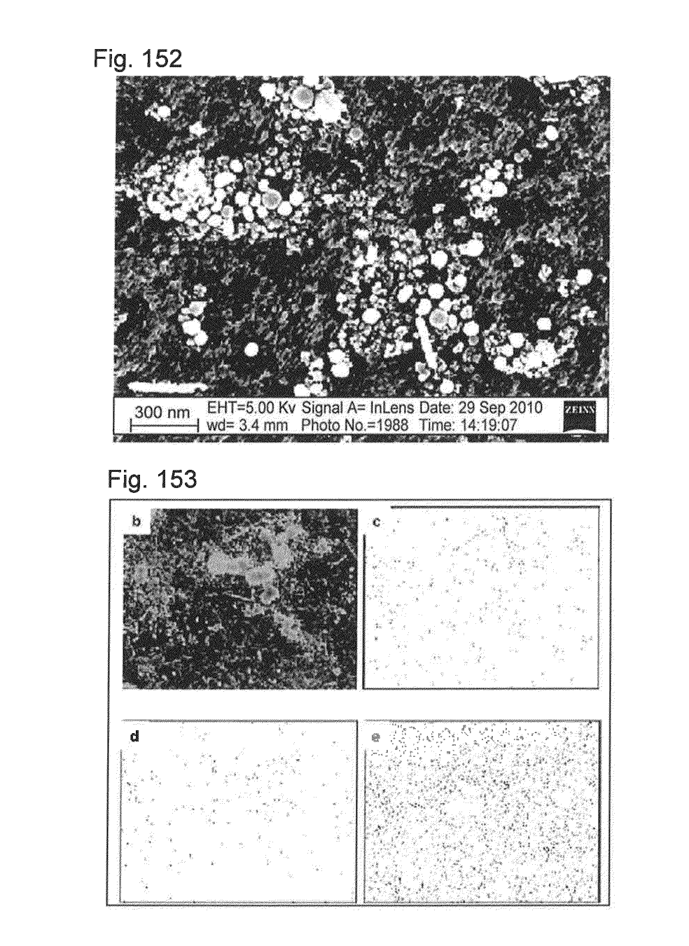

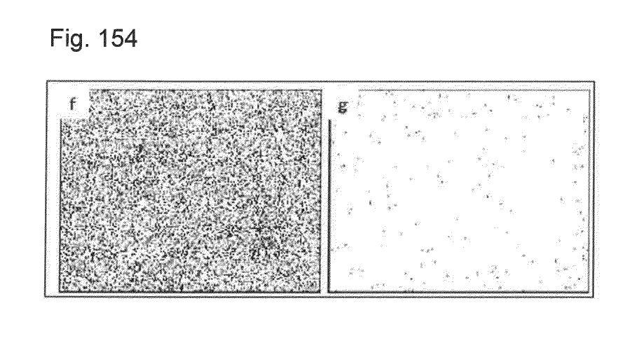

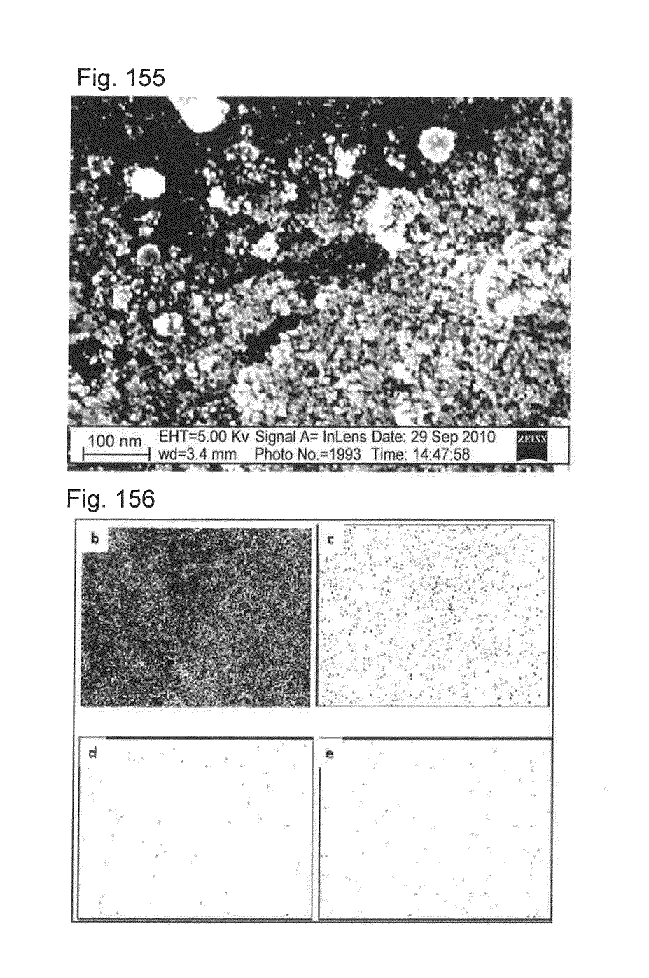

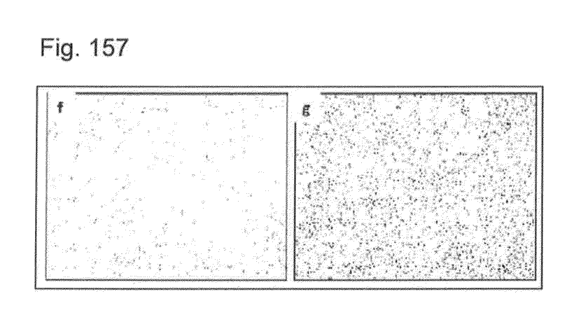

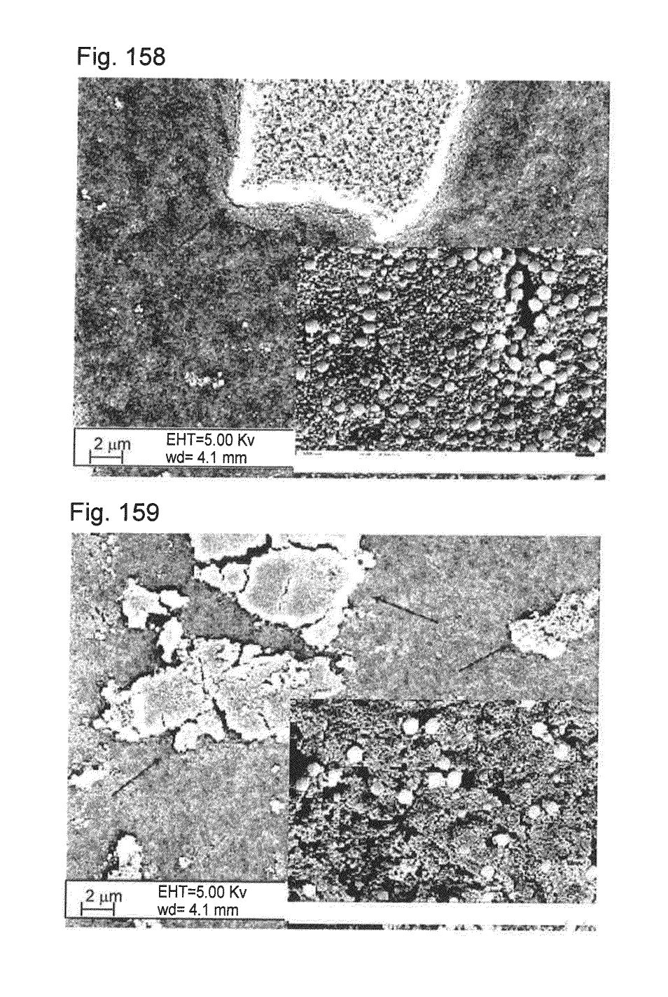

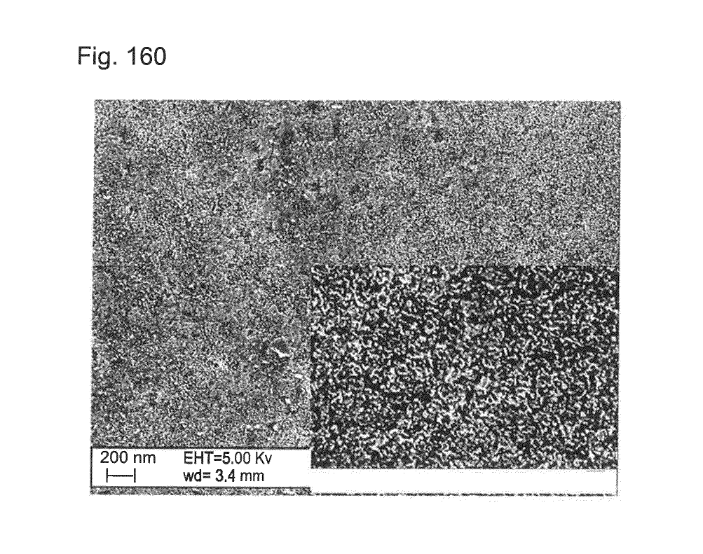

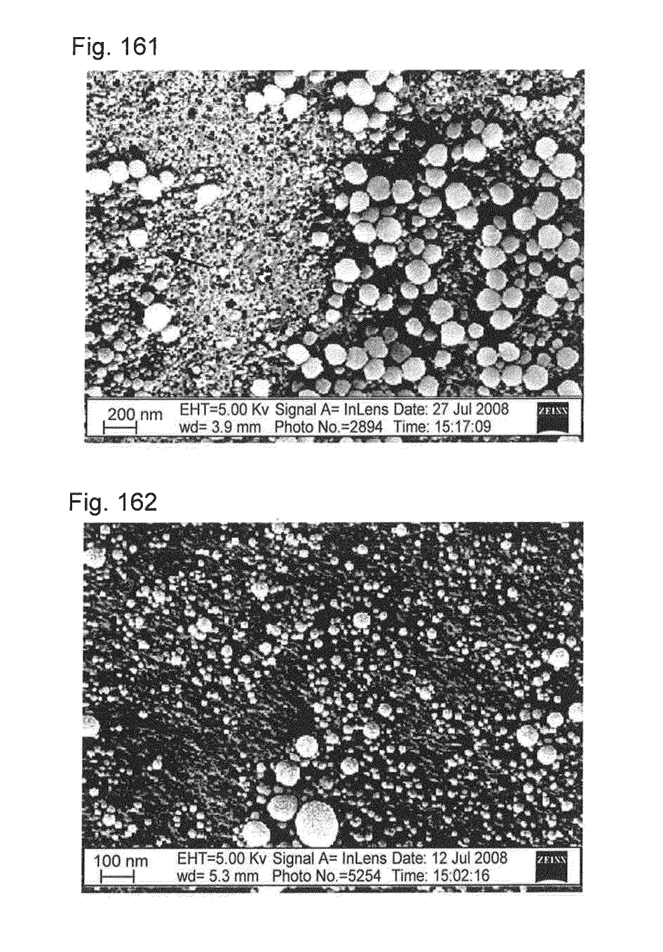

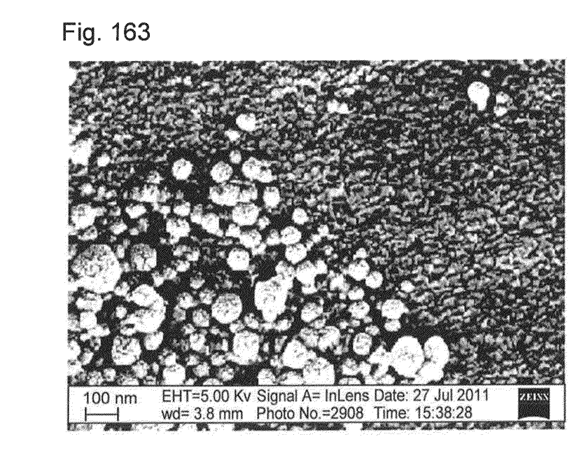

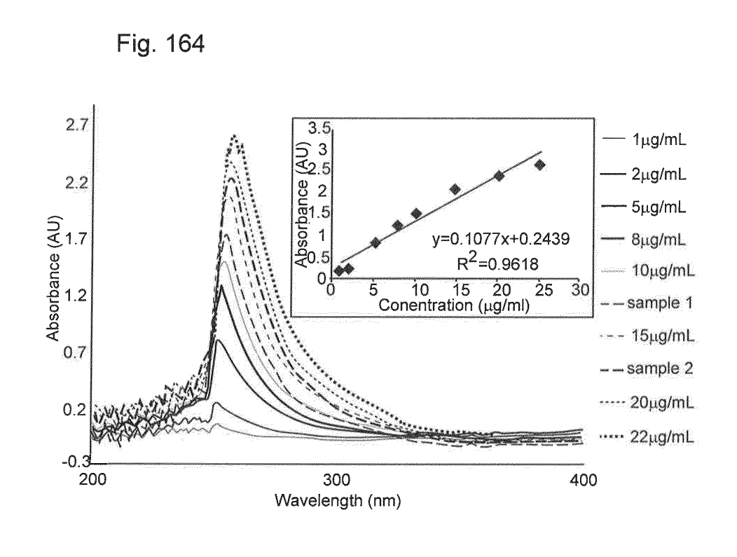

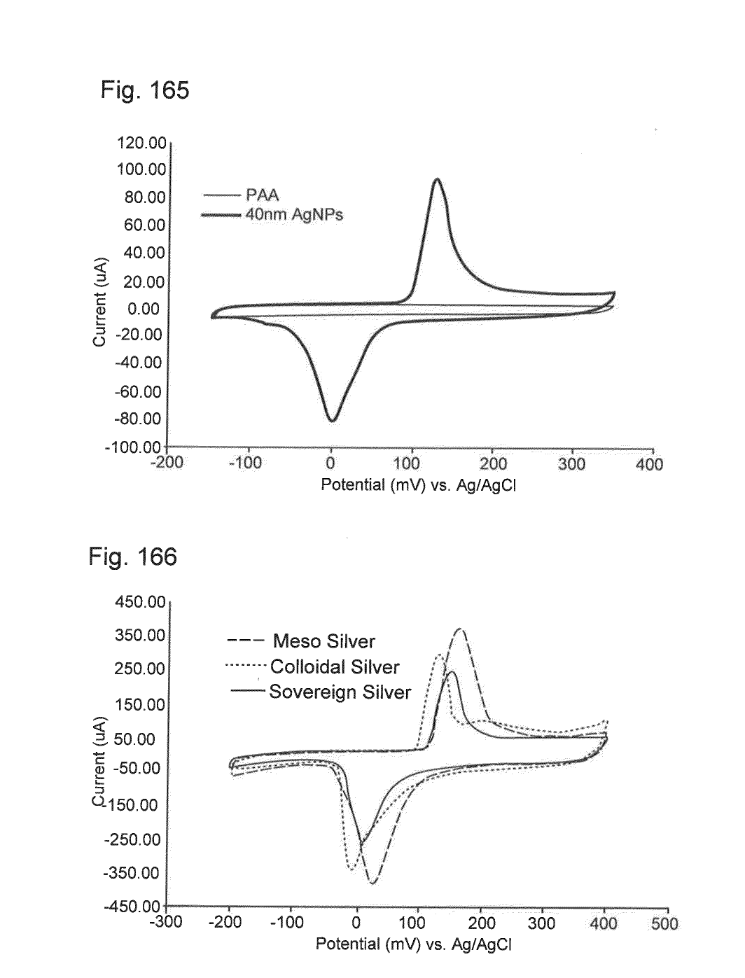

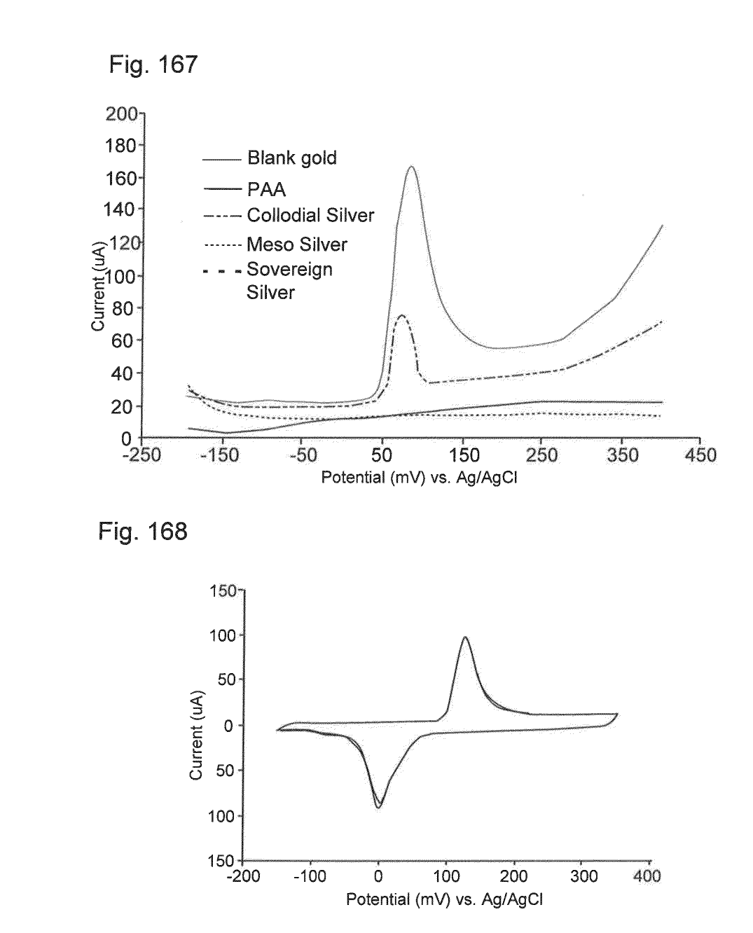

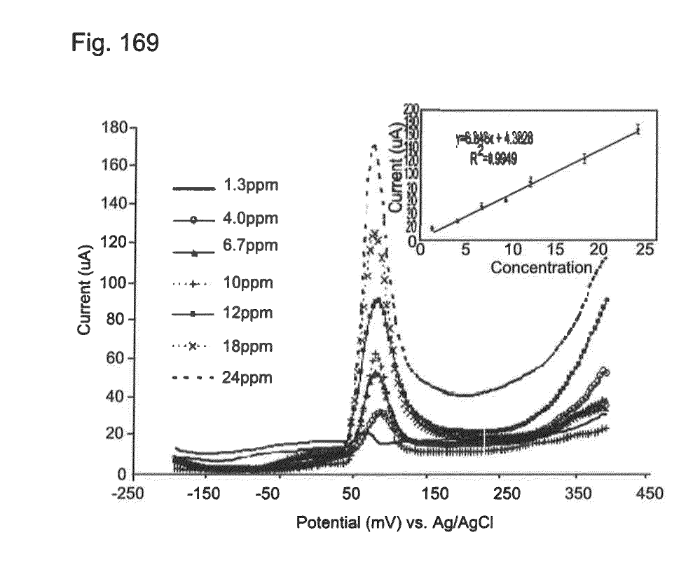

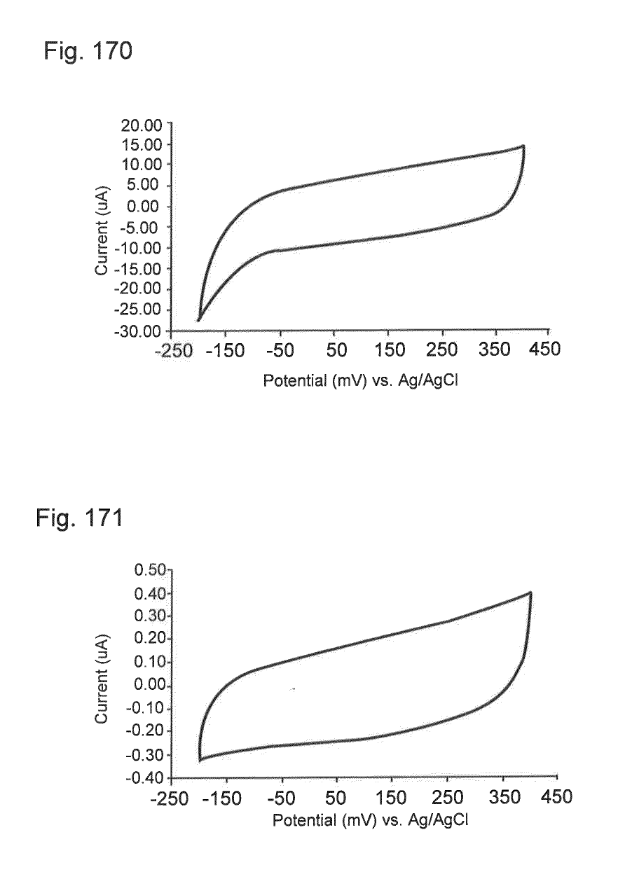

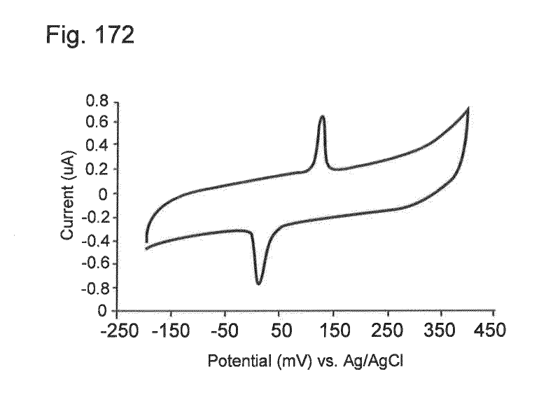

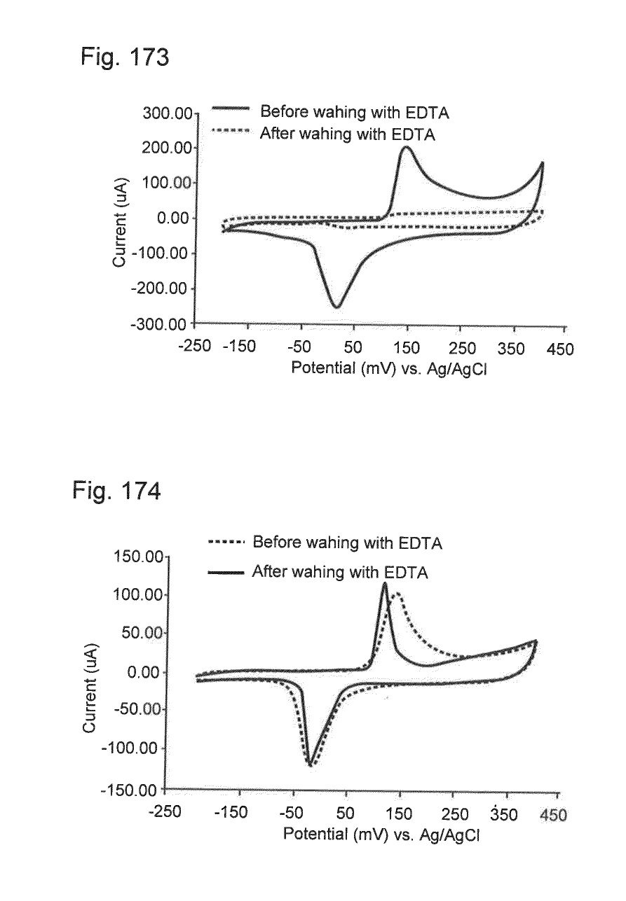

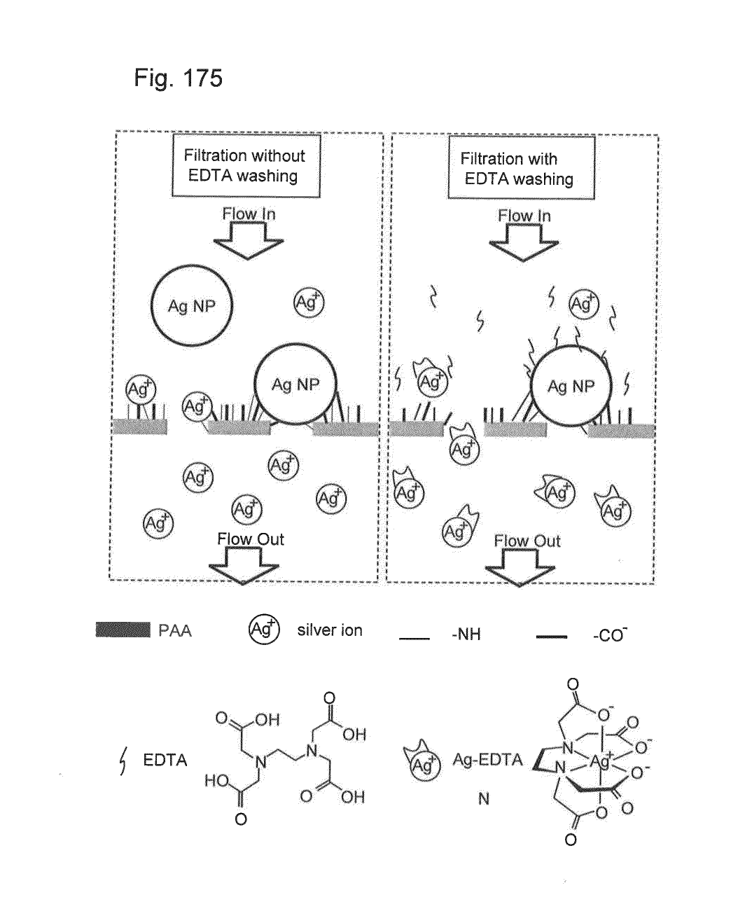

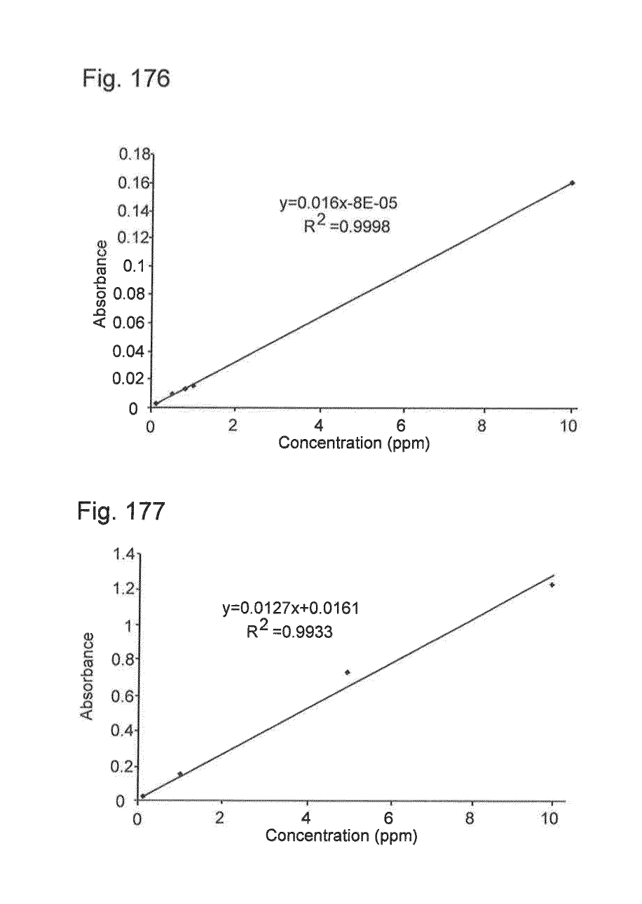

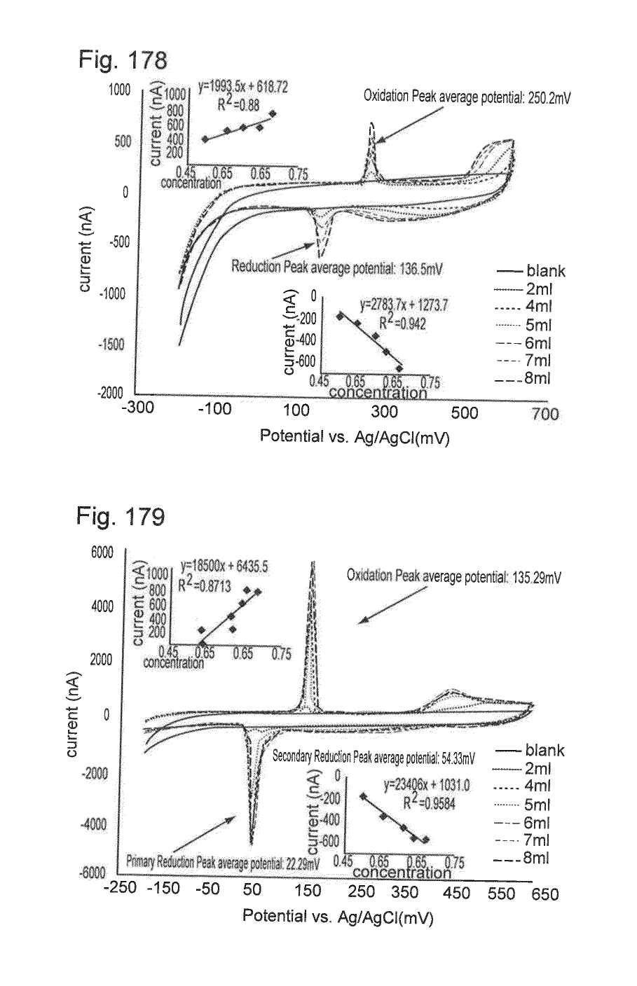

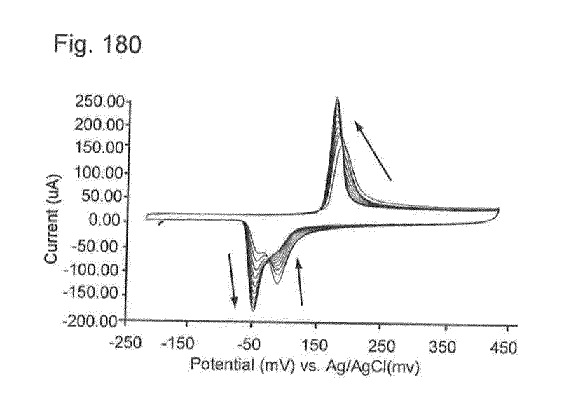

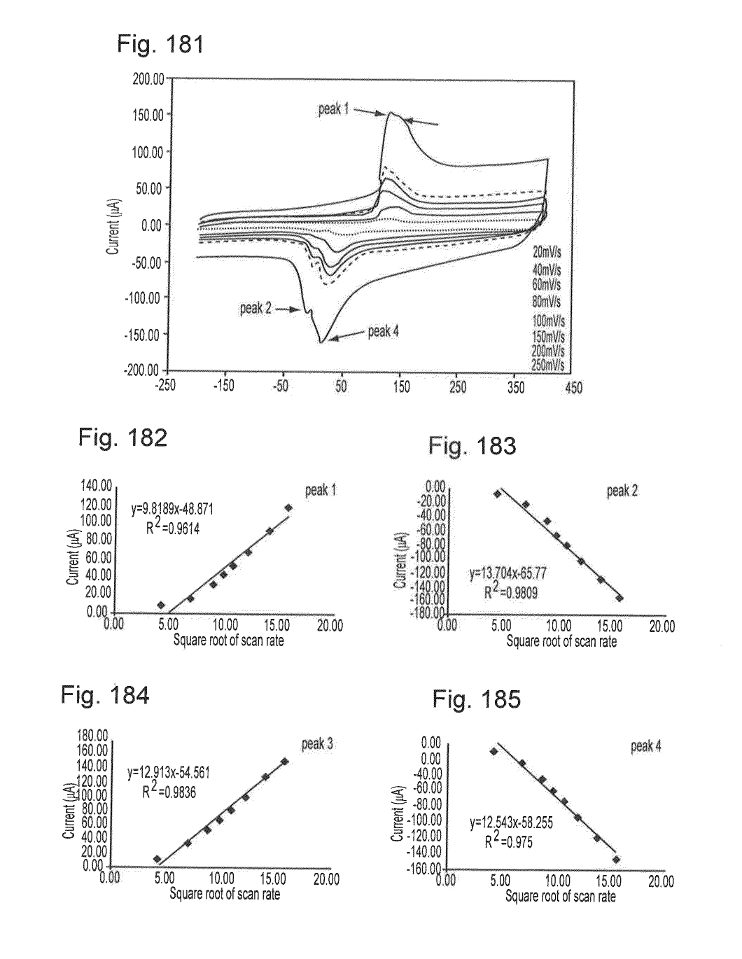

AAS analysis for silver is based on the absorbance of silver ions at 328 nm and where the silver ions have the highest absorbance. Solutions of AgNO₃ were used to develop these calibration lines. FIG. 61 showed the absorbance and concentration relationship in low concentration range (0.1 ppm to 10 ppm) and FIG. 61b showed the relationship in the total range (0.1 ppm to 100 ppm) that was tested. The detection limit was about 50 ppb. As described in the experimental section, silver NPs in food supplement samples were oxidized into silver ions using strong acid first and the resulting silver ions were measured using AAS. The concentrated results of silver NPs were converted from AAS results of silver ions in term of mass concentration with unit of mg/l or ppm. AAS results were compared with the electrochemical results in TABLE 20 below. The electrochemical method achieved similar concentration results compared to the AAS analysis, although the standard deviations in electrochemical methods were slightly higher than those of the AAS.

TABLE 20

| | Concentration | | Concentration | |
|---|---|---|---|---|
| | determined by | | determined by | |
| | electrochemical method | SD | AAS | SD |
| | (ppm/mg · l⁻¹) | n = 9 | (ppm/mg · l⁻¹) | n = 3 |
| MesoSilver | 23.3 | 1.5 | 25.6 | 0.39 |
| Colloidal Silver | 17.2 | 0.3 | 16.9 | 0.24 |
| Sovereign Silver | 10.9 | 0.6 | 11.8 | 0.25 |

FIG. 62 shows the CV results of silver NPs with various amounts in buffer solution. When there was no NaCl in buffer solution, no peaks showed off until the added amount reached 4 ml (FIG. 62a). However, redox peaks appeared when only 2 ml added to buffer solution with NaCl (FIG. 62b). This means the addition of NaCl to buffer solution improved the sensitivity.

In FIG. 62a, there two oxidation peaks and two reduction peaks. The potential for first sharp peak pair is 193.95 mV while the potential for second broad peak pair is 480 mV, according to Equation (4) below,

E=(Eₚₙ+E_{pc})/2 Equation (4)

where E is the half redox reaction potential, Eₚₐ is potential for oxidation peak and E_{pc} is potential for reduction peak. Usually, Ag/AgCl reference electrode filled with saturated KCl solution has a standard electrode potential of 0.197V compared with standard hydrogen electrode (SHE). And Ag/AgCl reference electrode filled with 3M KCl solution has a standard electrode potential of 0.210V compared with SHE. The RE 5B reference electrode used in our experiment is filled with 3M NaCl solution according to the description of manufacturer. So 0.210V was chosen to convert the observed redox potential into standard potential compared with SHE. And the standard potential for the first pair is 0.403V while the standard potential for the second pair is 0.658V. Reaction (1) to (7) are the possible redox reactions related to silver element. According to Pourbaix diagram of silver, the redox reactions and corresponding potentials vary at different pH values²²⁹. The theoretical potentials of Reaction (3) and (4) at pH 7.0 are 0.341V and 0.569V respectively. So the first redox peak pair can be assigned to Reaction (3) and the second redox peak pair can be assigned to redox reaction of AgO (Reaction 4).

AgCl(s)+e⁻⇄Ag(s)+Cl⁻(aq) E₀=0.222V Reaction (1)

Ag⁺(aq)+e⁻⇄Ag(s) E₀=0.8V Reaction (2)

Ag₂O(s)+2H⁺(aq)+2e⁻⇄2Ag(s)+H₂O E₀=1.17V Reaction (3)

2AgO(s)+2H⁺(aq)+2e⁻⇄Ag₂O(s)+H₂O E₀=1.40V Reaction (4)

Ag₂O₃(s)+6H⁺(aq)+4e⁻⇄2Ag⁺(aq)+3H₂O E₀=1.67V Reaction (5)

AgO(s)+2H⁺(aq)+e⁻⇄Ag⁺(aq)+H₂O E₀=1.77V Reaction (6)

Ag²⁺(aq)+e⁻⇄Ag⁺(aq) E₀=1.98V Reaction (7)

In FIG. 62b, there were two sharp reduction peaks connected together at low addition amounts (2 ml to 4 ml). The one showed in all experiments was assigned as the primary reduction peak, while the one disappeared in high amount of addition experiments (5 ml to 8 ml) was assigned as the secondary reduction peak. Both peaks were considered from reduction of AgCl because their standard potentials were 0.289V and 0.305V which are more close to the theoretical potential of 0.258V for Reaction (1). The theoretical potential is calculated from Nernst Equation when Cl⁻ concentration is 0.25M. And the other pair of broad peaks appearing at 0.428V (oxidation) and 0.302V (reduction) respectively has a standard potential of 0.575V. Since there were plenty of Cl⁻ ions in buffer solution and hence no free Ag⁺ could exist in solution, the reaction for this pair of broad peaks should not be assigned to Reaction (2). So the most possible explanation for this pair is Reaction (3).

The two sharp reduction peaks for low addition amount of MesoSilver in FIG. 62b coincided with result of multiple cycles of CV measurement (FIG. 62c). Redox reaction for MesoSilver in solution was not very stable as shown in FIG. 62c. The oxidation peak shifted to lower potential from 0.128V to 0.118V, and change from broad peak to sharp peak within the cycles. Two reduction peaks showed off at 0.004V and 0.038V respectively with a cross point in between, and the peak at 4 mV got bigger while the peak at 0.038V got smaller within multiple cycles. This means there were two species existed in solution and one species for 0.038V changed into another one for 0.004V. Because the standard potentials for first cycle (0.128V and 0.038V) and last cycle (0.118V and 0.004V) are 0.293V and 0.271V respectively, both of them should be due to the reaction of AgCl. The two reduction peaks belonging to two species should be assigned to silver NPs and silver ions in MesoSilver solution. Reaction (1) can be considered as the oxidation of Ag into Ag⁺ followed by immediate reaction with Cl⁻ into AgCl. According to the research of Ivanova et al.²²⁶, bigger silver NPs should have high redox potential for redox reaction of Ag⁺/Ag. In their study, they observed positive shift for potential with increasing NPs size. So the redox peaks in first cycle should be mainly contributed by silver NPs, while the redox peaks in last cycle mainly came from silver ions which should form smaller silver seed than silver NPs in MesoSilver. Within cycles, more and more silver NPs were broken down into silver ions; forming AgCl by oxidization, and finally being reduced into silver seed. This possible mechanism can well explain why the redox peaks shifted from higher potential to low potential during potential cycling.

FIG. 63 compared the current change with various scan rates. As discussed above, peak1 and peak2 belongs to redox reaction of silver ions while peak3 and peak4 should be assigned to redox reaction of silver NPs. The linear regressive relationship between square root of scan rate and current of each peak indicate these redox reactions are reversible.

In summary, the discussion above presents three methods for detection of silver NPs. The electrochemical method using PAA membrane can successfully capture and detect silver NPs quantitatively. This method with PAA membranes also showed unique advantage compared to the optical method and the electrochemical method without PAA membrane. The PAA membranes provided a simple approach to concentrate and isolate the NPs sample by varying filtration volume with minimal sample preparation. And the electrochemical detection was fast, requiring only few minutes. With PAA membrane and EDTA masking method, this electrochemical detection technique targeted silver NPs merely without silver ions. The optical method can provide quantitative measurement only for non-protected silver NPs while electrochemical method without PAA membrane cannot eliminate the effect of silver ions.

### E. Summary

In view of the foregoing, the discussion above describes, in varying detail, information and data to quantify and qualify various embodiments of filter devices, membranes, and implementations related thereto.

Implementation I presents the synthesis and fabrication of embodiments of PAA thermally-cured membrane and its derivatives. The polymers were synthesized using ODA and PMDA via thermal curing process. In order to prevent imidization and formation of PI, 75° C. was chosen for the thermal curing of PAA and a range of PAA derivatives were synthesized. The NMR and FTIR results confirmed that the functional carboxyl and amide groups were retained in the PAA series synthesized. Results also show that low temperature (75° C.) synthesis can successfully prevent the formation of PI from PAA. After comparing the mechanical properties of PSG resulting from the various compositions and different ratios of gold and silane, the molar ratio of PAA/gold in 16:1 and molar ratio of PAA/APTMOS/TMOS/TMOSPA in 20:5:5:1 were found to be the best conditions for these polymeric derivatives. The resulting membranes were flexible, transparent, conducting, and electroactive. The effect of thermal curing temperature to the quantity and size of gold NPs was discussed. With increasing thermal curing temperature, more gold NPs appeared on the surface of PG membranes. However, few gold NPs were observed on the surfaces of PSG membranes. The silicone content in PSG membranes contained gold NPs inside the membranes and it was noticed that the particles shifted to the surface at higher temperatures.

Implementation II presents the synthesis of embodiments of phase-inverted PAA membranes and its derivatives. Although the chemical compositions were the same as the thermally-cured membranes, the phase-inverted membranes were found to exhibit a totally different morphology and physical structure from the thermally-cured membranes. Phase-inverted PAA membrane and its derivatives are flexible, opaque, sponge-like and nano-porous membranes. Their structures are anisotropic, consisting of a dense nano-porous thin top layer and a thick supporting sublayer with micro size pores. Embodiments can comprise surface nano-pores of size that can be adjusted by the concentration of the casting PAA solutions. The change of surface pore size versus the corresponding concentration of casting solution was found to be described by a single component exponential decay. Generally, the mean pore size of PAA membrane decreases with increasing concentration of the casting solution. At low concentration range (smaller than 0.25M), the mean pore sizes of membranes decreased dramatically with increasing concentrations. From 0.25M to higher concentrations, the resulting pore sizes change in small range. Embodiments of the PAA membranes were also coated onto the surfaces of filter papers to create robust PAA-filter paper membrane and filter devices. The coated filter papers have a thin layer of PAA with similar pore size as its corresponding stand-alone PAA membranes. Moreover, the PAA-coated layer was observed to have smoother surfaces than the stand-alone membranes, and they also have smaller pore size range. Finally, the PAA-coated filter papers were more durable than PAA membranes alone because of the supporting filter paper.

In Implementation II, the casting solution could not be evenly spread onto the substrate, because the hand dispersion of PAA casting solution was not perfect. This led to some defects in the membranes, including uneven thickness, cracks on surface and holes resulting from trapped air bubble during fabrication. Automatic dispersion may remedy this deficiency for PAA fabrication.

Embodiments of the phase-inverted PAA membranes also exhibit unique optical properties which are different from its thermally-cured membranes. These embodiments generate some special fluorescent emissions after they were excited at various excitation wavelengths. This feature may indicate that the shift of emission wavelength compared with excitation wavelength can be better explained by enhanced Raman scattering and not by conventional fluoresecence spectroscopic principles. The results of enhanced Raman scattering spectroscopy confirmed that embodiments of phase-inverted PAA membrane can promote enhance Raman scattering on its surface, which could be attributed to the membrane's unique porous surface and conducting polymer nature. The last part of Implementation II presents the results of storage solution and stability of phase-inverted membranes. These results are not conclusive because the variety of the solvents tested for storage solution was quite limited. The results are limited to solvent combination of water, ethanol, acetone, DMAc and DMF; however, these results could be enhanced using more solvents, multi-phase solutions, and double-phase solutions for storage of PAA membrane.

Implementation III presents nano-filtration (NF) using phase-inverted PAA membranes. Quantum dots, silver NPs and TiO₂ NPs ranging from 20 nm to 150 nm were filtered separately using the phase-inverted PAA membranes. The general filtration efficiency was found to be above 80% with the highest single efficiency reaching 99.97%. Performance of the PAA membrane was compared with commercial filters. Results showed that qualitative filter papers barely captured any silver NPs. Nylon filter membranes gave an overall filtration efficiency of 44.52%. The overall average filtration efficiency of aluminum oxide membrane was 78.28%. Unlike commercial membranes, embodiments of the PAA membranes exhibited superior performance. Phase-inverted PAA membranes were found to exhibit superior durability and higher efficiency. In silver NPs filtration, PAA membranes had overall filtration efficiency of 98.5%, while in filtration of quantum dots the overall average efficiency of 87.46% was reported. PAA coated filter papers exhibited comparable filtration efficiency as PAA membrane without filter paper as the substrate.

Implementation III also illustrates the capability of embodiments of phase-inverted PAA membranes for the separation of engineered NPs. Several NPs mixtures were tested, consisting of metal-based NPs, such as a mixture gold NPs with various sizes, and a mixture of TiO₂, silver, gold NPs. Other mixtures were consisted of organic and inorganic NPs such as gold NPs and polystyrene nano-beads. No matter which mixture, the separation mechanism using phase-inverted PAA membranes were in accordance with the pore sizes of these membranes employed. These membranes have only size-selectivity but no elemental selectivity was found. However, chemical modification to the PAA membrane might improve the selectivity of separation. These modifications may include, for example, functional groups on PAA. Modified PAA could either be more hydrophilic or be more hydrophobic, and hence improve its selectivity to organic NPs or inorganic NPs. These membranes can slightly aggregate NPs on membrane surface, which can block some pores on the surface and hence affected the efficiency of separation. The aggregation effect may influence the calibration of NPs after each step of separation.

Implementation IV shows that PAA membranes are not just filters; they could simultaneously serve as sensors for silver NPs detection and quantization. The first part of Implementation IV describes optical method for detection of silver NPs with a detection limit of 1 μg/ml. However, this method is based on redox chemical reaction and may only apply to NPs which have no capping layer on their surface. For those capped NPs, they are protected by the capping layer from this redox chemical reaction.

Implementation IV also discusses electrochemical method for quantitative detection of silver NPs. Utilizing PAA membrane as a concentration and sensor substrate, we reported a detection limit of 100 ppb with a filtration volume of 15 ml. These methods may be selective to particular types of particles (e.g., silver NPs). This implementation also describes utilization of EDTA to mask the interfering ions which improved the selectivity of this detection method. However, in some examples, because the PAA membrane was attached to gold electrodes, the sensitivity was decreased by contact potential. Compared with AAS verification which has a detection limit of 100 ppb, electrochemical detection of silver NPs using PAA membrane has a similar result for the concentrations of silver NPs samples with a higher detection limit of 200 ppb for 10 ml sample. Some embodiments may benefit from improvements in fabrication of PAA membrane electrode. One way to improve the fabrication can be a direct fabrication of PAA membrane coated onto gold mesh instead of simple attachment to gold electrode after fabrication of the stand-alone membrane. In this way, the contact potential between the PAA membrane and gold could be decreased. Another method that can be considered is to improve the conductivity of PAA by adding other highly conductive materials such as gold NPs and carbon nano-tubes.

Method for electrochemical detection of silver NPs without PAA membrane was presented in the last part of Implementation IV. Although this method can detect silver NPs in aqueous solution as well, it can eliminate the effect of silver ions. The function of NaCl in buffer solution was investigated. The addition of NaCl to buffer solution improved the sensitivity of detection. Method of utilizing PAA membrane is more selective and sensitive than that without PAA membrane.

Summarily, the discussion above identifies various embodiments of PAA-based membranes (e.g., phase-inverted PAA membranes) using a range of synthetic approaches. These embodiments can apply to novel applications, for example, PAA membranes have shows Raman activity as nano-filters and as sensors for engineered nano-materials.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A filter device, comprising:
a substrate;
a first layer disposed on the substrate, the first layer having a composition comprising a first component of poly(amic) acid, the first layer having a first porous structure with pores of a first pore size, wherein the first pore size is less than 100 nm.

2. The filter device of claim 1, wherein the substrate has a second porous structure with pores of a second pore size that is greater than the first pore size.

3. The filter device of claim 2, wherein the substrate comprises a filter media.

4. The filter device of claim 2, wherein the first layer is configured integrally with the substrate.

5. The filter device of claim 1, wherein the first pore size is in a range of from about 7 nm to about 30 nm.

6. The filter device of claim 1, wherein the first layer comprises a first sublayer and a second sublayer interposed between the first sublayer and the substrate, each of the first sublayer and the second sublayer comprising the first component, wherein pores of the first sublayer are larger than pores of the second sublayer.

7. The filter device of claim 1, wherein the composition of the first layer comprises a second component cross-linked with the first component.

8. The filter device of claim 7, wherein the second component comprises nano-particles.

9. The filter device of claim 8, wherein the nano-particles comprise a noble metal.

10. The filter device of claim 1, further comprising a coating layer disposed on the substrate, wherein the coating layer is configured to conduct an electrical stimulus.

11. An apparatus for filtering nano-particles from a solution, said apparatus comprising:
a filter media;
a membrane disposed on the filter media, the membrane comprising a composition of poly(amic) acid and one or more additive components bonded with the poly(amic) acid,
wherein the membrane is configured with an anisotropic structure.

12. The apparatus of claim 11, wherein the anisotropic structure comprises a first sublayer and a second sublayer, each having pores with, respectively, a first pore size and a second pores size that is different from the first pore size,

13. The apparatus of claim 11, and wherein the first pore size and the second pore size are less than 100 nm.

14. The apparatus of claim 11, wherein the additive component comprises one or more of gold nano-particles and silicone.

15. The apparatus of claim 14, wherein the membrane is formed integrally with the filter media.

16. A membrane, comprising:
a porous structure with pores less than 100 nm, the porous structure comprising poly(amic) acid, a first additive cross-linked with the poly(amic) acid, and a second additive comprising nano-particles bonded to the porous structure.

17. The membrane of claim 16, wherein the nano-particles comprise gold.

18. The membrane of claim 17, wherein the nano-particles comprise a noble metal.

19. The membrane of claim 17, wherein the first additive comprises silicone.

20. The membrane of claim 16, wherein the porous structure is anisotropic with a first layer in which the pores have a first pore size and a second layer in which the pores have a second pore size that is greater than the first pore size.
